(19) United States
(12) Patent Application Publication
(10) Pub. No.: US 2026/0303312 A1
(43) Pub. Date: Oct. 1, 2026

(54) METHOD AND APPARATUS FOR DESIGNING HARQ CODEBOOK FOR FULL-DUPLEX COMMUNICATION IN WIRELESS COMMUNICATION SYSTEM

(71) Applicant: Samsung Electronics Co., Ltd., Suwon-si, Gyeonggi-do (KR)

(72) Inventors: Kyungjun CHOI, Suwon-si (KR); Younsun KIM, Suwon-si (KR); Hyoungju JI, Suwon-si (KR)

(21) Appl. No.: 19/490,139

(22) PCT Filed: Jun. 10, 2024
(86) PCT No.: PCT/KR2024/007877

§ 371 Date: Dec. 4, 2025

(30) Foreign Application Priority Data
Jun. 9, 2023 (KR) 10-2023-0074078

(51) Int. Cl. H04L 5/14; H04L 5/00; H04W 72/23

(52) U.S. Cl. CPC H04L 5/14; H04L 5/0094; H04W 72/23

(57) ABSTRACT

The present disclosure relates to a 5G or 6G communication system for supporting a higher data transmission rate. The present invention provides a method for generating a type-1 HARQ-ACK codebook in a wireless communication system. A method performed by a terminal of a communication system according to an embodiment of the present invention may comprise the steps of receiving configuration information related to subband non-overlapping full duplex (SBFD), identifying at least one occasion for receiving a physical downlink shared channel (PDSCH), and receiving the PDSCH in a valid occasion among the at least one occasion, wherein, in case that the configuration information corresponds to a first configuration, the valid occasion is defined as either an occasion including only a first type symbol or an occasion including only a second type symbol, and wherein, in case that the configuration information corresponds to a second configuration, the valid occasion is defined as an occasion including only a first type symbol and an occasion including only a second type symbol.

### TECHNICAL FIELD

The present disclosure relates to operations of a terminal and a base station in a wireless communication system. More particularly, the present disclosure relates to a method for transmitting HARQ-ACK indicating whether a physical downlink shared channel (PDSCH) has been successfully received by a UE upon receiving the PDSCH, and an apparatus capable of performing the method.

### BACKGROUND ART

5G mobile communication technology defines a wide frequency band to enable fast transmission speed and new services, and can be implemented not only in a frequency band equal to or lower than 6 gigahertz (6 GHz) (‘sub 6 GHz’) bands, such as 3.5 gigahertz (3.5 GHz), but also in ultra-high frequency band (‘above 6 GHz’), also known as millimeter wave (mmWave), such as 28 GHz and 39 GHz. In addition, 6G mobile communication technology, which is called a system beyond 5G, is being considered to be implemented in a terahertz band (e.g., from 95 GHz to 3 terahertz (3 THz) band) to achieve a transmission speed 50 times faster and an ultra low-latency time reduced to one-tenth, compared to the 5G mobile communication technology.

The goal in the early stage of the 5G mobile communication technology is to support services and meet performance requirements for enhanced mobile broadband (eMBB), ultra-reliable low-latency communications (URLLC), and massive machine-type communications (mMTC). To achieve the goal, standardization is underway for beamforming and massive MIMO to mitigate path loss of radio waves and increase a propagation range of radio waves in an ultra-high frequency band, support for various numerologies (such as an operation of multiple subcarrier spacings) and dynamic operation of slot formats for efficient utilization of ultra-high frequency resources, initial access technologies to support multi-beam transmission and broadband, definition and operation of a bandwidth part (BWP), new channel coding methods such as a low density parity check (LDPC) code for large-capacity data transmission and a polar code for high reliable transmission of control information, L2 pre-processing, network slicing to provide dedicated networks specialized to specific services, etc.

Currently, discussions are underway for improvement and performance enhancement of the initial 5G mobile communication technology in consideration of services that the 5G mobile communication technology is intended to support. Physical layer standardization is underway for technologies such as vehicle-to-everything (V2X), which assists in driving determinations of autonomous vehicles and enhances user convenience based on their own location and status information transmitted by vehicles, new radio unlicensed (NR-U), which aims for system operation meeting various regulatory requirements in unlicensed bands, NR UE power saving, a non-terrestrial network (NTN), which is direct UE-satellite communication to secure coverage in areas where communication with terrestrial networks is impossible, and positioning.

In addition, standardization of wireless interface architecture/protocol fields is also underway for technologies such as intelligent factories (industrial Internet of Things, IIoT) that support new services through integration and convergence with other industries, integrated access and backhaul (IAB) that provides nodes to extend network service area by integrating and supporting a wireless backhaul link and an access link, mobility enhancement technology including conditional handover and dual active protocol stack (DAPS) handover, and two-step random access (2-step RACH for NR) that simplifies a random access procedure, and standardization of system architecture/service fields is also underway for 5G baseline architecture (e.g., service based architecture, service based interface) for combining network functions virtualization (NFV) and software-defined networking (SDN) technologies, and mobile edge computing (MEC) that receives services based on a location of a UE, etc.

When such 5G mobile communication systems are commercialized, connected devices, experiencing explosive growth, will be linked to communication networks. Therefore, it is expected that the enhancement of the functions and performance of 5G mobile communication systems and the integrated operation of connected devices will be required. To this end, new research is scheduled to be conducted on eXtended reality (XR) to efficiently support augmented reality (AR), virtual reality (VR), mixed reality (MR), etc., enhancing 5G performance and reducing complexity by using artificial intelligence (AI) and machine learning (ML), supporting AI services, supporting metaverse services, drone communications, etc.

In addition, the advancement of the 5G mobile communication systems may provide the foundation for the development of not only 6G mobile communication technologies, including a new waveform to ensure coverage in a terahertz band, multi-antenna transmission technologies such as full-dimensional multiple-input multiple-output (FD-MIMO), array antennas, and large-scale antennas, metamaterial-based lenses and antennas to enhance coverage of a terahertz band signal, high-dimensional spatial multiplexing technology using orbital angular momentum (OAM), and reconfigurable intelligent surface (RIS) technology, but also for 6G mobile communication technologies, including full-duplex technology to enhance frequency efficiency and improve system networks, AI-based communication technologies that utilize satellites and artificial intelligence from the design stage and incorporate end-to-end AI support functions to achieve system optimization, and next-generation distributed computing technologies that utilize ultra-high-performance communication and computing resources to realize highly complex services beyond the limitations of UE computing capabilities, etc.

With the advancement of the wireless communication systems as described above, various services may be provided. Accordingly, measures are required to smoothly provide these services.

### DISCLOSURE OF INVENTION

### Technical Problem

The disclosed embodiment is directed to providing an apparatus and a method capable of effectively providing services in a mobile communication system.

### Solution to Problem

According to an embodiment of the present disclosure, a method performed by a terminal of a communication system includes receiving configuration information related to subband non-overlapping full duplex (SBFD), identifying at least one occasion for receiving a physical downlink shared channel (PDSCH), and receiving the PDSCH at a valid occasion among the at least one occasion, wherein, in case that the configuration information corresponds to a first configuration, the valid occasion is defined as either an occasion including only a first type symbol or an occasion including only a second type symbol, and wherein, in case that the configuration information corresponds to a second configuration, the valid occasion is defined as the occasion including only the first type symbol and the occasion including only the second type symbol.

According to an embodiment of the present disclosure, a method performed by a base station of a communication system includes transmitting configuration information related to subband non-overlapping full duplex (SBFD), identifying at least one occasion for transmitting a physical downlink shared channel (PDSCH), and transmitting the PDSCH at a valid occasion among the at least one occasion, wherein, in case that the configuration information corresponds to a first configuration, the valid occasion is defined as either an occasion including only a first type symbol or an occasion including only a second type symbol, and wherein, in case that the configuration information corresponds to a second configuration, the valid occasion is defined as the occasion including only the first type symbol and the occasion including only the second type symbol.

According to an embodiment of the present disclosure, a terminal of a communication system includes a transceiver, and a controller configured to receive configuration information related to subband non-overlapping full duplex (SBFD), identify at least one occasion for receiving a physical downlink shared channel (PDSCH), and receive the PDSCH at a valid occasion among the at least one occasion, wherein, in case that the configuration information corresponds to a first configuration, the valid occasion is defined as either an occasion including only a first type symbol or an occasion including only a second type symbol, and wherein, in case that the configuration information corresponds to a second configuration, the valid occasion is defined as the occasion including only the first type symbol and the occasion including only the second type symbol.

According to an embodiment of the present disclosure, a base station of a communication system includes a transceiver, and a controller configured to transmit configuration information related to subband non-overlapping full duplex (SBFD), identify at least one occasion for transmitting a physical downlink shared channel (PDSCH), and transmit the PDSCH at a valid occasion among the at least one occasion, wherein, in case that the configuration information corresponds to a first configuration, the valid occasion is defined as either an occasion including only a first type symbol or an occasion including only a second type symbol, and wherein, in case that the configuration information corresponds to a second configuration, the valid occasion is defined as the occasion including only the first type symbol and the occasion including only the second type symbol.

### Advantageous Effects of Invention

The disclosed embodiments may provide an apparatus and method capable of effectively providing services in a mobile communication system.

### BRIEF DESCRIPTION OF DRAWINGS

FIG. 1 is a diagram illustrating a basic structure of a time-frequency domain in a wireless communication system according to an embodiment of the present disclosure.

FIG. 2 is a diagram illustrating a structure of a frame, a subframe, and a slot in the wireless communication system according to an embodiment of the present disclosure.

FIG. 3 is a diagram illustrating an example of a bandwidth part configuration in the wireless communication system according to an embodiment of the present disclosure.

FIG. 4 is a diagram illustrating an example of a control resource set configuration for a downlink control channel in the wireless communication system according to an embodiment of the present disclosure.

FIG. 5 is a diagram illustrating a structure of the downlink control channel in the wireless communication system according to an embodiment of the present disclosure.

FIG. 6 is a diagram for describing a method for a base station and a UE to transmit and receive data in consideration of a downlink data channel and rate matching resources in the wireless communication system according to an embodiment of the present disclosure.

FIG. 7 is a diagram illustrating an example of frequency-domain resource allocation for PDSCH in the wireless communication system according to an embodiment of the present disclosure.

FIG. 8 is a diagram illustrating an example of time-domain resource allocation for PDSCH in the wireless communication system according to an embodiment of the present disclosure.

FIG. 9 is a diagram illustrating an example of time-domain resource allocation according to subcarrier spacing of a data channel and a control channel in the wireless communication system according to an embodiment of the present disclosure.

FIG. 10 is a diagram illustrating a wireless protocol structure between a base station and a UE in a single cell, carrier aggregation, and dual connectivity situation in the wireless communication system according to an embodiment of the present disclosure.

FIG. 11 is a diagram illustrating a TDD configuration and an SBFD configuration according to an embodiment of the present disclosure.

FIG. 12 is a diagram illustrating the SBFD configuration according to an embodiment of the present disclosure.

FIG. 13 is a diagram illustrating an antenna operation method in a TDD transmission scheme.

FIG. 14 is a diagram illustrating a static antenna operation method in an SBFD transmission scheme according to an embodiment of the present disclosure.

FIG. 15A is a diagram for describing a Type-1 HARQ-ACK codebook for HARQ-ACK transmission on a PDSCH according to an embodiment of the present disclosure.

FIG. 15B is a diagram for describing the Type-1 HARQ-ACK codebook for HARQ-ACK transmission on the PDSCH according to an embodiment of the present disclosure.

FIG. 15C is a diagram for describing the Type-1 HARQ-ACK codebook for HARQ-ACK transmission on the PDSCH according to an embodiment of the present disclosure.

FIG. 16 is a diagram illustrating a PDSCH reception occasion to be included in and excluded from the Type-1 HARQ-ACK codebook depending on an SBFD symbol or a non-SBFD symbol.

FIG. 17 is a diagram illustrating the PDSCH reception occasion to be included in and excluded from the Type-1 HARQ-ACK codebook according to uplink/downlink slot configuration information and SBFD configuration information.

FIG. 18A is a diagram for describing the Type-1 HARQ-ACK codebook for HARQ-ACK transmission by a terminal configured for an SBFD operation according to an embodiment of the present disclosure.

FIG. 18B is a diagram for describing the Type-1 HARQ-ACK codebook for HARQ-ACK transmission by the terminal configured for the SBFD operation according to an embodiment of the present disclosure.

FIG. 18C is a diagram for describing the Type-1 HARQ-ACK codebook for HARQ-ACK transmission by the terminal configured for the SBFD operation according to an embodiment of the present disclosure.

FIG. 19 is a diagram illustrating a structure of a terminal in a wireless communication system according to an embodiment of the present disclosure.

FIG. 20 is a diagram illustrating a structure of a base station in a wireless communication system according to an embodiment of the present disclosure.

### MODE FOR THE INVENTION

Hereinafter, embodiments of the present disclosure will be described in detail with reference to the accompanying drawings.

In describing the embodiments, descriptions of technical contents that are well known in the technical field to which the present disclosure pertains and are not directly related to the present disclosure will be omitted. This is to more clearly convey the gist of the present disclosure without ambiguity by omitting unnecessary explanations.

For the same reason, some components in the accompanying drawings are exaggerated, omitted, or schematically illustrated. In addition, the size of each component does not entirely reflect the actual size. The same reference numerals are assigned to the same or corresponding components in each drawing.

Various advantages and features of the present disclosure and methods accomplishing them will become apparent from the following description of embodiments with reference to the accompanying drawings. However, the present disclosure is not limited to embodiments to be described below, but may be implemented in various different forms, these embodiments will be provided only in order to make the present disclosure complete and allow those skilled in the art to completely recognize the scope of the present disclosure, and the present disclosure will be defined by the scope of the claims. Throughout the specification, like reference numerals denote like components. In addition, in describing the present disclosure, when it is determined that a detailed description for the functions or configurations related to the present disclosure may unnecessarily obscure the gist of the present disclosure, the detailed description therefor will be omitted. Further, the following terms are terms defined in consideration of the functions in the present disclosure and may vary depending on the intention, practice, etc., of users and operators. Therefore, the definitions thereof should be construed based on the contents throughout the specification.

Hereinafter, a base station is an entity that performs resource allocation of a terminal, and may be at least one of a gNode B, an eNode B, a Node B, a base station (BS), a wireless access unit, a base station controller, or a node on a network. The terminal may include user equipment (UE), a mobile station (MS), a cellular phone, a smartphone, a computer, or a multimedia system capable of performing a communication function. In the present disclosure, downlink (DL) refers to a wireless transmission path of a signal transmitted from a base station to a terminal, and uplink (UL) refers to a wireless transmission path of a signal transmitted from a terminal to a base station. In addition, although a long-term evolution (LTE) or LTE-advanced (LTE-A) system may be described below as an example, embodiments of the present disclosure may also be applied to other communication systems having a similar technical background or channel type. For example, the 5th generation (5G) mobile communication technology (new radio, NR) developed after LTE-A may be included in such other communication systems, and the 5G below may also be a concept that includes the existing LTE, LTE-A, and other similar services. In addition, the present disclosure may be applied to other communication systems through certain modifications, as determined by those skilled in the art, without significantly departing from the scope of the present disclosure.

In this case, it will be appreciated that each block of processing flowcharts and combinations of the flowcharts may be executed by computer program instructions. Since these computer program instructions may be mounted in a processor of a general computer, a special computer, or other programmable data processing apparatuses, these computer program instructions executed through the processor of the computer or other programmable data processing apparatuses create means performing functions described in a block(s) of the flow chart. Since these computer program instructions may also be stored in a computer usable or computer readable memory that may be directed to a computer or other programmable data processing apparatuses in order to implement the functions in a specific scheme, the computer program instructions stored in the computer usable or computer readable memory may also produce manufacturing articles including instruction means performing the functions described in the block(s) of the flowchart. Since the computer program instructions may also be mounted on the computer or other programmable data processing apparatuses, the instructions performing a series of operation steps on the computer or other programmable data processing apparatuses to create processes executed by the computer, thereby executing the computer or other programmable data processing apparatuses may also provide steps for performing the functions described in a block(s) of the flowchart.

In addition, each block may represent some of modules, segments, or codes including one or more executable instructions for executing a specific logical function(s). Further, it is to be noted that functions mentioned in the blocks may occur regardless of a sequence in some alternative embodiments. For example, two blocks that are continuously illustrated may be simultaneously performed in fact or may sometimes be performed in a reverse sequence depending on corresponding functions.

In this case, the term ‘~unit’ used in the present embodiment means software or hardware components such as field programmable gate array (FPGA) or application specific integrated circuit (ASIC), and the ‘~unit’ performs certain roles. However, the ‘~unit’ is not meant to be limited to the software or hardware. The ‘~unit’ may be configured to be stored in a storage medium that can be addressed or may be configured to reproduce one or more processors. Accordingly, as an example, the ‘~unit’ may include components such as software components, object-oriented software components, class components, and task components, as well as processes, functions, attributes, procedures, subroutines, segments of program code, drivers, firmware, microcode, circuits, data, databases, data structures, tables, arrays and variables. Components and functions provided within ‘~unit’ may be combined into a smaller number of components and ‘~unit’ or may be further separated into additional components and ‘~unit.’ In addition, components and ‘~units’ may be implemented to reproduce one or more central processing units (CPUs) in a device or a secure multimedia card. In addition, in an embodiment, the ‘~unit’ may include one or more processors.

Wireless communication systems have evolved from their initial voice-centric services to broadband wireless communication systems that provide high-speed, high-quality packet data services, such as communication standards including 3GPP's high speed packet access (HSPA), long term evolution (LTE) (or evolved universal terrestrial radio access (E-UTRA)), LTE-advanced (LTE-A), LTE-Pro, 3GPP2's high rate packet data (HRPD), ultra mobile broadband (UMB), IEEE's 802.16e, etc.

As a representative example of these broadband wireless communication systems, for the LTE system, orthogonal frequency division multiplexing (OFDM) is employed in downlink (DL) and single carrier frequency division multiple access (SC-FDMA) is employed in uplink (UL). The uplink refers to a wireless link through which a terminal (user equipment (UE) or mobile station (MS)) transmits data or control signals to a base station (eNode B or base station (BS)), and the downlink refers to a wireless link through which a base station transmits data or control signals to a terminal. The multiple access scheme as described above typically allocates and operates time-frequency resources to carry and transmit data or control information to each user so that the time-frequency resources do not overlap, i.e., orthogonality is ensured, thereby allowing the data or control information of each user to be distinct.

The future communication systems beyond LTE, that is, the 5G communication systems should be able to freely reflect various requirements of users, service providers and the like. Therefore, services simultaneously satisfying various requirements should be supported. The services being considered for the 5G communication systems include enhanced mobile broadband (eMBB), massive machine type communication (mMTC), ultra reliability low latency communication (URLLC), etc.

The eMBB aims to provide a data rate that is even higher than that supported by existing LTE, LTE-A, or LTE-Pro. For example, in the 5G communication system, the eMBB should be able to provide a peak data rate of 20 Gbps in the downlink and a peak data rate of 10 Gbps in the uplink from the viewpoint of one base station. In addition, the 5G communication systems should provide not only the peak data rate but also an increased user perceived data rate of a UE. To meet these requirements, there is a need to improve various transmission and reception technologies, including more enhanced multi-input multi-output (MIMO) transmission technology. Furthermore, LTE transmits signals using a maximum transmission bandwidth of 20 MHz in the 2 GHz band, while 5G communication systems may satisfy data rates required by the 5G communication systems by using a wider frequency bandwidth than 20 MHz in the 3 to 6 GHz or 6 GHz or higher frequency bands.

Simultaneously, the mMTC is being considered to support application services such as the Internet of Things (IoT) in 5G communication systems. To efficiently provide the IoT, the mMTC requires support for access of a large number of UEs within a cell, enhanced UE coverage, enhanced battery life, and reduced UE costs, etc. The IoT is attached to various sensors and devices to provide communication functions, and therefore, should be able to support a large number of UEs (e.g., 1,000,000 UEs/km²) within a cell. In addition, due to the nature of services, the UE supporting the mMTC is highly likely to be located in shadow areas, such as basements of buildings where cells may not cover. Therefore, the UE may require even wider coverage than other services provided by 5G communication systems. The UE supporting the mMTC should be configured to be a low-cost UE, and since it is difficult to frequently replace the battery of the UE, a very long battery life time, such as 10 to 15 years, may be required.

Finally, the URLLC refers to a cellular-based wireless communication service used for specific mission-critical purposes. As an example of the URLLC, services used for remote control of robots or machinery, industrial automation, unmanned aerial vehicles, remote health care, and emergency alert, etc., may be considered. Therefore, the communication provided by the URLLC should provide extremely low latency and extremely high reliability. For example, services supporting the URLLC should satisfy air interface latency less than 0.5 milliseconds, and at the same time, has requirements of a packet error rate of 10-5 or less. Therefore, for the services supporting the URLLC, 5G systems should provide a shorter transmit time interval (TTI) than other services, and at the same time, may require design specifications that allocate wider resources in the frequency band to secure the reliability of communication links.

Three services of the 5G, that is, eMBB, URLLC, and mMTC, may be multiplexed and transmitted within one system. In this case, to satisfy distinct requirements of each service, different transmission and reception techniques and transmission and reception parameters may be used between services. Of course, 5G is not limited to the three services described above.

### [NR Time-Frequency Resource]

A frame structure of a 5G system will be described in more detail below with reference to the drawings.

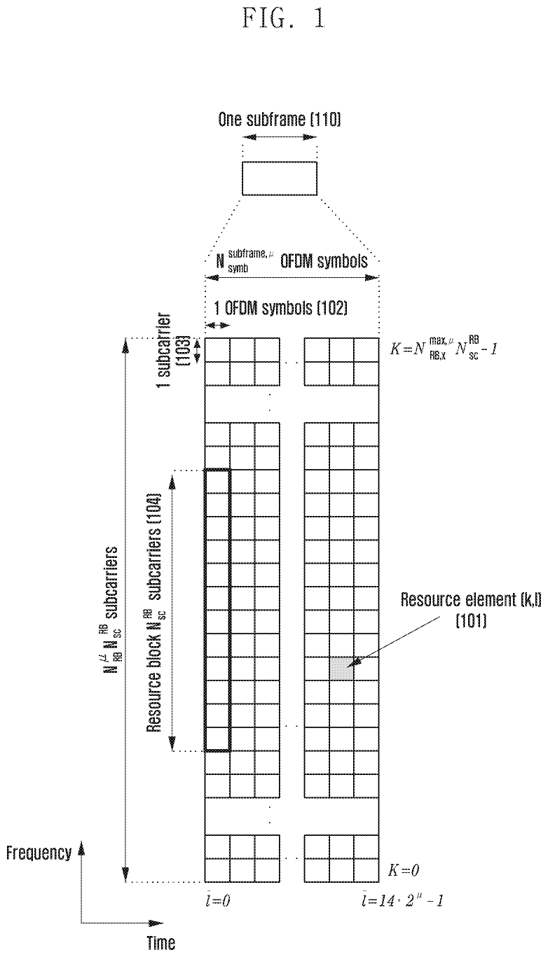

FIG. 1 is a diagram illustrating a basic structure of a time-frequency domain that is a wireless resource area where data or control channels are transmitted in a 5G system.

In FIG. 1, a horizontal axis represents a time domain, and a vertical axis represents a frequency domain. A basic unit of resources in the time and frequency domains is a resource element (RE) 101, which may be defined as 1 orthogonal frequency division multiplexing (OFDM) symbol 102 on a time-domain and 1 subcarrier 103 on a frequency-domain. In the frequency domain,

$${N}_{sc}^{RB}$$

(e.g., 12) contiguous REs may constitute one resource block (RB) 104.

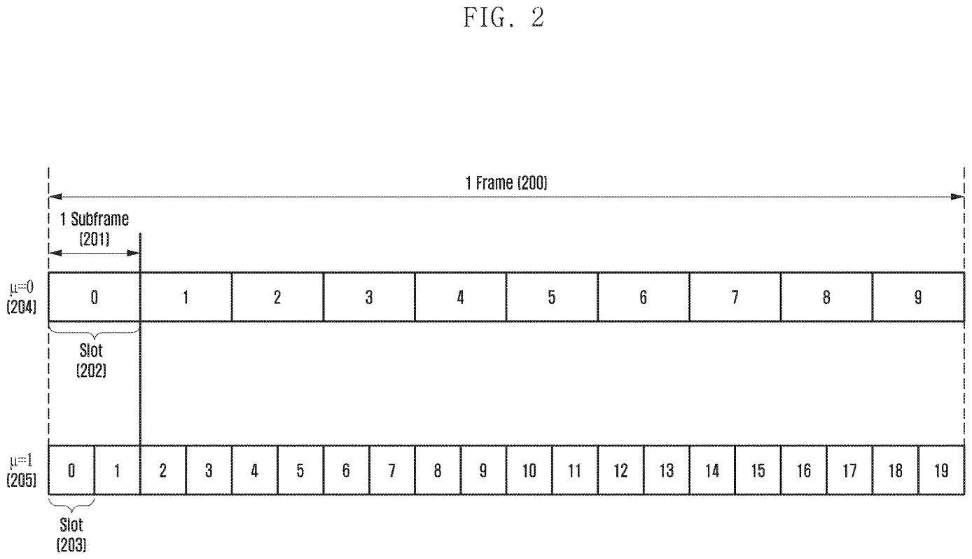

FIG. 2 is a diagram illustrating a structure of a frame, a subframe, and a slot in the wireless communication system according to an embodiment of the present disclosure.

FIG. 2 illustrates an example of a structure of a frame 200, a subframe 201, and a slot 202. 1 frame 200 may be defined as 10 ms. 1 subframe 201 may be defined as 1 ms. Accordingly, 1 frame 200 may be composed of a total of 10 subframes 201. 1 slot 202 and 203 may be defined as 14 OFDM symbols (i.e., the number

$${N}_{symb}^{slot}$$

of symbols per slot=14). 1 subframe 201 may be composed of one or more slots 202 and 203, and the number of slots 202 and 203 per subframe 201 may vary depending on configuration values μ 204 and 205 for subcarrier spacing. In an example of FIG. 2, a case where the configuration value for the subcarrier spacing is μ=0 204 and a case where the configuration value for the subcarrier spacing is μ=1 205 are illustrated. When μ=0 204, 1 subframe 201 may be composed of one slot 202, and when μ=1 (205), 1 subframe 201 may be composed of two slots 203. That is, the number

$${N}_{slot}^{subframe , μ}$$

of slots per subframe may vary depending on the configuration value μ for the subcarrier spacing, and the number

$${N}_{slot}^{frame , μ}$$

of slots per frame may vary accordingly. The

$${N}_{slot}^{subframe , μ} and {N}_{slot}^{subframe , μ}$$

depending on each subcarrier spacing configuration μ may be defined as in Table 1 below.

TABLE 1

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Next, the bandwidth part (BWP) configuration in the 5G communication system will be described in detail with reference to the drawings.

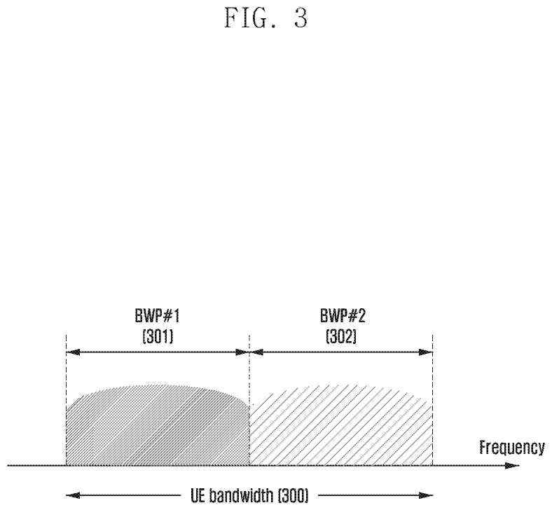

FIG. 3 is a diagram illustrating an example of a bandwidth part configuration in the wireless communication system according to an embodiment of the present disclosure.

FIG. 3 illustrates an example where a UE bandwidth 300 is configured with two bandwidth parts, that is, bandwidth part #1 (BWP #1) 301 and bandwidth part #2 (BWP #2) 302. A base station may configure one or more bandwidth parts for the UE, and may configure pieces of information as shown in Table 2 below for each bandwidth part.

TABLE 2

| | |
|---|---|
| BWP ::= | SEQUENCE { |
| bwp-Id | BWP-Id, |
| locationAndBandwidth | INTEGER (1..65536), |
| subcarrierSpacing | ENUMERATED {n0, n1, n2, n3, n4, n5}, |
| cyclicPrefix | ENUMERATED { extended } |
| } | |

Of course, the above examples are not limited, and in addition to the above configuration information, various parameters related to the bandwidth part may be configured for the UE. The above pieces of information may be transferred from the base station to the UE via higher layer signaling, such as radio resource control (RRC) signaling. At least one of one or more configured bandwidth parts may be activated. Whether the configured bandwidth part is activated may be semi-statically transferred from the base station to the UE via the RRC signaling or dynamically transferred via downlink control information (DCI).

According to some embodiments, a UE before radio resource control (RRC) connection may be configured with an initial bandwidth part (Initial BWP) for initial access via a master information block (MIB) from the base station. More specifically, during the initial access phase, the UE may receive configuration information about a control resource set (CORESET) and a search space where PDCCH for receiving system information (which may correspond to remaining system information (RMSI) or system information block 1 (SIB1)) required for the initial access may be transmitted via the MIB. The control resource set and search space configured by the MIB may each be regarded as identity (ID) 0. The base station may notify the UE of configuration information such as frequency allocation information, time allocation information, and numerology for control resource set #0 via the MIB. In addition, the base station may notify the UE of configuration information about monitoring periodicity and occasion for the control resource set #0, i.e., configuration information for search space #0, via the MIB. The UE may regard the frequency domain configured as the control resource set #0 acquired from the MIB as the initial bandwidth part for the initial access. In this case, the identity (ID) of the initial bandwidth part may be regarded as 0.

The configuration of the bandwidth part supported by the 5G may be used for various purposes.

According to some embodiments, when the bandwidth supported by the UE is smaller than the system bandwidth, this may be supported via the bandwidth part configuration. For example, by configuring, by the base station, the frequency position (configuration information 2) of the bandwidth part for the UE, the UE may transmit and receive data at a specific frequency location within the system bandwidth.

In addition, according to some embodiments, the base station may configure multiple bandwidth parts for the UE to support different numerologies. For example, to support data transmission and reception using both 15 kHz subcarrier spacing and 30 kHz subcarrier spacing for a certain UE, two bandwidth parts may be configured with 15 kHz and 30 kHz subcarrier spacing, respectively. Different bandwidth parts may be frequency-division multiplexed, and when data is to be transmitted and received in specific subcarrier spacing, the bandwidth part configured for the corresponding subcarrier spacing may be activated.

Furthermore, according to some embodiments, the base station may configure bandwidth parts with different bandwidth sizes for a UE to reduce power consumption of a UE. For example, when the UE supports a very large bandwidth, for example, 100 MHz bandwidth, and always transmits and receives data in the corresponding bandwidth, very large power consumption may occur. In particular, performing monitoring of unnecessary downlink control channels in a large bandwidth of 100 MHz in a situation where there is no traffic may be very inefficient in terms of power consumption. To reduce the power consumption of the UE, the base station may configure a bandwidth part with a relatively small bandwidth, for example, 20 MHz bandwidth part, for a UE. In the situation where there is no traffic, the UE may perform the monitoring operation in the 20 MHz bandwidth part, and when data is generated, the UE may transmit and receive data in the 100 MHz bandwidth part according to the instructions of the base station.

In the method for configuring a bandwidth part, UEs before RRC connection may receive configuration information for the initial bandwidth part via the master information block (MIB) during the initial access phase. More specifically, the UE may be configured with a control resource set (CORESET) for a downlink control channel on which the downlink control information (DCI) for scheduling a system information block (SIB) may be transmitted from a MIB of a physical broadcast channel (PBCH). The bandwidth of the control resource set configured by the MIB may be regarded as the initial bandwidth part, and the UE may receive a physical downlink shared channel (PDSCH) on which the SIB is transmitted via the configured initial bandwidth part. In addition to the purpose of receiving the SIB, the initial bandwidth part may also be utilized for other system information (OSI), paging, and random access.

### [Bandwidth Part (BWP) Switch]

When a UE is configured with one or more bandwidth parts, the base station may instruct the UE to change (or switch and transition) the bandwidth part using a bandwidth part indicator field in the DCI. For example, in FIG. 3, when the currently activated bandwidth part of the UE is bandwidth part #1 301, the base station may instruct the UE to use bandwidth part #2 302 by the bandwidth part indicator within the DCI, and the UE may perform the bandwidth part switch to the bandwidth part #2 302 indicated by the bandwidth part indicator within the received DCI.

As described above, since the DCI-based bandwidth part switch may be indicated by the DCI scheduling the PDSCH or PUSCH, when the UE receives a bandwidth part switch request, the UE should be able to seamlessly receive or transmit the PDSCH or PUSCH scheduled by the corresponding DCI in the switched bandwidth part. To this end, requirements for a delay time T_{BWP} required when changing the bandwidth part are regulated in the standard, which may be defined as in Table 3, for example.

TABLE 3

BWP switch delay T_{BWP} (slots)

| μ | NR Slot length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}
Depends on UE capability.
Note 2:
If the BWP switch involves changing of SCS, the BWP switch delay is determined by the larger one between the SCS before BWP switch and the SCS after BWP switch.

The requirements for the bandwidth part switch delay time support Type 1 or Type 2, depending on UE's capability. The UE may report the supportable bandwidth part delay time type to the base station.

According to the requirements for the above-described bandwidth part switch delay time, when the UE receives DCI including a bandwidth part switch indicator in slot n, the UE may complete the change to the new bandwidth part indicated by the bandwidth part switch indicator at a point in time no later than slot n+T_{BWP} and perform transmission and reception of a data channel scheduled by the corresponding DCI in the changed new bandwidth part. When scheduling the data channel with the new bandwidth part, the base station may determine the time-domain resource allocation for the data channel in consideration of the bandwidth part switch delay time T_{BWP} of the UE. That is, when scheduling the data channel with the new bandwidth part, the base station may schedule the corresponding data channel after the bandwidth part switch delay time in the method for determining time-domain resource allocation for a data channel. Accordingly, the UE may not expect that the DCI indicating the bandwidth part change indicates a slot offset (K0 or K2) value smaller than the bandwidth part switch delay time T_{BWP}.

When the UE receives the DCI (e.g., DCI format 1_1 or 0_1) indicating the bandwidth part change, the UE may not perform any transmission or reception during a time interval from a third symbol of a slot in which the PDCCH including the corresponding DCI is received to a start point of a slot indicated by the slot offset (K0 or K2) value indicated by a time-domain resource allocation indicator field within the corresponding DCI. For example, when the UE receives the DCI indicating the bandwidth part change in slot n and the slot offset value indicated by the corresponding DCI is K, the UE may not perform any transmission or reception from the third symbol of slot n to a symbol (i.e., the last symbol of slot n+K−1) before slot n+K.

### [SS/PBCH Block]

Next, a synchronization signal (SS)/PBCH block in 5G will be described.

The SS/PBCH block may refer to a physical layer channel block composed of a primary SS (PSS), a secondary SS (SSS), and a PBCH. Specifically, the SS/PBCH block is as follows.
PSS: It denotes a signal that serves as a reference for downlink time/frequency synchronization and provides partial information of cell ID.
SSS: It denotes a signal that serves as a reference for downlink time/frequency synchronization and provides the remaining cell ID information not provided by the PSS. Additionally, it may serve as a reference signal for PBCH demodulation.
PBCH: It provides essential system information required for a UE to transmit and receive a data channel and a control channel. The essential system information may include search space-related control information indicating radio resource mapping information for the control channel, scheduling control information for a separate data channel that transmits the system information, etc.
SS/PBCH Block: SS/PBCH Block is composed of a combination of the PSS, SSS, and PBCH. One or more SS/PBCH blocks may be transmitted within a 5 ms time, and each SS/PBCH block transmitted may be distinct by an index.

The UE may detect the PSS and SSS during the initial access phase and decode the PBCH. The UE may acquire the MIB from the PBCH, and may be configured with control resource set (CORESET) #0 (which may correspond to the control resource set with a control resource set index of 0) from the MIB. The UE may monitor control resource set #0 under the assumption that the selected SS/PBCH block and a demodulation reference signal (DMRS) transmitted in control resource set #0 are quasi co located (QCL). The UE may receive the system information using the downlink control information transmitted in the control resource set #0. The UE may acquire random access channel (RACH)-related configuration information required for initial access from the received system information. The UE may transmit a physical RACH (PRACH) to the base station in consideration of the selected SS/PBCH index, and the base station receiving the PRACH may acquire information about the SS/PBCH block index selected by the UE. The base station may know which of the SS/PBCH blocks the UE has selected and that the UE monitors the control resource set #0 associated with the selected SS/PBCH block.

### [PDCCH: DCI Association]

Next, the downlink control information (DCI) in the 5G system will be described in detail below.

In the 5G system, scheduling information for uplink data (or physical uplink shared channel (PUSCH)) or downlink data (or physical downlink shared channel (PDSCH)) is transferred from the base station to the UE via the DCI. The UE may monitor fallback and non-fallback DCI formats on the PUSCH or PDSCH. The fallback DCI format may be composed of fixed fields predefined between the base station and the UE, and the non-fallback DCI format may include a configurable field.

The DCI may be transmitted via a physical downlink control channel (PDCCH) after being subjected to a channel coding and modulation process. A cyclic redundancy check (CRC) is attached to a DCI message payload, and the CRC may be scrambled by a radio network temporary identifier (RNTI) that corresponds to a UE's identity. Different RNTIs may be used depending on the purpose of the DCI message, such as UE-specific data transmission, power control commands, or random access responses. In other words, the RNTI is not explicitly transmitted, but is included in a CRC calculation process and transmitted. When receiving the DCI message transmitted via the PDCCH, the UE confirms the CRC using the allocated RNTI. When the CRC confirmation result is correct, the UE may know that the corresponding message has been transmitted to the UE.

For example, the DCI scheduling the PDSCH for system information (SI) may be scrambled by SI-RNTI. The DCI scheduling PDSCH for a random access response (RAR) message may be scrambled by RA-RNTI. The DCI scheduling PDSCH for a paging message may be scrambled by P-RNTI. The DCI notifying a slot format indicator (SFI) may be scrambled by SFI-RNTI. The DCI notifying transmit power control (TPC) may be scrambled by TPC-RNTI. The DCI scheduling the UE-specific PDSCH or PUSCH may be scrambled by cell RNTI (C-RNTI).

DCI format 0_0 may be used as fallback DCI for scheduling the PUSCH. In this case, the CRC may be scrambled by the C-RNTI. The DCI format 0_0 with the CRC scrambled by the C-RNTI may include, for example, pieces of information in Table 4.

```
TABLE 4
  - Identifier for DCI formats - [1] bit
  $‐ Frequency domain resource assignment [ ⌈ {log}_{2} ( {N}_{RB}^{UL , BWP} ( {N}_{RB}^{UL , BWP} + 1 ) / 2 ) ⌉ ] bits$
  - Time domain resource assignment - X bits
  - Frequency hopping flag - 1 bit.
  - Modulation and coding scheme - 5 bits
  - New data indicator - 1 bit
  - Redundancy version - 2 bits
  - HARQ process number - 4 bits
  - TPC command for scheduled PUSCH - [2] bits
  - UL/SUL indicator - 0 or 1 bit
```

DCI format 0_1 may be used as the non-fallback DCI for scheduling the PUSCH. In this case, the CRC may be scrambled by the C-RNTI. The DCI format 0_1 with the CRC scrambled by the C-RNTI may include, for example, pieces of information in Table 5.

```
TABLE 5
  - Carrier indicator - 0 or 3 bits
  - UL/SUL indicator - 0 or 1 bit
  - Identifier for DCI formats - [1] bits
  - Bandwidth part indicator - 0, 1 or 2 bits
  - Frequency domain resource assignment
        $\cdot For resource allocation type 0 , ⌈ {N}_{RB}^{UL , BWP} / P ⌉ bits$
        $\cdot For resource allocation type 1 , ⌈ {log}_{2} ( {N}_{RB}^{UL , BWP} ( {N}_{RB}^{UL , BWP} + 1 ) / 2 ) ⌉ bits$
  - Time domain resource assignment - 1, 2, 3, or 4 bits
  - VRB-to-PRB mapping - 0 or 1 bit, only for resource allocation type 1.
        • 0 bit if only resource allocation type 0 is configured;
        • 1 bit otherwise.
  - Frequency hopping flag - 0 or 1 bit, only for resource allocation type 1.
        • 0 bit if only resource allocation type 0 is configured;
        • 1 bit otherwise.
  - Modulation and coding scheme - 5 bits
  - New data indicator - 1 bit
  - Redundancy version - 2 bits
  - HARQ process number - 4 bits
  - 1st downlink assignment index - 1 or 2 bits
        • 1 bit for semi-static HARQ-ACK codebook;
        • 2 bits for dynamic HARQ-ACK codebook with single HARQ-
          ACK codebook.
  - 2nd downlink assignment index - 0 or 2 bits
        • 2 bits for dynamic HARQ-ACK codebook with two HARQ-
          ACK sub-codebooks;
        • 0 bit otherwise.
  - TPC command for scheduled PUSCH - 2 bits
  $‐ SRS resource indicator - ⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{SRS} ) ⌉ bits$
        $\cdot ⌈ {log}_{2} ( {\sum }_{k = 1}^{{L}_{max}} ( \begin{matrix}{N}_{SRS} \\ k\end{matrix} ) ) ⌉ bits for non - codebook based PUSCH$
            transmission;
        • [log₂(N_{SRS})] bits for codebook based PUSCH transmission.
  - Precoding information and number of layers - up to 6 bits
  - Antenna ports - up to 5 bits
  - SRS request - 2 bits
  - CSI request - 0, 1, 2, 3, 4, 5, or 6 bits
  - CBG transmission information - 0, 2, 4, 6, or 8 bits
  - PTRS-DMRS association - 0 or 2 bits.
  - beta offset indicator - 0 or 2 bits
  - DMRS sequence initialization - 0 or 1 bit
```

DCI format 1_0 may be used as the fallback DC for scheduling the PDSCH. In this case, the CRC may be scrambled by the C-RNTI. The DCI format 1_0 with the CRC scrambled by the C-RNTI may include, for example, pieces of information in Table 6.

```
TABLE 6
  - Identifier for DCI formats - [1] bit
  - Frequency domain resource assignment -
$[ ⌈ {log}_{2} ( {N}_{RB}^{DL , BWP} ( {N}_{RB}^{DL , BWP} + 1 ) / 2 ) ⌉ ] bits$
  - Time domain resource assignment - X bits
  - VRB-to-PRB mapping - 1 bit.
  - Modulation and coding scheme - 5 bits
  - New data indicator - 1 bit
  - Redundancy version - 2 bits
  - HARQ process number - 4 bits
  - Downlink assignment index - 2 bits
  - TPC command for scheduled PUCCH - [2] bits
  - PUCCH resource indicator - 3 bits
  - PDSCH-to-HARQ feedback timing indicator - [3] bits
```

DCI format 1_1 may be used as the non-fallback DCI for scheduling the PDSCH. In this case, the CRC may be scrambled by the C-RNTI. The DCI format 1_1 with the CRC scrambled by the C-RNTI may include, for example, pieces of information in Table 7.

```
TABLE 7
  - Carrier indicator - 0 or 3 bits
  - Identifier for DCI formats - [1] bits
  - Bandwidth part indicator - 0, 1 or 2 bits
  - Frequency domain resource assignment
        $\cdot For resource allocation type 0 , ⌈ {N}_{RB}^{DL , BWP} / P ⌉ bits$
        $\cdot For resource allocation type 1 , ⌈ {log}_{2} ( {N}_{RB}^{DL , BWP} ( {N}_{RB}^{DL , BWP} + 1 ) / 2 ) ] bits$
  - Time domain resource assignment -1, 2, 3, or 4 bits
  - VRB-to-PRB mapping - 0 or 1 bit, only for resource allocation type 1.
        • 0 bit if only resource allocation type 0 is configured;
        • 1 bit otherwise.
  - PRB bundling size indicator - 0 or 1 bit
  - Rate matching indicator - 0, 1, or 2 bits
  - ZP CSI-RS trigger - 0, 1, or 2 bits
  For transport block 1:
  - Modulation and coding scheme - 5 bits
  - New data indicator - 1 bit
  - Redundancy version - 2 bits
  For transport block 2:
  - Modulation and coding scheme - 5 bits
  - New data indicator - 1 bit
  - Redundancy version - 2 bits
  - HARQ process number - 4 bits
  - Downlink assignment index - 0 or 2 or 4 bits
  - TPC command for scheduled PUCCH - 2 bits
  - PUCCH resource indicator - 3 bits
  - PDSCH-to-HARQ_feedback timing indicator - 3 bits
  - Antenna ports - 4, 5 or 6 bits
  - Transmission configuration indication - 0 or 3 bits
  - SRS request - 2 bits
  - CBG transmission information - 0, 2, 4, 6, or 8 bits
  - CBG flushing out information - 0 or 1 bit
  - DMRS sequence initialization - 1 bit
```

### [PDCCH: CORESET, REG, CCE, Search Space]

The downlink control channel in a 5G communication system will be described in more detail below with reference to the drawings.

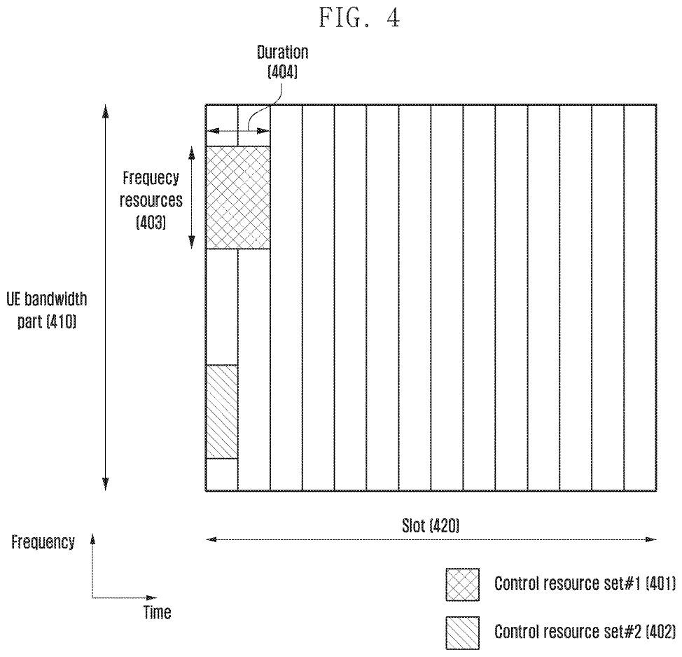

FIG. 4 is a diagram illustrating an example of the control resource set (CORESET) in which the downlink control channel is transmitted in the 5G wireless communication system. FIG. 4 illustrates an example in which two control resource sets (control resource set #1 401 and control resource set #2 402) are configured within a UE bandwidth part 410 on a frequency-domain and within one slot 420 on a time-domain. The control resource sets 401 and 402 may be configured within specific frequency resources 403 within the entire UE bandwidth part 410 on the frequency-domain. The control resource sets 401 and 402 may be configured as one or more OFDM symbols on the time-domain, which may be defined as a control resource set duration 404. Referring to the example illustrated in FIG. 4, the control resource set #1 401 is configured to a control resource set duration of 2 symbols, and the control resource set #2 402 is configured to a control resource set duration of 1 symbol.

In the above-described 5G, the control resource set may be configured for the UE by the base station via the higher layer signaling (e.g., the system information, the master information block (MIB), the radio resource control (RRC) signaling). Configuring the control resource set for the UE refers to providing information such as a control resource set identity, a frequency position of the control resource set, and symbol duration of the control resource set. For example, pieces of information in Table 8 may be included.

TABLE 8

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |
| frequencyDomainResources | BIT STRING (SIZE (45)), |
| duration | INTEGER (1..maxCoReSetDuration), |
| cce-REG-MappingType | CHOICE { |
| interleaved | SEQUENCE { |
| reg-BundleSize | ENUMERATED {n2, n3, n6}, |
| precoderGranularity | ENUMERATED |

{sameAsREG-bundle, allContiguousRBs},

| | |
|---|---|
| interleaverSize | ENUMERATED {n2, n3, n6} |

```
        shiftIndex INTEGER(0..maxNrofPhysicalResourceBlocks−1)
    },
```

| | |
|---|---|
| nonInterleaved | NULL |

},

| | |
|---|---|
| tci-StatesPDCCH | SEQUENCE(SIZE |

```
    (1..maxNrofTCI-StatesPDCCH)) OF TCI-StateId
      OPTIONAL,
```

| | |
|---|---|
| tci-PresentInDCI | ENUMERATED{enabled} |

}

In Table 8, tci-StatesPDCCH (simply referred to as transmission configuration indication (TCI) state) configuration information may include information on one or more synchronization signal (SS)/physical broadcast channel (PBCH) block index or channel state information reference signal (CSI-RS) index that are in a quasi co located (QCL) relation with the DMRS transmitted in the corresponding control resource set.

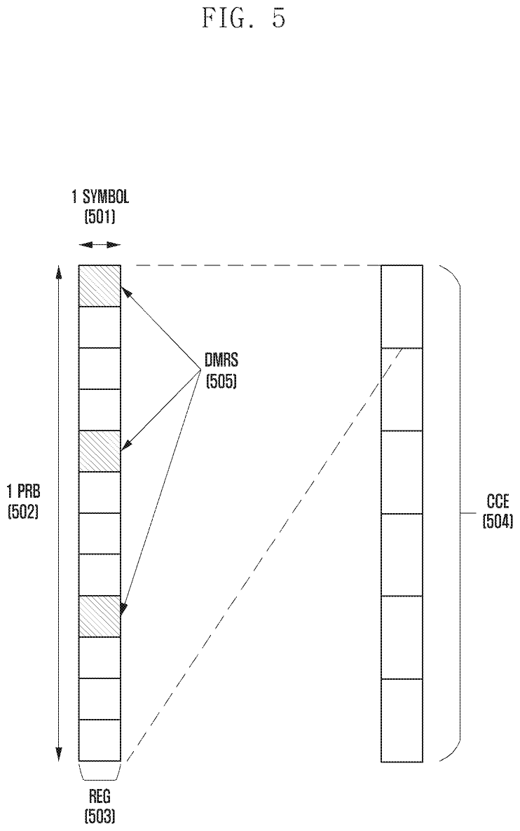

FIG. 5 is a diagram illustrating an example of a basic unit of time and frequency resources constituting the downlink control channel that may be used in the 5G. Referring to FIG. 5, the basic unit of the time and frequency resources constituting the control channel may be referred to as a resource element group (REG) 503, and the REG 503 may be defined as 1 OFDM symbol 501 on the time-domain and 1 physical resource block (PRB) 502 on the frequency-domain, i.e., 12 subcarriers. The base station may constitute a downlink control channel allocation unit by concatenating the REG 503.

As illustrated in FIG. 5, when the basic unit for allocating the downlink control channel in the 5G is a control channel element (CCE) 504, 1 CCE 504 may be composed of multiple REGs 503. Describing the REG 503 illustrated in FIG. 5 as an example, the REG 503 may be composed of 12 REs. When 1 CCE 504 is composed of 6 REGs 503, 1 CCE 504 may be composed of 72 REs. When a downlink control resource set is configured, the downlink control resource set may be composed of multiple CCEs 504, and a specific downlink control channel may be mapped to one or more CCEs 504 depending on an aggregation level (AL) within the control resource set and transmitted. The CCEs 504 within the control resource set are distinct by numbers. In this case, the numbers of the CCEs 504 may be assigned according to a logical mapping scheme.

The basic unit of the downlink control channel illustrated in FIG. 5, i.e., the REG 503 may include both REs to which the DCI is mapped and areas to which the DMRSs 505, which are reference signals for decoding the REs, are mapped. As illustrated in FIG. 5, 3 DMRSs 505 within 1 REG 503 may be transmitted. The number of CCEs required to transmit the PDCCH may be 1, 2, 4, 8, or 16 depending on the aggregation level (AL), and the number of different CCEs may be used to implement link adaptation of the downlink control channel. For example, when AL=L, one downlink control channel may be transmitted via L CCEs. The UE should detect signals without knowing the information about the downlink control channel. To facilitate blind decoding, a search space representing a set of CCEs was defined. The search space is a set of downlink control channel candidates composed of the CCEs that the UE should attempt to decode at a given aggregation level. Since there are multiple aggregation levels that form one bundle with 1, 2, 4, 8, or 16 CCEs, the UE may have multiple search spaces. A search space set may be defined as a set of search spaces at all configured aggregation levels.

The search space may be classified into a common search space and a UE-specific search space. A certain group of UEs or all UEs may search the common search space of the PDCCH to receive cell-common control information, such as dynamic scheduling or a paging message for the system information. For example, PDSCH scheduling allocation information for transmitting the SIB, which includes the operator information of the cell, etc., may be received by searching the common search space of the PDCCH. The common search space may be defined as a set of pre-arranged CCEs since a certain group of UEs or all UEs should receive the PDCCH. Scheduling allocation information for the UE-specific PDSCH or the PUSCH may be received by monitoring the UE-specific search space of the PDCCH. The UE-specific search space may be defined UE-specifically as a function of the UE's identity and various system parameters.

In 5G, the parameters for the PDCCH search space may be configured for the UE by the base station via the higher layer signaling (e.g., SIB, MIB, and RRC signaling). For example, the base station may configure, for the UE, the number of PDCCH candidates at each aggregation level L, the monitoring periodicity for the search space, the monitoring occasion on a per-symbol basis within the slot for the search space, the search space type (common search space or UE-specific search space), a combination of the DCI format and RNTI to be monitored in the corresponding search space, the control resource set index for monitoring the search space, etc. For example, pieces of information in Table 9 may be included.

TABLE 9

| | |
|---|---|
| SearchSpace ::= | SEQUENCE { |

```
  -- Identity of the search space. SearchSpaceId = 0 identifies the SearchSpace
    configured via PBCH (MIB) or ServingCellConfigCommon.
```

| | |
|---|---|
| searchSpaceId | SearchSpaceId, |
| controlResourceSetId | ControlResourceSetId, |
| monitoringSlotPeriodicityAndOffset | CHOICE { |
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |

```
  }
  duration INTEGER (2..2559)
```

| | |
|---|---|
| monitoringSymbolsWithinSlot | BIT STRING (SIZE (14)) |
| nrofCandidates | SEQUENCE { |
| aggregationLevel1 | ENUMERATED {n0, n1, n2, |

n3, n4, n5, n6, n8},

| | |
|---|---|
| aggregationLevel2 | ENUMERATED {n0, n1, n2, |

n3, n4, n5, n6, n8},

| | |
|---|---|
| aggregationLevel4 | ENUMERATED {n0, n1, n2, |

n3, n4, n5, n6, n8},

| | |
|---|---|
| aggregationLevel8 | ENUMERATED {n0, n1, n2, |

n3, n4, n5, n6, n8},

| | |
|---|---|
| aggregationLevel16 | ENUMERATED {n0, n1, n2, |

```
    n3, n4, n5, n6, n8}
  },
```

| | |
|---|---|
| searchSpaceType | CHOICE { |

```
    -- Configures this search space as common search space (CSS) and DCI
    formats to monitor.
```

| | |
|---|---|
| common | SEQUENCE { |

}

| | |
|---|---|
| ue-Specific | SEQUENCE { |

```
      -- Indicates whether the UE monitors in this USS for DCI formats 0-0
    and 1-0 or for formats 0-1 and 1-1.
```

| | |
|---|---|
| formats | ENUMERATED {formats0-0- |

```
    And-1-0, formats0-1-And-1-1},
      ...
        }
```

Depending on the configuration information, the base station may configure one or more search space sets for the UE. According to some embodiments, the base station may configure search space set 1 and search space set 2 for the UE, configure the UE to monitor, in the common search space, DCI format A scrambled by X-RNTI in the search space set 1, and configure the UE to monitor, in the UE-specific search space, DCI format B scrambled by Y-RNTI in the search space set 2.

Depending on the configuration information, one or more search space sets may present in the common search space or the UE-specific search space. For example, search space set #1 and search space set #2 may be configured as the common search space, and search space set #3 and search space set #4 may be configured as the UE-specific search space.

The following combinations of the DCI format and RNTI may be monitored in the common search space. Of course, the combinations are not limited to the following examples.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

The following combinations of the DCI format and RNTI may be monitored in the UE-specific search space. Of course, the combinations are not limited to the following examples.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The specified RNTIs may follow the following definitions and purposes.

Cell RNTI (C-RNTI): For UE-specific PDSCH scheduling

Temporary Cell RNTI (TC-RNTI): For UE-specific PDSCH scheduling

Configured Scheduling RNTI (CS-RNTI): For semi-statically configured UE-specific PDSCH scheduling

Random Access RNTI (RA-RNTI): For the PDSCH scheduling during the random access phase.

Paging RNTI (P-RNTI): For the PDSCH scheduling on which the paging is transmitted.

System Information RNTI (SI-RNTI): For the PDSCH scheduling on which the system information is transmitted.

Interruption RNTI (INT-RNTI): For the purpose of notifying whether puncturing is applied to the PDSCH.

Transmit Power Control for PUSCH RNTI (TPC-PUSCH-RNTI): For power control command indication on the PUSCH.

Transmit Power Control for PUCCH RNTI (TPC-PUCCH-RNTI): For power control command indication on the PUCCH.

Transmit Power Control for SRS RNTI (TPC-SRS-RNTI): For power control command indication on the SRS.

The DCI formats specified above may follow the exemplary definitions as shown in Table 10.

TABLE 10

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

In 5G, a search space at aggregation level L in control resource set p and search space set s may be expressed as shown in Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + 1 \qquad Equation 1$$

L: Aggregation level
n_{CI}: Carrier index
N_{CCE,p}: Total number of CCEs present in control resource set p

$${n}_{s , f}^{μ} :$$

Slot index

$${M}_{s , max}^{( L )} :$$

The number of PDCCH candidates at aggregation level L

$${m}_{s , {n}_{CI}} = 0 , … , {M}_{s , max}^{( L )} - 1 :$$

PDCCH candidate index at aggregation level L
i=0, . . . , L−1

$${Y}_{p , {n}_{s , f}^{μ}} = ( {A}_{p} \cdot {Y}_{p , {n}_{s , f}^{μ} - 1} ) mod D ,$$

Y_{p,-1}=n_{RNTI}≠0, Aₚ=39827 for p mod 3=0, Aₚ=39829 for p mod 3=1, Aₚ=39839 for p mod 3=2, D=65537
n_{RNTI}: UE's identity

$${Y}_{p , {n}_{s , f}^{μ}}$$

value may correspond to 0 for the common search space.

$${Y}_{p , {n}_{s , f}^{μ}}$$

value may correspond to a value varying depending on the UE's identity (C-RNTI or ID configured for the UE by the base station) and the time index for the UE-specific search space.

In 5G, multiple search space sets may be configured with different parameters (e.g., parameters in Table 9), so the aggregation of the search space sets monitored by the UE at each point in time may vary. For example, when the search space set #1 is configured with X-slot periodicity, the search space set #2 is configured with Y-slot periodicity, and X and Y are different, the UE may monitor both the search space set #1 and the search space set #2 in a specific slot, and monitor either the search space set #1 or the search space set #2 in a specific slot.

### [PDCCH: BD/CCE Limit]

When multiple search space sets are configured for the UE, the following conditions may be considered in the method for determining the search space set to be monitored by the UE.

When the UE receives a value of the higher layer signaling monitoringCapabilityConfig-r16 configured to r15MonitoringCapability, the UE defines the maximum values of the number of PDCCH candidates that the UE may monitor and the number of CCEs constituting the entire search space (here, the entire search space refers to the entire CCE set corresponding to a union area of multiple search space sets) per slot. When the value of the monitoringCapabilityConfig-r16 is configured to r16monitoringcapability, the UE defines the maximum values of the number of PDCCH candidates the UE may monitor and the number of CCEs constituting the entire search space (here, the entire search space refers to the entire CCE set corresponding to the union area of multiple search space sets) per span.

### [Condition 1: Limitation on Maximum Number of PDCCH Candidates]

As described above, depending on the configuration value of the higher layer signaling, when the maximum number M^{μ} of PDCCH candidates that the UE may monitor is defined, per slot, in a cell configured with a subcarrier spacing of 15-2 kHz, the maximum number M^{μ} may follow Table 11 below, and when the maximum number M^{μ} is defined per span, the maximum number M^{μ} may follow Table 12 below.

TABLE 11

| | Maximum number of PDCCH candidates per slot |
|---|---|
| μ | and per serving cell (M^{μ}) |
| 0 | 44 |
| 1 | 36 |
| 2 | 22 |
| 3 | 20 |

TABLE 12

| | Maximum number M^{μ} of monitored PDCCH | | |
|---|---|---|---|
| | candidates per span for combination (X, Y) | | |
| | and per serving cell | | |
| μ | (2, 2) | (4, 3) | (7, 3) |
| 0 | 14 | 28 | 44 |
| 1 | 12 | 24 | 36 |

### [Condition 2: Limitation on Maximum Number of CCEs]

As described above, depending on the configuration value of the higher layer signaling, when the maximum number C of CCEs constituting the entire search space (here, the entire search space refers to the entire CCE set corresponding to the union area of multiple search space sets) is defined, per slot, in the cell configured with subcarrier spacing of 15-2 kHz, the maximum number C may follow Table 13 below and when the maximum number CU is defined per span, the maximum number CU may follow Table 14 below.

TABLE 13

| | Maximum number of non-overlapped CCEs per slot and per |
|---|---|
| μ | serving cell (C^{μ}) |
| 0 | 56 |
| 1 | 56 |
| 2 | 48 |
| 3 | 32 |

TABLE 14

Maximum number C^{μ} of non-overlapped CCEs per
span for combination (X, Y) and per serving cell

| μ | (2, 2) | (4, 3) | (7, 3) |
|---|---|---|---|
| 0 | 18 | 36 | 56 |
| 1 | 18 | 36 | 56 |

For convenience of description, the situation where both the conditions 1 and 2 are satisfied at a specific point in time is defined as “condition A.” Therefore, not satisfying condition A may mean not satisfying at least one of the conditions 1 and 2.

### [PDCCH Overbooking]

Depending on the configuration of the search space sets of the base station, the case where the condition A is not satisfied at a specific point in time may occur. When the condition A is not satisfied at a specific point in time, the UE may select and monitor only a portion of the search space sets configured to satisfy the condition A at the corresponding point in time, and the base station may transmit the PDCCH to the selected search space set.

A method for selecting a portion of the search spaces from among all the configured search space sets may follow the following method.

When the condition A for the PDCCH is not satisfied at a specific point in time (slot), the UE (or the base station) may preferentially select, from among the search space sets present at the corresponding point in time, the search space set whose search space type is configured as a common search space over the search space set configured as a UE-specific search space.

When all the search spaces configured as the common search spaces are selected (i.e., when the condition A is satisfied even after selecting all the search spaces configured as the common search spaces), the UE (or base station) may select the search space sets configured as the UE-specific search space. In this case, when there are multiple search space sets configured as the UE-specific search spaces, the search space set with a lower search space set index may have a higher priority. The UE (or base station) may select the UE-specific search space sets within the range that satisfies condition A, taking priority into consideration.

### [Rate Matching/Puncturing Association]

Rate matching and puncturing operations will be described in detail below.

When time and frequency resource A where any symbol sequence A is to be transmitted overlaps any time and frequency resource B, the transmission and reception operations of channel A considering resource C, which corresponds to an area where resource A and resource B overlap, may consider the rate matching or puncturing operations. The specific operations may follow the following contents.

### Rate Matching Operation

The base station may map and transmit channel A only to the remaining resource areas of the entire resource A for transmitting symbol sequence A to the UE, excluding the resource C corresponding to the overlapping area with the resource B. For example, when the symbol sequence A is composed of {symbol #1, symbol #2, symbol #3, symbol #4}, the resource A is composed of {resource #1, resource #2, resource #3, resource #4}, and the resource B is composed of {resource #3, resource #5}, the base station may sequentially map and transmit the symbol sequence A to {resource #1, resource #2, resource #4} which are the remaining resources of the resource A, except for {resource #3} corresponding to the resource C. As a result, the base station may map and transmit the symbol sequence {symbol #1, symbol #2, symbol #3} to {resource #1, resource #2, resource #4}, respectively.

The UE may determine the resources A and B based on the scheduling information for the symbol sequence A from the base station, and thus, determine the resource C, which corresponds to the area where the resources A and B overlap. The UE may receive the symbol sequence A under the assumption that the symbol sequence A is mapped to the remaining areas of the entire resource A, excluding the resource C, and transmitted. For example, when the symbol sequence A is composed of {symbol #1, symbol #2, symbol #3, symbol #4}, the resource A is composed of {resource #1, resource #2, resource #3, resource #4}, and the resource B is composed of {resource #3, resource #5}, the UE may receive the symbol sequence A under the assumption that the symbol sequence A is sequentially mapped to {resource #1, resource #2, resource #4} which are the remaining resources of the resource A excluding {resource #3} corresponding to the resource C. As a result, the UE may perform a series of subsequent reception operations under the assumption that the symbol sequence {symbol #1, symbol #2, symbol #3} is mapped to {resource #1, resource #2, resource #4}, respectively, and transmitted.

### Puncturing Operation

When there is the resource C corresponding to the overlapping area with the resource B in the entire resource A to which the base station intends to transmit the symbol sequence A to the UE, the base station maps the symbol sequence A to the entire resource A, but does not perform transmission in the resource area corresponding to the resource C and may perform transmission only in the remaining resource areas of the resource A, excluding the resource C. For example, when the symbol sequence A is composed of {symbol #1, symbol #2, symbol #3, symbol #4}, the resource A is composed of {resource #1, resource #2, resource #3, resource #4}, and the resource B is composed of {resource #3, resource #5}, the base station may map the symbol sequence A {symbol #1, symbol #2, symbol #3, symbol #4} to the resource A {resource #1, resource #2, resource #3, resource #4}, respectively, and transmit only the symbol sequence {symbol #1, symbol #2, symbol #4} corresponding to the remaining resources {resource #1, resource #2, resource #4} of the resource A, excluding {resource #3} corresponding to the resource C, and the base station may not transmit {symbol #3} mapped to {resource #3} corresponding to the resource C. As a result, the base station may map and transmit the symbol sequence {symbol #1, symbol #2, symbol #4} to {resource #1, resource #2, resource #4}, respectively.

The UE may determine the resources A and B based on the scheduling information for the symbol sequence A from the base station, and thus, determine the resource C, which corresponds to the area where the resources A and B overlap. The UE may receive the symbol sequence A under the assumption that the symbol sequence A is mapped to the entire resource A, but is transmitted only in the remaining areas of the resource area A, excluding the resource C. For example, when the symbol sequence A is composed of {symbol #1, symbol #2, symbol #3, symbol #4}, the resource A is composed of {resource #1, resource #2, resource #3, resource #4}, and the resource B is composed of {resource #3, resource #5}, the UE may assume that the symbol sequence A {symbol #1, symbol #2, symbol #3, symbol #4} is mapped to the resource A {resource #1, resource #2, resource #3, resource #4}, respectively, but does not transmit the {symbol #3} mapped to {resource #3} corresponding to the resource C, and receive the symbol sequence {symbol #1, symbol #2, symbol #4} under the assumption that the corresponding symbol sequence {symbol #1, symbol #2, symbol #4} is mapped to the remaining resources {resource #1, resource #2, resource #4} of the resource A, excluding {resource #3} corresponding to the resource C, and transmitted. As a result, the UE may perform a series of subsequent reception operations under the assumption that the symbol sequence {symbol #1, symbol #2, symbol #4} is mapped to {resource #1, resource #2, resource #4}, respectively, and transmitted.

Hereinafter, a method for configuring rate matching resources for the purpose of rate matching in a 5G communication system will be described. The rate matching refers to adjusting a size of a signal in consideration of the amount of resources available for transmission of the signal. For example, the rate matching of the data channel may refer to adjusting the size of the data without mapping and transmitting the data channel in a specific time and frequency resource area.

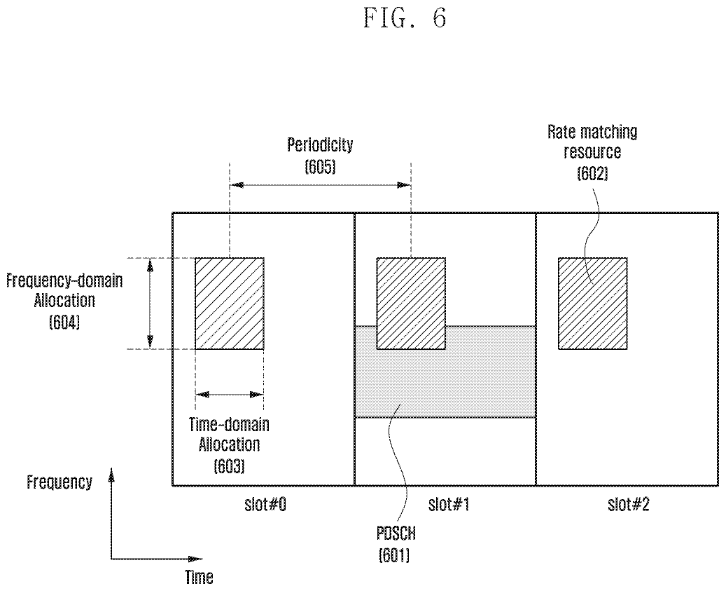

FIG. 6 is a diagram for describing a method for a base station and a UE to transmit and receive data in consideration of a downlink data channel and rate matching resources.

FIG. 6 illustrates a downlink data channel (PDSCH 601) and a rate matching resource 602. The base station may configure one or more rate matching resources 602 for the UE via the higher layer signaling (e.g., RRC signaling). The rate matching resource 602 configuration information may include time-domain resource allocation information 603, frequency-domain resource allocation information 604, and periodicity information 605. Hereinafter, a bitmap corresponding to the frequency-domain resource allocation information 604 is referred to as a “first bitmap”, a bitmap corresponding to the time-domain resource allocation information 603 is referred to as a “second bitmap”, and a bitmap corresponding to the periodicity information 605 is referred to as a “third bitmap”. When all or part of the time and frequency resources of the scheduled data channel 601 overlap the configured rate matching resources 602, the base station may rate-match the data channel 601 in the rate matching resource 602 portion and transmit the data channel 601, and the UE may receive and decode the data channel 601 after the assumption that the data channel 601 is rate-matched in the rate matching resource 602 portion.

The base station may dynamically notify the UE via the DCI whether to rate-match the data channel in the configured rate matching resource portion via additional configuration (which corresponds to a “rate matching indicator” within the above-described DCI format). Specifically, the base station may select some of the configured rate matching resources and group the selected rate matching resources into rate matching resource groups, and may use a bitmap scheme to indicate, to the UE, via the DCI, whether the data channel is rate-matched for each rate matching resource group. For example, when four rate matching resources, RMR #1, RMR #2, RMR #3, and RMR #4, are configured, the base station may configure RMG #1={RMR #1, RMR #2} and RMG #2={RMR #3, RMR #4} as the rate matching groups, and may use 2 bits within the DCI field to indicate to the UE, by the bitmap scheme, whether to perform the rate matching in the RMG #1 and RMG #2, respectively. For example, the case where the rate matching should performed may be indicated as “1”, and the case where the rate matching should not be performed may be indicated as “0”.

In 5G, granularities at “RB symbol level” and “RE level” are supported by the above-described method for configuring a rate matching resource in a UE. More specifically, it may follow the following configuration methods.

### RB Symbol Level

The UE may be configured with up to four RateMatchPatterns per bandwidth part via the higher layer signaling. One RateMatchPattern may include the following contents.
A reserved resource within the bandwidth part may include a resource whose time and frequency resource areas of the corresponding reserved resource are configured by a combination of a RB-level bitmap and a symbol-level bitmap on the frequency-domain. The reserved resource may span across one or two slots. A repeated time-domain pattern (periodicityAndPattern) composed of time and frequency domains formed by each RB-level and symbol-level bitmap pair may be additionally configured.
The time and frequency-domain resource area configured as the control resource set within the bandwidth part, and the resource area corresponding to the time-domain pattern configured by the search space configuration in which the corresponding resource area is repeated may be included.

### RE Level

The UE may be configured with the following contents via the higher layer signaling.
It may include, as configuration information (lte-CRS-ToMatchAround) for a RE corresponding to a LTE CRS (cell-specific reference signal or common reference signal) pattern, the number (nrofCRS-Ports) of ports of the LTE CRS, and a LTE-CRS-vshift(s) value (v-shift), location information (carrierFreqDL) of a center subcarrier of an LTE carrier from a reference frequency point (e.g., reference point A), bandwidth size (carrierBandwidthDL) information of the LTE carrier, subframe configuration information (mbsfn-SubframConfigList) corresponding to a multicast-broadcast single-frequency network (MBSFN), etc. The UE may determine a location of a CRS within an NR slot corresponding to the LTE subframe based on the above-described information.
It may include configuration information for a resource set corresponding to one or more zero power (ZP) CSI-RSs within the bandwidth part.

### [LTE CRS Rate Match Association]

Next, the rate match process for the above-described LTE CRS will be described in detail. For the coexistence between the long term evolution (LTE) and the new RAT (NR), the NR provides a function to configure the pattern of the cell specific reference signal (CRS) of the LTE to the NR UE. More specifically, the CRS pattern may be provided by the RRC signaling including at least one parameter within the ServingCellConfig IE (Information Element) or the ServingCellConfigCommon IE. Examples of the parameters may include lte-CRS-ToMatchAround, lte-CRS-PatternList1-r16, lte-CRS-PatternList2-r16, crs-RateMatch-PerCORESETPoolIndex-r16, etc.

Rel-15 NR provides a function that allows configuration of one CRS pattern per serving cell via the lte-CRS-ToMatchAround parameter. In Rel-16 NR, the function has been extended to enable the configuration of multiple CRS patterns for each serving cell. More specifically, the UE configured with single-transmission and reception point (TRP) may have one CRS pattern configured per LTE carrier, and the UE configured with multi-TRP may have two CRS patterns configured per LTE carrier. For example, the UE configured with single-TRP may have up to three CRS patterns configured per serving cell via the lte-CRS-PatternList1-r16 parameter. As another example, the UE configured with multi-TRP may have CRS configured per TRP. That is, a CRS pattern for TRP1 may be configured via the lte-CRS-PatternList1-r16 parameter, and the CRS pattern for TRP2 may be configured through the lte-CRS-PatternList2-r16 parameter. Meanwhile, when two TRPs are configured as described above, it is determined whether both the CRS patterns of TRP1 and TRP2 or only the CRS pattern for one TRP is applied to a specific physical downlink shared channel (PDSCH) via a crs-RateMatch-PerCORESETPoolIndex-r16 parameter. When the ers-RateMatch-PerCORESETPoolIndex-r16 parameter is configured to enabled, only the CRS pattern of one TRP is applied, and in other cases, the CRS patterns of both TRPs are applied.

Table 15 shows ServingCellConfig IE that includes the CRS pattern, and Table 16 shows RateMatchPatternLTE-CRS IE that includes at least one parameter for the CRS pattern.

TABLE 15

| | |
|---|---|
| ServingCellConfig ::= | SEQUENCE { |
| tdd-UL-DL-ConfigurationDedicated | TDD-UL-DL-ConfigDedicated |

OPTIONAL, -- Cond TDD

| | |
|---|---|
| initialDownlinkBWP | BWP-DownlinkDedicated |

OPTIONAL, -- Need M

| | |
|---|---|
| downlinkBWP-ToReleaseList | SEQUENCE (SIZE (1..maxNrofBWPs)) OF BWP-Id |

OPTIONAL, -- Need N

| | |
|---|---|
| downlinkBWP-ToAddModList | SEQUENCE (SIZE (1..maxNrofBWPs)) OF |
| BWP-Downlink | OPTIONAL, -- Need N |
| firstActiveDownlinkBWP-Id | BWP-Id |

OPTIONAL, -- Cond SyncAndCellAdd

| | |
|---|---|
| bwp-InactivityTimer | ENUMERATED {ms2, ms3, ms4, ms5, ms6, ms8, ms10, |

ms20, ms30,

ms40,ms50, ms60, ms80,ms100,

ms200,ms300, ms500,

ms750, ms1280, ms1920, ms2560,

spare10, spare9, spare8,

spare7, spare6, spare5, spare4, spare3,

spare2, spare1 } OPTIONAL, --Need R

| | |
|---|---|
| defaultDownlinkBWP-Id | BWP-Id |

OPTIONAL, -- Need S

| | |
|---|---|
| uplinkConfig | UplinkConfig |

OPTIONAL, -- Need M

| | |
|---|---|
| supplementaryUplink | UplinkConfig |

OPTIONAL, -- Need M

| | |
|---|---|
| pdcch-ServingCellConfig | SetupRelease { PDCCH-ServingCellConfig } |

OPTIONAL, -- Need M

| | |
|---|---|
| pdsch-ServingCellConfig | SetupRelease { PDSCH-ServingCellConfig } |

OPTIONAL, -- Need M

| | |
|---|---|
| csi-MeasConfig | SetupRelease { CSI-MeasConfig } |

OPTIONAL, -- Need M

| | |
|---|---|
| sCellDeactivationTimer | ENUMERATED {ms20, ms40, ms80, ms160, ms200, |

ms240,

ms320, ms400, ms480, ms520, ms640,

ms720,

ms840, ms1280, spare2,spare1}

OPTIONAL, -- Cond ServingCellWithoutPUCCH

| | |
|---|---|
| crossCarrierSchedulingConfig | CrossCarrierSchedulingConfig |

OPTIONAL, -- Need M

| | |
|---|---|
| tag-Id | TAG-Id, |
| dummy | ENUMERATED {enabled} |

OPTIONAL, -- Need R

| | |
|---|---|
| pathlossReferenceLinking | ENUMERATED {spCell, sCell} |

OPTIONAL, -- Cond SCellOnly

| | |
|---|---|
| servingCellMO | MeasObjectId |

```
OPTIONAL, -- Cond MeasObject
  ...,
  [[
```

| | |
|---|---|
| lte-CRS-ToMatchAround | SetupRelease { RateMatchPatternLTE-CRS } |

OPTIONAL, -- Need M

| | |
|---|---|
| rateMatchPatternToAddModList | SEQUENCE (SIZE (1..maxNrofRateMatchPatterns)) |
| OF RateMatchPattern OPTIONAL, | -- Need N |
| rateMatchPatternToReleaseList | SEQUENCE (SIZE (1..maxNrofRateMatchPatterns)) |
| OF RateMatchPatternId OPTIONAL, | -- Need N |
| downlinkChannelBW-PerSCS-List | SEQUENCE (SIZE (1..maxSCSs)) OF |
| SCS-SpecificCarrier | OPTIONAL -- Need S |

```
  ]],
  [[
```

| | |
|---|---|
| supplementaryUplinkRelease | ENUMERATED {true} |

OPTIONAL, -- Need N

| | |
|---|---|
| tdd-UL-DL-ConfigurationDedicated-IAB-MT-r16 | TDD-UL-DL-ConfigDedicated-IAB-MT-r16 |

OPTIONAL, -- Cond TDD_IAB

| | |
|---|---|
| dormantBWP-Config-r16 | SetupRelease { DormantBWP-Config-r16 } |

OPTIONAL, -- Need M

| | |
|---|---|
| ca-SlotOffset-r16 | CHOICE { |
| refSCS15kHz | INTEGER (−2..2), |
| refSCS30KHz | INTEGER (−5..5), |
| refSCS60KHz | INTEGER (−10..10), |
| refSCS120KHz | INTEGER (−20..20) |

}
OPTIONAL, -- Cond AsyncCA

| | |
|---|---|
| channelAccessConfig-r16 | SetupRelease { ChannelAccessConfig-r16 } |

OPTIONAL, -- Need M

| | |
|---|---|
| intraCellGuardBandsDL-List-r16 | SEQUENCE (SIZE (1..maxSCSs)) OF |
| IntraCellGuardBandsPerSCS-r16 | OPTIONAL, -- Need S |
| intraCellGuardBandsUL-List-r16 | SEQUENCE (SIZE (1..maxSCSs)) OF |
| IntraCellGuardBandsPerSCS-r16 | OPTIONAL, -- Need S |
| csi-RS-ValidationWith-DCI-r16 | ENUMERATED {enabled} |

OPTIONAL, -- Need R

| | |
|---|---|
| lte-CRS-PatternList1-r16 | SetupRelease { LTE-CRS-PatternList-r16 } |

OPTIONAL, -- Need M

| | |
|---|---|
| lte-CRS-PatternList2-r16 | SetupRelease { LTE-CRS-PatternList-r16 } |

OPTIONAL, -- Need M

| | |
|---|---|
| crs-RateMatch-PerCORESETPoolIndex-r16 | ENUMERATED {enabled} |

OPTIONAL, -- Need R

| | |
|---|---|
| enableTwoDefaultTCI-States-r16 | ENUMERATED {enabled} |

OPTIONAL, -- Need R
enableDefaultTCI-StatePerCoresetPoolIndex-r16 ENUMERATED {enabled}
OPTIONAL, -- Need R

| | |
|---|---|
| enableBeamSwitchTiming-r16 | ENUMERATED {true} |

OPTIONAL, -- Need R

| | |
|---|---|
| cbg-TxDiffTBsProcessingType1-r16 | ENUMERATED {enabled} |

OPTIONAL, -- Need R

| | |
|---|---|
| cbg-TxDiffTBsProcessingType2-r16 | ENUMERATED {enabled} |

OPTIONAL -- Need R
]]
}

TABLE 16
- RateMatchPatternLTE-CRS
The IE RateMatchPatternLTE-CRS is used to configure a pattern to rate match
around LTE CRS. See TS 38.214 [19], clause 5.1.4.2.

RateMatchPatternLTE-CRS information element

-- ASN1START
-- TAG-RATEMATCHPATTERNLTE-CRS-START

| | |
|---|---|
| RateMatchPatternLTE-CRS ::= | SEQUENCE { |
| carrierFreqDL | INTEGER (0..16383), |
| carnerBandwidthDL | ENUMERATED {n6, n15, n25, n50, n75, n100, spare2, spare1}, |
| mbsfn-SubframeConfigList | EUTRA-MBSFN-SubframeConfigList |

OPTIONAL, -- Need M

| | |
|---|---|
| nrofCRS-Ports | ENUMERATED {n1, n2, n4}, |
| v-Shift | ENUMERATED {n0, n1, n2, n3, n4, n5} |

}

| | |
|---|---|
| LTE-CRS-PatternList-r16 ::= | SEQUENCE (SIZE (1..maxLTE-CRS-Patterns-r16)) OF RateMatchPatternLTE-CRS |

-- TAG-RATEMATCHPATTERNLTE-CRS-STOP
-- ASN1STOP
RateMatchPatternLTE-CRS field descriptions
carrierBandwidthDL
BW of the LTE carrier in number of PRBs (see TS 38.214 [19], clause 5.1.4.2).
carrierFreqDL
Center of the LTE carrier (see TS 38.214 [19], clause 5.1.4.2).
mbsfn-SubframeConfigList
LTE MBSFN subframe configuration (see TS 38.214 [19], clause 5.1.4.2).
nrofCRS-Ports
Number of LTE CRS antenna port to rate-match around (see TS 38.214 [19], clause 5.1.4.2).
v-Shift
Shifting value v-shift in LTE to rate match around LTE CRS (see TS 38.214 [19], clause 5.1.4.2).

### [PDSCH: Frequency Resource Allocation Association]

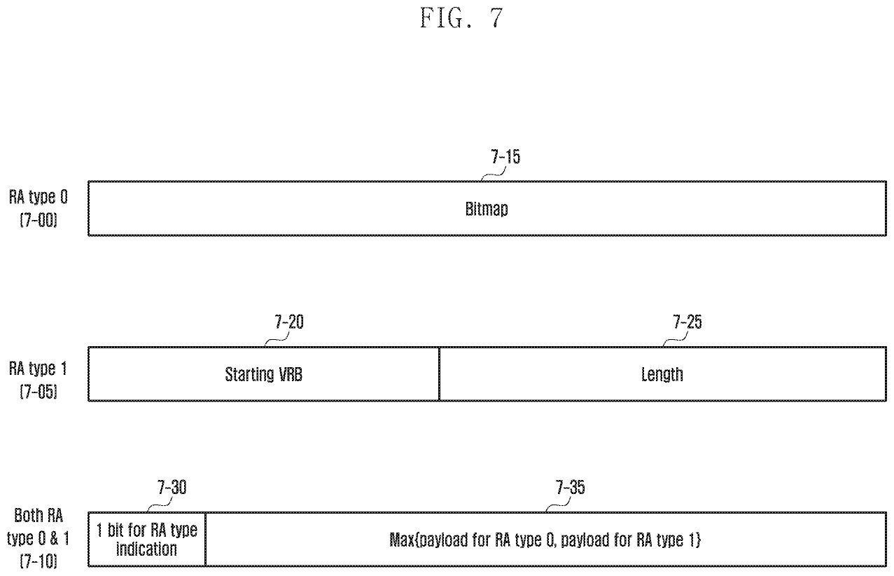

FIG. 7 is a diagram illustrating an example of the frequency-domain resource allocation for the physical downlink shared channel (PDSCH) in the wireless communication system according to an embodiment of the present disclosure.

FIG. 7 is a diagram illustrating a method for allocating three frequency-domain resources that are type 0 (7-00), type 1 (7-05), and dynamic switch (7-10) that may be configured via a higher layer in an NR wireless communication system.

Referring to FIG. 7, when the UE is configured to use only resource type 0 (7-00) via higher layer signaling, some of the downlink control information (DCI) that allocates the PDSCH to the corresponding UE includes a bitmap composed of NRBG bits. The conditions for this will be described later. In this case, NRBG refers to the number of resource block groups (RBGs) determined as shown in Table 17 below depending on a BWP size allocated by a BWP indicator and a higher layer parameter rbg-Size, and data is transmitted to the RBG indicated as 1 by the bitmap.

TABLE 17

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

When the UE is configured to use only resource type 1 (7-05) via the higher layer signaling, some DCIs allocating the PDSCH to the corresponding UE include the frequency-domain resource allocation information composed of

$$⌈ {log}_{2} ( {N}_{RB}^{DL , BWP} ( {N}_{RB}^{DL , BWP} + 1 ) / 2 ⌉$$

bits. The conditions for this will be described later. In this way, the base station may configure a starting VRB (7-20) and a length (7-25) of frequency-domain resource contiguously allocated from the starting VRB (7-20).

When the UE is configured to use both the resource type 0 and resource type 1 (7-10) via the higher layer signaling, some DCIs allocating the PDSCH to the corresponding UE include the frequency-domain resource allocation information composed of bits with the larger value (7-35) of a payload (7-15) for configuring the resource type 0 and payloads (7-20 and 7-25) for configuring the resource type 1. The conditions for this will be described later. In this case, one bit may be added to the most significant bit (MSB) of the frequency-domain resource allocation information within the DCI, and the corresponding bit with a value of “0” may indicate the use of the resource type 0, while the corresponding bit with a value of “1” may indicate the use of the resource type 1.

### [PDSCH/PUSCH: Time Resource Allocation Association]

A time-domain resource allocation method for a data channel in a next generation mobile communication system (5G or NR systems) will be described below.

The base station may configure, for the UE, a table for time-domain resource allocation information for the downlink data channel (physical downlink shared channel (PDSCH) and the uplink data channel (physical uplink shared channel (PUSCH)) via the higher layer signaling (e.g., the RRC signaling). For the PDSCH, a table composed of up to maxNrofDL-Allocations=16 entries may be configured, and for the PUSCH, a table composed of up to maxNrofUL-Allocations=16 entries may be configured. In an embodiment, the time-domain resource allocation information may include PDCCH-to-PDSCH slot timing (corresponding to a time interval in slot units between a point in time at which the PDCCH is received and a point in time at which the PDSCH scheduled by the received PDCCH is transmitted, which is denoted as K0), PDCCH-to-PUSCH slot timing (corresponding to a time interval in slot units between a point in time at which the PDCCH is received and a point in time at which the PUSCH scheduled by the received PDCCH is transmitted, which is denoted as K2), information about a position and length of a start symbol for which the PDSCH or the PUSCH is scheduled within a slot, a mapping type of the PDSCH or the PUSCH, etc. For example, information such as Table 18 or Table 19 below may be transmitted from the base station to the UE.

TABLE 18
PDSCH-TimeDomainResourceAllocationList information element

| | |
|---|---|
| PDSCH-TimeDomainResourceAllocationList ::= | SEQUENCE |

(SIZE(1..maxNrofDL-Allocations)) OF PDSCH-TimeDomainResourceAllocation
PDSCH-TimeDomainResourceAllocation ::= SEQUENCE {

| | | |
|---|---|---|
| k0 | INTEGER(0..32) | OPTIONAL, |

-- Need S

| | |
|---|---|
| mappingType | ENUMERATED {typeA, typeB}, |
| startSymbolAndLength | INTEGER (0..127) |

}

TABLE 19
PUSCH-TimeDomainResourceAllocation information element

| | |
|---|---|
| PUSCH-TimeDomainResourceAllocationList ::= | SEQUENCE |

(SIZE(1..maxNrofUL-Allocations)) OF PUSCH-TimeDomainResourceAllocation
PUSCH-TimeDomainResourceAllocation ::= SEQUENCE {

| | | |
|---|---|---|
| k2 | INTEGER(0..32) | OPTIONAL, -- Need S |

| | |
|---|---|
| mappingType | ENUMERATED {typeA, typeB}, |
| startSymbolAndLength | INTEGER (0..127) |

}

The base station may notify the UE of one of the entries in the table for the above-described time-domain resource allocation information via L1 signaling (e.g., DCI) (e.g., indicated by the ‘time-domain resource allocation’ field in the DCI). The UE may acquire the time-domain resource allocation information for the PDSCH or the PUSCH based on the DCI received from the base station.

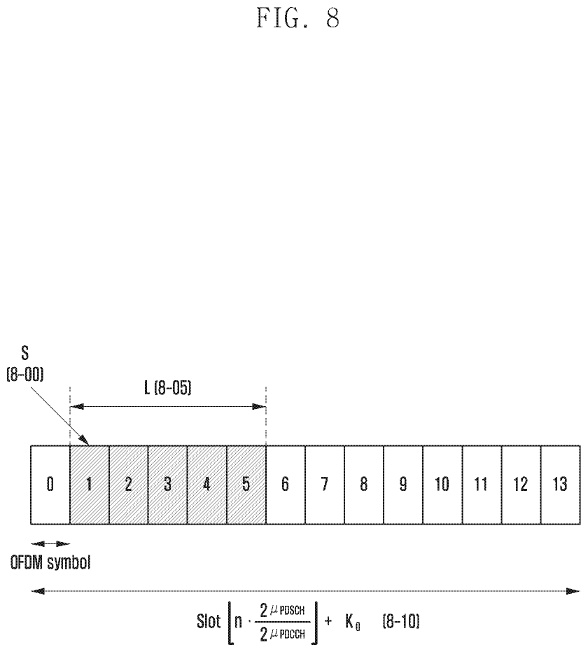

FIG. 8 is a diagram illustrating an example of time-domain resource allocation for PDSCH in the wireless communication system according to an embodiment of the present disclosure.

Referring to FIG. 8, the base station may indicate a time-domain position of the PDSCH resource based on the subcarrier spacing (SCS) (pPDSCH, pPDCCH) of the data channel and control channel configured using the higher layer, a scheduling offset (K0) value, and an OFDM symbol start position 8-00 and length 8-05 within one slot dynamically indicated via the DCI.

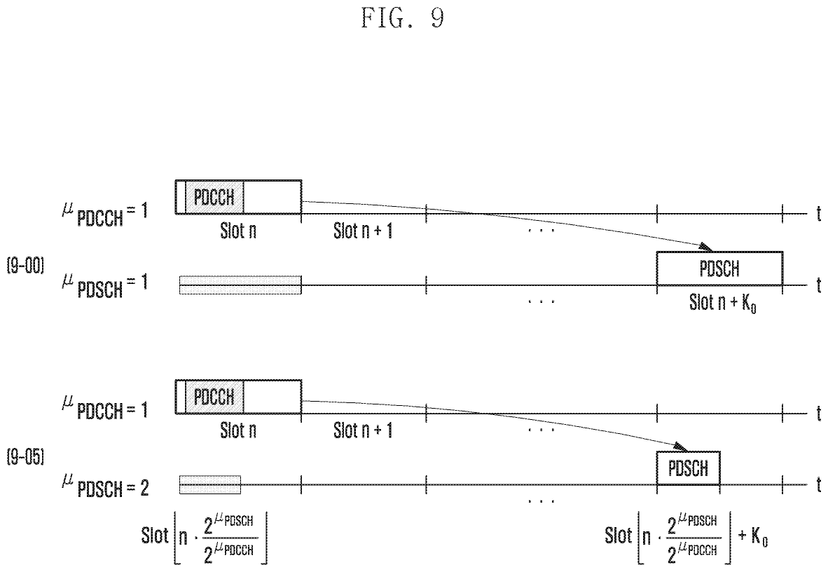

FIG. 9 is a diagram illustrating an example of the time-domain resource allocation according to the subcarrier spacing of the data channel and the control channel in the wireless communication system according to an embodiment of the present disclosure.

Referring to FIG. 9, when the subcarrier spacing of the data channel and the subcarrier spacing of the control channel are the same (9-00, μ_{PDSCH}=μ_{PDCCH}), slot numbers for data and control are the same, so the base station and the UE may generate a scheduling offset according to a predetermined slot offset K0. On the other hand, when the subcarrier spacing of the data channel and the subcarrier spacing of the control channel are different (9-05, pPDSCH PDCCH), the slot numbers for the data and control are different, so the base station and the UE may generate a scheduling offset according to the predetermined slot offset K0, based on the subcarrier spacing of the PDCCH.

### [PUSCH: Transmission Scheme Association]

Next, the scheduling scheme for the PUSCH transmissions will be described. The PUSCH transmission may be dynamically scheduled based on UL grant within the DCI or may be operated based on configured grant Type 1 or Type 2. The dynamic scheduling indication for the PUSCH transmission may be made by the DCI format 0_0 or 0_1.

Configured grant Type 1 PUSCH transmission may be semi-statically configured by receiving a configuredGrantConfig including the rrc-ConfiguredUplinkGrant in Table 20 via the higher signaling, without receiving the UL grant within the DCI. Configured grant Type 2 PUSCH transmission may be semi-persistently scheduled based on the UL grant in the DCI after receiving the configuredGrantConfig not including the rrc-ConfiguredUplinkGrant in Table 20 via the higher signaling. When the PUSCH transmission operates by the configured grant, parameters applied to the PUSCH transmission are applied via configuredGrantConfig in Table 20 as the higher signaling, excluding dataScramblingIdentityPUSCH, txConfig, codebookSubset, maxRank, and scaling of UCI-OnPUSCH provided by pusch-Config in Table 21 as the higher signaling. When the UE receives transformPrecoder within configuredGrantConfig in Table 20 as the higher signaling, the UE applies tp-pi2BPSK within the pusch-Config in Table 21 for the PUSCH transmission operated by the configured grant.

TABLE 20

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, resourceAllocationType1, |

dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, sym5x14, sym8x14, |

sym10x14, sym16x14, sym20x14,

sym32x14, sym40x14, sym64x14, sym80x14, sym128x14,

sym160x14, sym256x14, sym320x14, sym512x14,

sym640x14, sym1024x14, sym1280x14, sym2560x14,

sym5120x14,

sym6, sym1x12, sym2x12, sym4x12, sym5x12, sym8x12,

sym10x12, sym16x12, sym20x12, sym32x12,

sym40x12, sym64x12, sym80x12, sym128x12, sym160x12,

sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1..maxNrofPhysicalResourceBlocks−1) |

OPTIONAL, -- Need R

| | |
|---|---|
| pathlossReferenceIndex | INTEGER (0..maxNrofPUSCH-PathlossReferenceRSs−1), |

```
    ...
  }
OPTIONAL, -- Need R
  ...
}
```

Next, the PUSCH transmission method will be described. A DMRS antenna port for the PUSCH transmission is the same as an antenna port for SRS transmission. The PUSCH transmission may follow a codebook-based transmission method and a non-codebook-based transmission method, respectively, depending on whether a txConfig value within the pusch-Config of Table 21, which is the higher signaling, is ‘codebook’ or ‘nonCodebook’.

As described above, the PUSCH transmission may be dynamically scheduled by the DCI format 0_0 or 0_1, or semi-statically configured by the configured grant. When the UE is indicated to schedule the PUSCH transmission by the DCI format 0_0, the UE performs beam configuration for the PUSCH transmission by using pucch-spatialRelationInfoID corresponding to the UE-specific PUCCH resource corresponding to a minimum ID within the activated uplink BWP of the serving cell. In this case, the PUSCH transmission is based on the single antenna port. The UE does not expect scheduling for the PUSCH transmission by the DCI format 0_0 within a BWP where no PUCCH resource including pucch-spatialRelationInfo is configured. When the UE is not configured with the txConfig within the pusch-Config in Table 21, the UE does not expect to be scheduled by the DCI format 0_1.

TABLE 21

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS-UplinkConfig } |

OPTIONAL, -- Need M

| | |
|---|---|
| dmrs-UplinkForPUSCH-MappingTypeB | SetupRelease { DMRS-UplinkConfig } |

OPTIONAL, -- Need M

| | |
|---|---|
| pusch-PowerControl | PUSCH-PowerControl |

OPTIONAL, -- Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER (1.. |

maxNrofPhysicalResourceBlocks−1)
OPTIONAL, -- Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease |
| { PUSCH-TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| codebookSubset | ENUMERATED |

{fullyAndPartialAndNonCoherent, partialAndNonCoherent,nonCoherent}
OPTIONAL, -- Cond codebookBased

| | |
|---|---|
| maxRank | INTEGER (1..4) |

OPTIONAL, -- Cond codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
...
}

Next, the codebook-based PUSCH transmission will be described. The codebook-based PUSCH transmission may be dynamically scheduled by the DCI format 0_0 or 0_1, or semi-statically operated by the configured grant. When the codebook-based PUSCH is dynamically scheduled by the DCI format 0_1 or semi-statically configured by the configured grant, the UE determines a precoder for the PUSCH transmission based on an SRS resource indicator (SRI), a transmission precoding matrix indicator (TPMI), and a transmission rank (the number of PUSCH transmission layers).

In this case, the SRI may be provided via the field SRS resource indicator within the DCI or configured via srs-ResourceIndicator as the higher signaling. The UE is configured with at least one SRS resource for the codebook-based PUSCH transmission, but may be configured with up to two SRS resources. When the UE receives the SRI via the DCI, the SRS resource indicated by the corresponding SRI refers to the SRS resource corresponding to the SRI among the SRS resources transmitted prior to the PDCCH including the corresponding SRI. In addition, the TPMI and the transmission rank may be provided via field precoding information and number of layers within the DCI, or configured via precodingAndNumberOfLayers as the higher signaling. The TPMI is used to indicate the precoder applied to the PUSCH transmission. When the UE is configured with one SRS resource, the TPMI is used to indicate a precoder to be applied to one configured SRS resource. When the UE is configured with multiple SRS resources, the TPMI is used to indicate the precoder to be applied to the SRS resource indicated via the SRI.

The precoder to be used for the PUSCH transmission is selected from an uplink codebook with the number of antenna ports equal to a nrofSRS-Ports value within the SRS-Config as the higher signaling. In the codebook-based PUSCH transmission, the UE determines the codebook subset based on the TPMI and a codebookSubset within the pusch-Config as the higher signaling. The codebookSubset within the higher signaling pusch-Config may be configured with one of ‘fullyAndPartialAndNonCoherent’, ‘partialAndNonCoherent’, or ‘nonCoherent’ based on the UE capability reported by the UE to the base station. When the UE reports ‘partialAndNonCoherent’ in the UE capability, the UE does not expect the codebookSubset value in the higher signaling to be configured to ‘fullyAndPartialAndNonCoherent’. In addition, when the UE reports ‘nonCoherent’ in the UE capability, the UE does not expect the codebookSubset value as the higher signaling to be configured to ‘fullyAndPartialAndNonCoherent’ or ‘partialAndNonCoherent’. When nrofSRS-Ports within the SRS-ResourceSet as the higher signaling indicates two SRS antenna ports, the UE does not expect the codebookSubset value as the higher signaling to be configured to ‘partialAndNonCoherent’.

The UE may receive one SRS resource set where a usage value within the SRS-ResourceSet as the higher signaling is configured to ‘codebook’, and may be indicated one SRS resource within the corresponding SRS resource set via the SRI. When multiple SRS resources are configured within the SRS resource set where the usage value within the SRS-ResourceSet as the higher signaling is configured to the ‘codebook’, the UE expects the nrofSRS-Ports value within the SRS-Resource as the higher signaling to be configured to the same value for all the SRS resources.

The UE transmits, to the base station, one or multiple SRS resources included in the SRS resource set where the usage value is configured to the ‘codebook’ according to the higher signaling, and the base station selects one of the SRS resources transmitted by the UE and instructs the UE to perform the PUSCH transmission using the transmission beam information of the selected SRS resource. In this case, in the codebook-based PUSCH transmission, the SRI is used as information to select an index of one SRS resource and is included in the DCI. Additionally, the base station includes, in the DCI, information indicating the TPMI and rank to be used by the UE for the PUSCH transmission. The UE performs the PUSCH transmission using the SRS resource indicated by the SRI by applying the indicated rank based on the transmission beam of the corresponding SRS resource and the precoder indicated by the TPMI.

Next, the non-codebook-based PUSCH transmission will be described. The noncodebook-based PUSCH transmission may be dynamically scheduled by the DCI format 0_0 or 0_1, or semi-statically operated by the configured grant. When at least one SRS resource is configured in the SRS resource set where the usage value within the SRS-ResourceSet as the higher signaling is configured to ‘nonCodebook’, the UE may be scheduled the non-codebook-based PUSCH transmission via the DCI format 0_1.

For the SRS resource set where the usage value within the SRS-ResourceSet as the higher signaling is configured to ‘nonCodebook’, the UE may be configured with one associated NZP CSI-RS resource (non-zero power CSI-RS). The UE may perform calculations on a precoder for SRS transmission by measuring the NZP CSI-RS resource associated with the SRS resource set. When a difference between a last received symbol of an aperiodic NZP CSI-RS resource associated with the SRS resource set and a first symbol of aperiodic SRS transmission at the UE is less than 42 symbols, the UE does not expect information about the precoder for the SRS transmission to be updated.

When a resourceType value within the SRS-ResourceSet as the higher signaling is configured to ‘aperiodic’, the associated NZP CSI-RS is indicated by an SRS request as a field within DCI format 0_1 or 1_1. In this case, when the associated NZP CSI-RS resource is an aperiodic NZP CSI-RS resource, the presence of the associated NZP CSI-RS is indicated in the case where the value of the SRS request as the field within the DCI format 0_1 or 1_1 is not ‘00’. In this case, the corresponding DCI should not indicate cross carrier or cross BWP scheduling. In addition, when the value of the SRS request indicates the presence of the NZP CSI-RS, the corresponding NZP CSI-RS is located in the slot where the PDCCH including the SRS request field is transmitted. In this case, TCI states configured on the scheduled subcarrier are not configured to QCL-TypeD.

When a periodic or semi-persistent SRS resource set is configured, the associated NZP CSI-RS may be indicated via the associatedCSI-RS in the SRS-ResourceSet as the higher signaling. For the non-codebook-based transmission, the UE does not expect spatialRelationInfo as the higher signaling for the SRS resource and the associatedCSI-RS within the SRS-ResourceSet as the higher signaling to be configured together.

When the UE is configured with multiple SRS resources, the UE may determine the precoder and transmission rank to be applied to the PUSCH transmission based on the SRI indicated by the base station. The SRI may be indicated via the field SRS resource indicator within the DCI or configured via srs-ResourceIndicator as the higher signaling. Similar to the codebook-based PUSCH transmission described above, when the UE receives the SRI via the DCI, the SRS resource indicated by the corresponding SRI refers to the SRS resource corresponding to the SRI among the SRS resources transmitted prior to the PDCCH including the corresponding SRI. The UE may use one or more SRS resources for the SRS transmission. The maximum number of SRS resources that may be simultaneously transmitted within the same symbol within one SRS resource set and the maximum number of SRS resources are determined by the UE capability reported by the UE to the base station. In this case, the SRS resources simultaneously transmitted by the UE occupy the same RB. The UE configures one SRS port for each SRS resource. The number of SRS resource sets where the usage value within the SRS-ResourceSet as the higher signaling is configured with the ‘nonCodebook’ may be configured to only one, and the number of SRS resources for non-codebook-based PUSCH transmission may be configured to up to four.

The base station transmits one NZP-CSI-RS associated with the SRS resource set to the UE, and the UE calculates a precoder to be used when transmitting one or more SRS resources within the corresponding SRS resource set based on the results measured when receiving the corresponding NZP-CSI-RS. When the UE transmits one or more SRS resources within the SRS resource set where the usage is configured to the ‘nonCodebook’ to the base station, the UE applies the calculated precoder, and the base station selects one or more SRS resources from among the received one or more SRS resources. In this case, in the non-codebook-based PUSCH transmission, the SRI represents an index that may represent a combination of one or more SRS resources, and the SRI is included in the DCI. In this case, the number of SRS resources indicated by the SRI transmitted by the base station may be the number of PUSCH transmission layers, and the UE transmits the PUSCH by applying the precoder applied to the SRS resource transmission to each layer.

### [PUSCH: Preparation Procedure Time]

Next, a PUSCH preparation procedure time will be described. When the base station schedules the UE to transmit the PUSCH using the DCI formats 0_0, 0_1, or 0_2, the UE may require the PUSCH preparation procedure time to transmit the PUSCH by applying the transmission method (transmission precoding method, number of transmission layers, and spatial domain transmission filter for SRS resource) indicated via the DCI. The NR defines the PUSCH preparation procedure time. The PUSCH preparation procedure time of the UE may follow Equation 2 below.

$${T}_{proc , 2} = max ( ( {N}_{2} + {d}_{2 , 1} + {d}_{2} ) ( 2048 + 144 ) κ {2}^{- μ} {T}_{c} + {T}_{ext} + {T}_{switch} , {d}_{2 , 2} ) \qquad Equation 2$$

In T_{proc,2} above described in Equation 2, each variable may have the
following meaning.—N₂: It denotes the number of symbols determined by the UE processing capability 1 or 2 and the numerology μ according to the UE capability. When the UE processing capability is reported as 1 according to the UE capability report, N₂ may have the value of Table 22, and when the UE processing capability is reported as 2 and the use of the UE processing capability 2 is configured via the higher layer signaling, N₂ may have the value of Table 23.

TABLE 22

| μ | PUSCH preparation time N₂ [symbols] |
|---|---|
| 0 | 10 |
| 1 | 12 |
| 2 | 23 |
| 3 | 36 |

TABLE 23

| μ | PUSCH preparation time N₂ [symbols] |
|---|---|
| 0 | 5 |
| 1 | 5.5 |
| 2 | 11 for frequency range 1 |

d_{2,1}: It denotes the number of symbols determined as 0 when all the resource elements of the first OFDM symbol of the PUSCH transmission are configured to be composed of only DM-RS, and as 1 otherwise
κ: 64
μ: It follows a value between μ_{DL} and μ_{UL} for which T_{proc,2} is larger. μ_{DL} represents the numerology of the downlink where the PDCCH including the DCI scheduling the PUSCH is transmitted, and μ_{UL} represents the numerology of the uplink where the PUSCH is transmitted.

$${T}_{c} \text{:} It has 1 / ( Δ {f}_{max} * {N}_{f} ) , Δ {f}_{max} = 480 * {10}^{3} Hz , {N}_{f} = 4096.$$

d_{2,2}: It follows the BWP switching time when the DCI scheduling the PUSCH indicates BWP switching, and otherwise, it has 0.
d₂: When OFDM symbols of a PUCCH, a PUSCH with a higher priority index, and a PUCCH with a lower priority index overlap in time, the d₂ value of the PUSCH with the higher priority index is used. Otherwise, d₂ is 0.
Tₑₓₜ: When the UE uses a shared spectrum channel access scheme, the UE may calculate Tₑₓₜ and apply the calculated Tₑₓₜ to the PUSCH preparation procedure time. Otherwise, Tₑₓₜ is assumed to be 0.
T_{switch}: When the uplink switching interval is triggered, T_{switch} is assumed to be the switching interval time. Otherwise, T_{switch} is assumed to be 0.

When the base station and the UE consider the time-domain resource mapping information of the PUSCH scheduled via the DCI and the influence of the uplink-downlink timing advance, the PUSCH preparation procedure time is determined to be insufficient in the case where the first symbol of the PUSCH starts before the first uplink symbol where the CP begins after T_{proc,2} from the last symbol of the PDCCH including the DCI scheduling the PUSCH. If not, the base station and the UE determine that the PUSCH preparation procedure time is sufficient. The UE transmits the PUSCH only when the PUSCH preparation procedure time is sufficient, and may ignore the DCI scheduling the PUSCH when the PUSCH preparation procedure time is insufficient.

### [CA/DC Association]

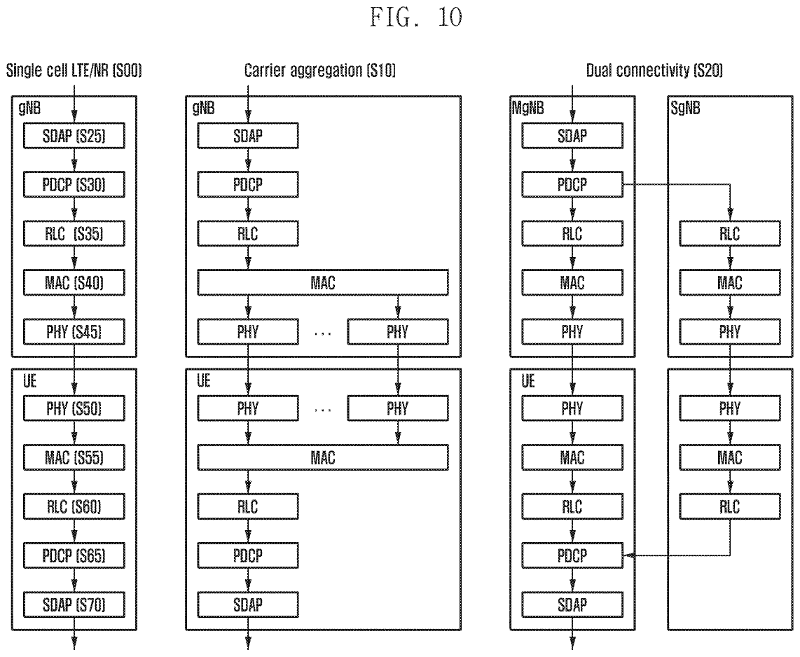

FIG. 10 is a diagram illustrating a wireless protocol structure between a base station and a UE in a single cell, carrier aggregation, and dual connectivity situation according to an embodiment of the present disclosure.

Referring to FIG. 10, the wireless protocol of the next generation mobile communication system consists of NR service data adaptation protocol (NR SDAP) (S25, S70), NR packet data convergence protocol (NR PDCP) (S30, S65), NR radio link control (NR RLC) (S35, S60), and NR medium access control (NR MAC) (S40, S55) at the UE and NR base station, respectively.

The main functions of NR SDAP (S25, S70) may include some of the following functions.
Transfer function of user data (transfer of user plane data)
Mapping function of QoS flow and data bearer with respect to uplink and downlink (mapping between a QoS flow and a DRB for both DL and UL)
Marking function of QoS flow ID with respect to uplink and downlink (marking QoS flow ID in both DL and UL packets)
Function of mapping reflective QoS flow to data bearer with respect to uplink SDAP PDUs (reflective QoS flow to DRB mapping for the UL SDAP PDUs).

For the SDAP layer entity, the UE may be configured to determine, via an RRC message, whether to use a header of the SDAP layer entity or a function of the SDAP layer entity on a per-PDCP layer entity basis, a per-bearer basis, or per-logical channel basis. When the SDAP header is configured, the UE may instruct a 1-bit indicator for NAS reflective QoS (NAS reflective QoS) and a 1-bit indicator for AS reflective QoS (AS reflective QoS) of the SDAP header to update or reconfigure the mapping information for the QoS flow and data bearer in the uplink and downlink. The SDAP header may include QoS flow ID information representing QoS. The QoS information may be used as data processing priority, scheduling information, etc., to support smooth service.

The main functions of NR PDCP (S30, S65) may include some of the following functions.
Header compression and decompression function (Header compression and decompression: ROHC only)
User data transfer function (Transfer of user data)
In-sequence delivery function (In-sequence delivery of upper layer PDUs)
Out-of-sequence delivery function (Out-of-sequence delivery of upper layer PDUs)
Reordering function (PDCP PDU reordering for reception)
Duplicate detection function (Duplicate detection of lower layer SDUs)
Retransmission function (Retransmission of PDCP SDUs)
Ciphering and deciphering function (Ciphering and deciphering)
Timer based SDU discard function (Timer-based SDU discard in uplink.)

The reordering function of the NR PDCP entity refers to a function of reordering PDCP PDUs received from a lower layer in sequence based on a PDCP sequence number (SN) and may include a function of delivering data to the higher layer in the reordered order. Alternatively, the reordering function of the NR PDCP entity may include a function of directly delivering PDCP PDUs without considering order, a function of recording lost PDCP PDUs by reordering, a function of reporting a status of lost PDCP PDUs to a transmitting side, and a function of requesting retransmission of lost PDCP PDUs.

The main functions of the NR RLC (S35, S60) may include some of the following functions.
Data transfer function (Transfer of upper layer PDUs)
In-sequence delivery function (In-sequence delivery of upper layer PDUs)
Out-of-sequence delivery function (Out-of-sequence delivery of upper layer PDUs)
ARQ function (Error correction through ARQ)
Concatenation, segmentation, reassembly function (Concatenation, segmentation and reassembly of RLC SDUs)
Re-segmentation function (Re-segmentation of RLC data PDUs)
Reordering function (Reordering of RLC data PDUs)
Duplicate detection function (Duplicate detection)
Error detection function (Protocol error detection)
RLC SDU discard function (RLC SDU discard)
RLC re-establishment function (RLC re-establishment)

The in-sequence delivery function of the NR RLC entity refers to the function of sequentially delivering RLC SDUs received from the lower layer to the higher layer. The in-sequence delivery function of the NR RLC entity may include a function of, when an original one RLC SDU is received after being segmented into multiple RLC SDUs, reassembling and delivering the RLC SDUs, a function of reordering the received RLC PDUs based on the RLC sequence number (SN) or the PDCP sequence number (SN), a function of recording lost RLC PDUs by reordering the RLC PDUs, a function of reporting a status of lost RLC PDUs to a transmitting side, and a function of requesting retransmission of the lost RLC PDUs. The in-sequence delivery function of the NR RLC entity may include a function of delivering, to the higher layer in sequence only the RLC SDUs before the lost RLC SDU when there is the lost RLC SDU, or a function of delivering, to the higher layer, in sequence all RLC SDUs received before a timer starts when a predetermined timer has expired even when there is the lost RLC SDU. Alternatively, the in-sequence delivery function of the NR RLC entity may include a function of delivering in sequence all RLC SDUs received so far to the higher layer when the predetermined timer has expired even when there are the lost RLC SDUs. In addition, the RLC PDUs may be processed in the sequence they are received (in the sequence of arrival, regardless of the sequence of the sequence number) and delivered to the PDCP entity out-of sequence delivery. In the case of the segment, the segments stored in the buffer or to be received later may be received, reconstructed into one complete RLC PDU, processed, and then delivered to the PDCP entity. The NR RLC layer may not include a concatenation function, and the function may be performed in the NR MAC layer or replaced with a multiplexing function of the NR MAC layer.

The out-of-sequence delivery function of the NR RLC entity described above refers to the function of directly delivering the RLC SDUs received from the lower layer to the higher layer out-of-sequence. When the original one RLC SDU is segmented into multiple RLC SDUs and received, the out-of-sequence delivery function may include a function of reassembling and delivering multiple RLC SDUs, and include a function of storing the RLC SNs or PDCP SNs of the received RLC PDUs, ordering the RLC SNs or PDCP SNs, and recording the lost RLC PDUs.

The NR MAC (S40, S55) may be associated with multiple NR RLC layer entities configured in one UE, and the main functions of the NR MAC may include some of the following functions.
Mapping function (Mapping between logical channels and transport channels)
Multiplexing and demultiplexing function (Multiplexing/demultiplexing of MAC SDUs)
Scheduling information reporting function (Scheduling information reporting)
HARQ function (Error correction through HARQ)
Function for priority adjustment between logical channels (Priority handling between logical channels of one UE)
Function for priority adjustment between UEs (Priority handling between UEs by means of dynamic scheduling)
MBMS service identification function (MBMS service identification)
Transport format selection function (Transport format selection)
Padding function (Padding)

The NR PHY layer (S45, S50) may perform functions such as channel coding and modulating higher layer data, converting the higher layer data into OFDM symbols for transmission via a wireless channel, or demodulating and channel decoding the OFDM symbols received via the wireless channel and transmitting the OFDM symbols to the higher layer.

The detailed structure of the wireless protocol structure may vary depending on a carrier (or cell) operation scheme. For example, when the base station transmits data to the UE based on a single carrier (or cell), the base station and the UE use a protocol structure having a single structure for each layer, as in S00. On the other hand, when the base station transmits data to the UE based on carrier aggregation (CA) using multiple carriers in a single TRP, the base station and the UE use a protocol structure that has a single structure up to the RLC layer, as in S10, but multiplexes a PHY layer through a MAC layer. As another example, when the base station transmits data to the UE based on dual connectivity (DC) using multiple carriers in multiple TRPs, the base station and the UE use the protocol structure that has the single structure up to the RLC layer but multiplexes the PHY layer through the MAC layer, as in S20.

Referring to the descriptions related to the PDCCH and beam configuration described above, the repeated transmission of the PDCCH is not currently supported in the current Rel-15 and Rel-16 NR, and thus, it is difficult to achieve the required reliability in scenarios requiring high reliability, such as URLLC. The present disclosure provides a method for PDCCH repetition transmission via multiple transmission points (TRPs) to improve the PDCCH reception reliability of the UE. A specific method will be described in detail in the following embodiments.

Hereinafter, embodiments of the present disclosure will be described in detail with reference to the accompanying drawings. The content of the present disclosure is applicable to both FDD and TDD systems. Hereinafter, in the present disclosure, the higher signaling (or higher layer signaling) refers to a signal transfer method in which signals are transferred from the base station to the UE via the physical downlink data channel, or from the UE to the base station via the physical uplink data channel, and may also be referred to as RRC signaling, PDCP signaling, or a medium access control (MAC) control element (MAC CE).

Hereinafter, in the present disclosure, when the UE determines whether cooperative communication is applied, various methods, such as a method in which PDCCH(s) allocating PDSCH to which cooperative communication is applied has a specific format, a method in which PDCCH(s) allocating PDSCH to which cooperative communication is applied includes a specific indicator that notifies whether to apply the cooperative communication, a method in which PDCCH(s) allocating PDSCH to which cooperative communication is applied is scrambled by a specific RNTI, or a method for assuming that cooperative communication is applied in a specific section indicated by a higher layer, may be used. Thereafter, for convenience of description, the case in which the UE receives a PDSCH with cooperative communication applied based on conditions similar to those described above will be referred to as a NC-JT case.

Hereinafter, in the present disclosure, determining the priority between A and B may be variously referred to as selecting a higher priority based on a predetermined priority rule and performing an operation corresponding to the selected higher priority, omitting or dropping an operation corresponding to a lower priority, etc.

Hereinafter, the present disclosure describes the above examples through multiple embodiments, but these embodiments are not independent and one or more embodiments may be applied simultaneously or in combination.

Hereinafter, embodiments of the present disclosure will be described in detail with reference to the accompanying drawings. Hereinafter, a base station is an entity that performs resource allocation of a UE, and may be at least one of a gNode B, an eNode B, a Node B, a base station (BS), a wireless access unit, a base station controller, or a node on a network. The terminal may include user equipment (UE), a mobile station (MS), a cellular phone, a smartphone, a computer, or a multimedia system capable of performing a communication function. Hereinafter, while the present disclosure is described below using the 5G system as an example, the embodiments of the present disclosure may also be applied to other communication systems with similar technical backgrounds or channel types. For example, LTE or LTE-A mobile communications, as well as mobile communication technologies developed after the 5G may be included. Therefore, the embodiments of the present disclosure may be applied to other communication systems with some modifications, as determined by those skilled in the art, without significantly departing from the scope of the present disclosure. The content of the present disclosure is applicable to both FDD and TDD systems.

In addition, in describing the present disclosure, when it is decided that a detailed description for the functions or configurations related to the present disclosure may unnecessarily obscure the gist of the present disclosure, the detailed description therefor will be omitted. Further, the following terms are terms defined in consideration of the functions in the present disclosure and may vary depending on the intention, practice, etc., of users and operators. Therefore, the definitions thereof should be construed based on the contents throughout the specification.

Hereinafter, in describing the present disclosure, the higher layer signaling may be signaling corresponding to at least one or one or more combinations of the following signaling types.
MIB (Master Information Block)
SIB (System Information Block) or SIB X (X=1, 2, . . . )
RRC (Radio Resource Control)
MAC (Medium Access Control) CE (Control Element)

In addition, the L1 signaling may refer to signaling using at least one or one or more combinations of signaling methods using physical layer channels or signaling described below.
PDCCH (Physical Downlink Control Channel)
DCI (Downlink Control Information)
UE-specific DCI
Group common DCI
Common DCI
Scheduling DCI (e.g., DCI used for scheduling downlink or uplink data)
Non-scheduling DCI (e.g., DCI not used for scheduling downlink or uplink data)
Physical Uplink Control Channel (PUCCH)
Uplink Control Information (UCI)

Hereinafter, in the present disclosure, determining the priority between A and B may be variously referred to as selecting a higher priority based on a predetermined priority rule and performing an operation corresponding to the selected higher priority, omitting or dropping an operation corresponding to a lower priority, etc.

Hereinafter, the present disclosure describes the above examples through multiple embodiments, but these embodiments are not independent and one or more embodiments may be applied simultaneously or in combination.

### [SBFD Association]

Meanwhile, in 3GPP, subband non-overlapping full duplex is being discussed as a new NR-based duplex scheme. The SBFD is a technology that utilizes a portion of downlink resources as uplink resources in a TDD spectrum of frequencies below 6 GHz or above 6 GHz, thereby receiving uplink transmissions from the UE as much as the increased uplink resources to expand the uplink coverage of the UE, and receiving feedback for the downlink transmission from the UE using the expanded uplink resources to reduce feedback delay. In the present disclosure, the UE that may receive information on whether the SBFD is supported from the base station and perform the uplink transmissions using a portion of the downlink resources may be conveniently referred to as an SBFD-capable UE. The following scheme may be considered for defining the SBFD scheme in the standard and for determining whether the SBFD is supported in a specific cell (or frequency, frequency band).

In the first scheme, in addition to the existing frame structure of unpaired spectrum (or time division duplex (TDD)) or paired spectrum (or frequency division duplex (FDD)), another frame structure type (e.g., frame structure type 2) may be introduced to define the SBFD. The frame structure type 2 may be defined as supported at a specific frequency or frequency band, or the base station may indicate whether the SBFD is supported to the UE via system information. The SBFD UE may determine whether the SBFD is supported in the specific cell (or frequency or frequency band) by receiving, from the base station, the system information, including whether the SBFD is supported.

In the second scheme, whether the SBFD is additionally supported in a specific frequency or frequency band of the existing unpaired spectrum (or TDD) may be indicated without defining a new frame structure type. In this second scheme, it may be defined whether the SBFD is additionally supported in a specific frequency or frequency band of the existing unpaired spectrum or the base station or the base station may indicate whether the SBFD is supported to the UE via the system information. The SBFD UE may determine whether the SBFD is supported in the specific cell (or frequency or frequency band) by receiving, from the base station, the system information, including whether the SBFD is supported.

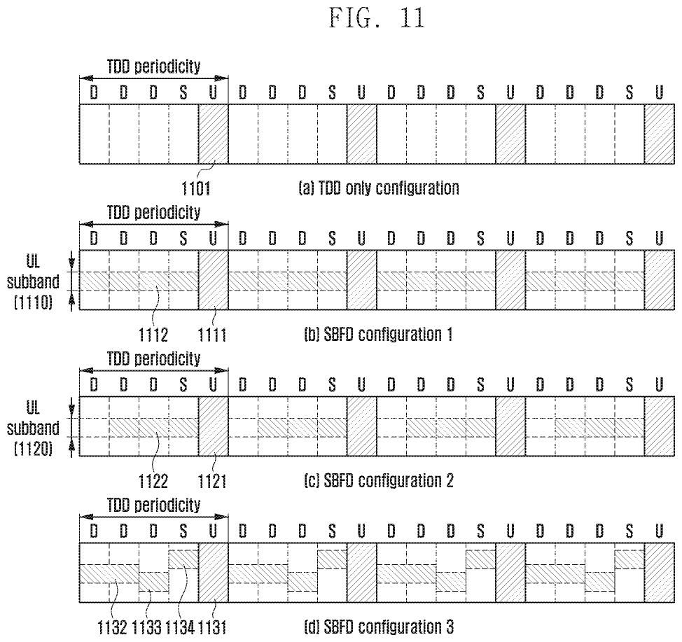

In the first and second schemes, the information on whether the SBFD is supported may be information (e.g., the SBFD resource configuration information in FIG. 11 to be described below) that indirectly indicates whether the SBFD is supported, by additionally configuring a portion of the downlink resources as the uplink resources in addition to the configuration for the TDD UL (uplink)-DL (downlink) resource configuration information indicating TDD downlink slot (or symbol) resources and uplink slot (or symbol) resources, or information that directly indicates whether the SBFD is supported.

In the present disclosure, the SBFD UE may acquire cell synchronization by receiving a synchronization signal block (SSB) in initial cell access for connecting to a cell (or base station). A process of acquiring the cell synchronization may be the same for both the SBFD UE and the existing TDD UE. Subsequently, the SBFD UE may determine whether the cell supports the SBFD via MIB acquisition, SIB acquisition, or a random access process.

The system information for transmitting the information on whether the SBFD is supported may be system information that is separately transmitted by being distinct from the system information for the UE (e.g., the existing TDD UE) supporting a different version of specifications within the cell, and the SBFD UE may determine whether the SBFD is supported by acquiring all or portion of the system information separately transmitted from the system information for the existing TDD UE. When the SBFD UE acquires only the system information for the existing TDD UE or the system information indicating that the SBFD is not supported, the SBFD UE may determine that the cell (or base station) supports only the TDD.

When the information on whether the SBFD is supported is included in the system information for the UE (e.g., the existing TDD UE) supporting a different version of specifications, the information on whether the SBFD is supported may be inserted at the very end without affecting the acquisition of the system information of the existing TDD UE. When the SBFD UE fails to acquire the information on whether the SBFD inserted at the very end is supported or acquires the information indicating that the SBFD is not supported, the SBFD UE may determine that the cell (or base station) supports only the TDD.

When the information on whether the SBFD is supported is included in the system information for the UE (e.g., the existing TDD UE) supporting a different version of specifications, the information on whether the SBFD is supported may be transmitted on a separate PDSCH without affecting the acquisition of the system information of the existing TDD UE. That is, a SBFD-unsupported UE may receive a first SIB (or SIB1) including the existing TDD-related system information on a first PDSCH. An SBFD-supporting UE may receive the first SIB (or SIB) including the existing TDD-related system information on the first PDSCH, and receive a second SIB including the SBFD-related system information on a second PDSCH. Here, the first PDSCH and the second PDSCH may be scheduled as a first PDCCH and a second PDCCH, and the cyclic redundancy code (CRC) of the first PDCCH and the second PDCCH may be scrambled with the same RNTI (e.g., SI-RNTI). The search space for monitoring the second PDCCH may be acquired from the system information of the first PDSCH, and if not acquired (i.e., if the system information of the first PDSCH does not include the information on the search space), the second PDCCH may be received in the same search space as the search space of the first PDCCH.

As described above, when the SBFD UE determines that the cell (or base station) supports only the TDD, the SBFD UE may perform a random access procedure and transmit and receive data/control signals in the same manner as the existing TDD UE.

The base station may configure separate random access resources for each of the existing TDD UE or SBFD UE (e.g., an SBFD UE supporting duplex communication and an SBFD UE supporting half-duplex communication) and transmit configuration information (control information or configuration information indicating time-frequency resources that may be used for PRACH) for the random access resources to the SBFD UE via the system information. The system information for transmitting the information on the random access resources may be separately transmitted system information distinct from the system information for the UE (e.g., existing TDD UE) supporting a different version of specifications within the cell.

The base station may configure separate random access resources for the TDD UE supporting a different version of specifications and for the SBFD UE, thereby enabling distinction between whether the TDD UE supporting a different version of specifications performs the random access or whether the SBFD UE performs the random access. For example, the separate random access resource configured for the SBFD UE may be a resource that the existing TDD UE determines as the downlink time resource. The SBFD UE may perform random access via the uplink resource (or a separate random access resource) configured for a portion of the downlink time resource frequency so the base station may determine that the UE attempting the random access via the uplink resource is an SBFD UE.

Alternatively, the base station may not configure the separate random access resource for the SBFD UE, but configure the common random access resource for all UEs within the cell. In this case, the configuration information for the random access resource may be transmitted to all UEs within the cell via the system information, and the SBFD UE receiving the system information may perform the random access on the random access resource. Thereafter, the SBFD UE may complete the random access process and enter RRC connection mode to transmit and receive data to and from the cell. After the RRC connection mode, the SBFD UE may receive, from the base station, a higher or physical signal that may determine that some frequency resources of the downlink time resource are configured for the uplink resources, and may perform an SBFD operation, for example, transmit an uplink signal from the uplink resources.

When the SBFD UE determines that the cell supports the SBFD, the SBFD UE may transmit, to the base station, capability information including at least one or more pieces of information from among whether the UE supports the SBFD, whether the UE supports full-duplex communication or half-duplex communication, and the number of transmit or receive antennas that the UE includes (or supports), thereby notifying the base station that the UE attempting the access is the SBFD UE. Alternatively, when the half-duplex communication support is an essential implementation for the SBFD UE, whether the half-duplex communication is supported may be omitted from the capability information. The SBFD UE may report the capability information to the base station through the random access procedure, report the capability information to the base station after completing the random access procedure, or report the capability information to the base station after entering the RRC connection mode for transmitting and receiving data to and from the cell.

The SBFD UE may support the half-duplex communication performing only the uplink transmission or downlink reception in an instant, and support the full-duplex communication performing both the uplink transmission and downlink reception in an instant, like the existing TDD UE. Therefore, the SBFD UE may report whether to support the half-duplex or full-duplex communication to the base station via the capability report. After the report, the base station may configure, for the SBFD UE, whether the SBFD UE performs transmission and reception using the half-duplex communication or full-duplex communication. When the SBFD UE reports the half-duplex communication capability to the base station, since there is generally no duplexer, a switching gap may be required to change the RF between the transmission and reception when the SBFD UE operates in the FDD or TDD.

FIG. 11 is a diagram illustrating an example of an SBFD operation in a TDD spectrum of a wireless communication system to which the present disclosure is applied.

FIG. 11A illustrates a case where TDD operates in a specific frequency band. In a cell operating the TDD, the base station may transmit and receive, to and from the existing TDD UE or SBFD UE, a signal including data/control information in a downlink slot (or symbol), an uplink slot (or symbol) 1101, and a flexible slot (or symbol) based on a configuration for TDD UL-DL resource configuration information indicating downlink slot (or symbol) resources and uplink slot (or symbol) resources of the TDD.

In FIG. 11, it may be assumed that a DDDSU slot format is configured based on the TDD UL-DL resource configuration information. Here, ‘D’ denotes a slot in which all symbols are composed of downlink symbols, ‘U’ denotes a slot in which all symbols are composed of uplink symbols, and ‘S’ denotes a slot other than ‘D’ or ‘U’, i.e., a slot including the downlink or uplink symbols or the flexible symbol. Here, for convenience, it may be assumed that S is composed of 12 downlink symbols and 2 flexible symbols. Furthermore, the DDDSU slot format may be repeated depending on the TDD UL-DL resource configuration information. That is, the repetition periodicity of the TDD configuration may be 5 slots (5 ms for 15 kHz SCS, 2.5 ms for 30 kHz SCS, etc.).

Next, FIGS. 11B to 11D illustrate cases where the SBFD operates along with the TDD in a specific frequency band.

Referring to FIG. 11B, the UE may configure some of frequency bands of a cell as a frequency band 1110 capable of uplink transmission. This band may be referred to as an uplink subband (UL subband). Furthermore, the uplink subband (UL subband) may be applied to all symbols in all slots. The UE may transmit an uplink channel or signal scheduled for all symbols 1112 within the UL subband. However, the UE may not transmit the uplink channel or signal in a band other than the UL subband.

Referring to FIG. 11C, the UE may be configured with some the frequency bands of the cell as a frequency band 1120 capable of the uplink transmission and may also be configured with a time domain during which the frequency band is activated. Here, the frequency band may be referred to as the uplink subband (UL subband). In FIG. 11C, the uplink subband (UL subband) is deactivated in a first slot, and the uplink subband (UL subband) may be activated in the remaining slots. Therefore, the UE may transmit the uplink channel or signal on an uplink subband (UL subband) 1122 of the remaining slots. In the example of FIG. 11C, the uplink subband (UL subband) is activated on a slot-by-slot basis. However, this is for illustrative purposes only. It may be configured whether the uplink subband (UL subband) is activated on a symbol-by-symbol basis.

Referring to FIG. 11D, the UE may be configured with time-frequency resources capable of the uplink transmission. The UE may configure one or more time-frequency resources as the time-frequency resources capable of the uplink transmission. For example, some of frequency bands 1132 of the first slot and a second slot may be configured as the time-frequency resources capable of the uplink transmission. In addition, some of frequency bands 1133 of a third slot and some of frequency bands 1134 of a fourth slot may be configured as the time-frequency resources capable of the uplink transmission.

In the following description, the time-frequency resources capable of the uplink transmission within a downlink symbol or slot may be referred to as SBFD resources. Furthermore, a symbol in which the uplink subband is configured within the downlink symbol may be referred to as an SBFD symbol. In addition, time-frequency resources capable of downlink reception within the uplink symbol or slot may be referred to as SBFD resources. Furthermore, a symbol in which a downlink subband is configured within the uplink subband may be referred to as an SBFD symbol.

For convenience, in the present disclosure, a band capable of downlink channel or signal reception, excluding the uplink subband, is referred to as a downlink subband. The UE may configure up to one uplink subband and up to two downlink subbands per symbol. For example, the UE may be configured with one of {uplink subband, downlink subband}, {downlink subband, uplink subband}, or {first downlink subband, uplink subband, second downlink subband} in a frequency domain.

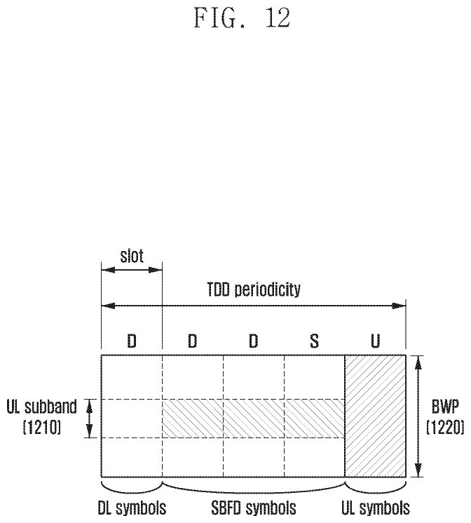

FIG. 12 is a diagram illustrating the SBFD configuration according to an embodiment of the present disclosure.

The present embodiment will be described with reference to FIG. 12. FIG. 12 is one example, and the present embodiment may be equally applied to other embodiments. Referring to FIG. 12, the UE may be configured with the uplink symbol, the downlink symbol, and the flexible symbol depending on the TDD configuration. Here, a ‘D’ slot denotes a slot in which all symbols in a slot are the downlink symbols. A ‘U’ slot denotes a slot in which all the symbols in the slot are the uplink symbols. An ‘S’ slot denotes a slot other than the ‘D’ slot or the ‘U’ slot.

The UE may be configured with a UL BWP 1220. Furthermore, the UE may be configured with a UL subband 1210 within a DL symbol. In the present embodiment, it is assumed that the UL BWP 1220 includes 275 RBs and the UL subband 1210 includes 50 RBs. It is assumed that the UL subband is not configured in the first slot. Therefore, the first slot is called a DL slot, and the symbol included in the first slot is called a DL symbol. It is assumed that the UL subband is configured in second, third, and fourth slots. Therefore, the second, third, and fourth slots are called SBFD slots, and the symbols included in the second, third, and fourth slots are called SBFD symbols. A fifth slot is an uplink slot, and the symbol included in the slot is called the uplink symbol.

A base station antenna may be composed of two antenna panels. The antenna panel may include one or more antenna elements. For convenience, the antenna panel has been used, but the panel may be equivalently referred to by other terms, such as an antenna group or a panel group. One of the two antenna panels is referred to as the first panel, and the other is referred to as the second panel. The two antenna panels may include the same number of antenna elements or different numbers of antenna elements. Furthermore, the two antenna panels may include the same number of transceiver units (TxRUs) or different numbers of TxRUs. The present disclosure describes two antenna panels, but may also be applied to multiple antenna panels.

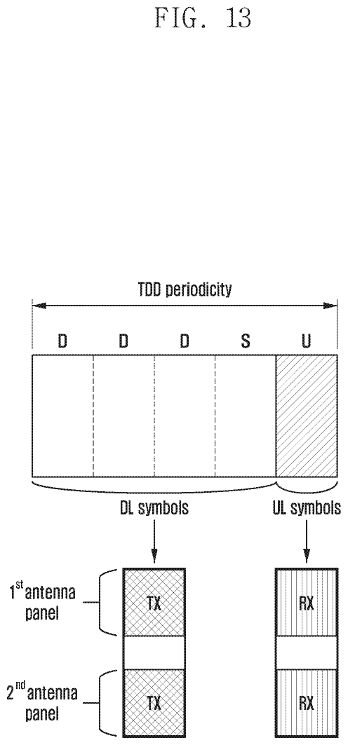

FIG. 13 is a diagram illustrating an antenna operation method in a TDD transmission scheme.

Referring to FIG. 13, a structure of a base station antenna for TDD operation is determined as follows. In the example of FIG. 13, it is assumed that the first four slots are used for the downlink, and the last slot is used for the uplink, depending on the TDD configuration. The base station may use two antenna panels for downlink transmission in a downlink slot or downlink symbol for downlink transmission. In addition, the two antenna panels may be used for uplink reception in the uplink slot or uplink symbol.

Referring to FIG. 13, the antenna panels used in symbols capable of downlink transmission are always the same as two panels. In addition, the antenna panels used in symbols capable of uplink reception are always the same as two panels. In addition, the base station uses the antenna panel used for downlink transmission for uplink reception. In other words, the base station may use the same antenna panel for downlink transmission and uplink reception.

### [Antenna Operation Method for SBFD Operation]

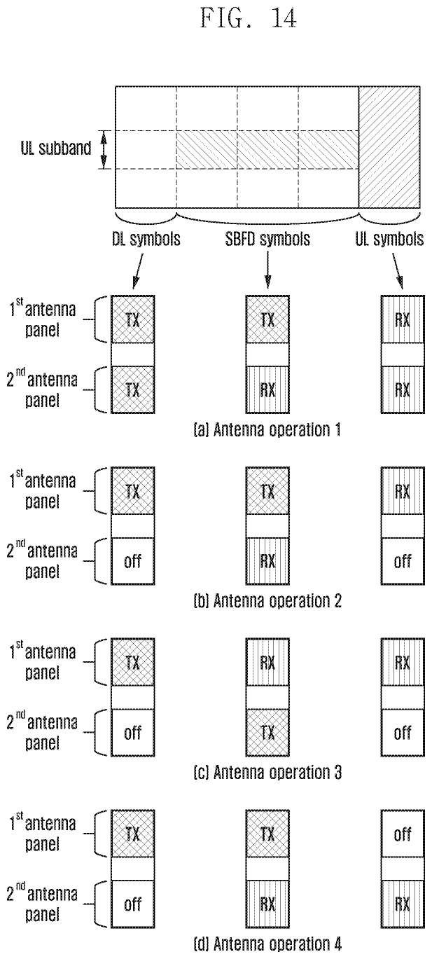

FIG. 14 is a diagram illustrating a static antenna operation method in an SBFD transmission scheme according to an embodiment of the present disclosure.

Hereinafter, the structure of the base station antenna for the SBFD operation will be described with reference to FIG. 14.

The base station may perform the SBFD operation using two antenna panels in various methods. The antenna operation method to be described below refers to the antenna panel used depending on the type or purpose of symbols during the SBFD operation.

In the first antenna operation method, referring to FIG. 14A, when transmitting the downlink channel/signal in the downlink symbol/slot, the base station may use both the first and second antenna panels for downlink transmission. When receiving the uplink channel/signal in the uplink symbol/slot, the base station may use both the first and second antenna panels for uplink reception. When transmitting the downlink channel/signal and receiving the uplink channel/signal in the SBFD symbol/slot, the base station may use the first antenna panel for downlink transmission and the second antenna panel for uplink reception. According to the first antenna operation method, the number of antenna elements or antenna panels used for downlink transmission in the downlink symbol/slot may be greater than the number of antenna elements or antenna panels used for downlink transmission in the SBFD symbol/slot. In addition, the number of antenna elements or the number of antenna panels used for uplink reception in the uplink symbol/slot may be greater than the number of antenna elements or the number of antenna panels used for uplink reception in the SBFD symbol/slot. Therefore, the number of antenna elements or the number of antenna panels used for downlink transmission may vary depending on which symbol the downlink channel/signal received by the UE is transmitted in, and the characteristics of the transmission signal of the base station may vary accordingly. Therefore, the UE needs to know which antenna mode (it is referred to as antenna mode refers to the number of panels, the number of antenna elements used for downlink transmission and the number of panels, the number of antenna elements used for uplink reception according to the antenna operation method) the base station uses. The same applies to the uplink. That is, the number of antenna elements or the number of antenna panels used for uplink transmission may vary depending on which symbol the uplink channel/signal transmitted by the UE is transmitted in, and the characteristics of the reception of the base station may vary accordingly.

As the second antenna operation method, referring to FIG. 14B, when transmitting the downlink channel/signal in the downlink symbol/slot, the base station may use the first antenna panel for downlink transmission. When transmitting the uplink channel/signal in the uplink symbol/slot, the base station may use the first antenna panel for uplink reception. When transmitting the downlink channel/signal and receiving the uplink channel/signal in the SBFD symbol/slot, the base station may use the first antenna panel for downlink transmission and the second antenna panel for uplink reception. In this method, the antenna panel or antenna element used by the base station for downlink transmission in the downlink symbol/slot is the same as the antenna panel or antenna element used by the base station for downlink transmission in the SBFD symbol/slot. However, the antenna panel or antenna element used by the base station for uplink reception may be different from the antenna panel or antenna element used by the base station for uplink reception in the SBFD symbol/slot. Therefore, the antenna element used for uplink transmission may vary depending on which symbol the uplink channel/signal transmitted by the UE is transmitted in, and the characteristics of the signal received by the base station may vary accordingly.

As the third antenna operation method, referring to FIG. 14C, when transmitting the downlink channel/signal in the downlink symbol/slot, the base station may use the first antenna panel for downlink transmission. When transmitting the uplink channel/signal in the uplink symbol/slot, the base station may use the first antenna panel for uplink reception. When transmitting the downlink channel/signal and receiving the uplink channel/signal in the SBFD symbol/slot, the base station may use the first antenna panel for uplink reception and the second antenna panel for downlink transmission. In this method, the antenna panel or antenna element used by the base station for uplink reception in the uplink symbol/slot is the same as the antenna panel or antenna element used by the base station for uplink reception in the SBFD symbol/slot. However, the antenna panel or antenna element used by the base station for downlink transmission in the downlink symbol/slot may be different from the antenna panel or antenna element used by the base station for downlink transmission in the SBFD symbol/slot. Therefore, the antenna element used for downlink transmission may vary depending on which symbol the downlink channel/signal received by the UE is transmitted in, and the characteristics of the signal transmitted by the base station may vary accordingly.

As the fourth antenna operation method, referring to FIG. 14D, when transmitting the downlink channel/signal in the downlink symbol/slot, the base station may use the first antenna panel for downlink transmission. When transmitting the uplink channel/signal in the uplink symbol/slot, the base station may use the second antenna panel for uplink reception. When transmitting the downlink channel/signal and receiving the uplink channel/signal in the SBFD symbol/slot, the base station may use the first antenna panel for downlink transmission and the second antenna panel for uplink reception. In this method, the antenna panel or antenna element used by the base station for downlink transmission in the downlink symbol/slot is the same as the antenna panel or antenna element used by the base station for downlink transmission in the SBFD symbol/slot. In addition, the antenna panel or antenna element used by the base station for uplink reception in the uplink symbol/slot is the same as the antenna panel or antenna element used by the base station for uplink reception in the SBFD symbol/slot. Therefore, the UE may not need separate information about the antenna mode.

The above four methods are examples of the antenna operation methods for various SBFD operations. The present invention is not limited to four antenna operation methods described above.

### [Scheduling Constraints]

When the UE receives a PDSCH, the PDSCH may be scheduled across a symbol corresponding to a first symbol type and a symbol corresponding to a second symbol type. Here, the first symbol type may be an SBFD symbol, and the second symbol type may be a non-SBFD symbol. The SBFD symbol may be a symbol configured with a DL subband or a UL subband, and the non-SBFD symbol may be a symbol not configured with a DL subband or a UL subband.

It may be determined whether the PDSCH scheduled across a symbol corresponding to the first symbol type and a symbol corresponding to the second symbol type may be received based on the structure of the base station antenna.

For example, when the base station transmits the PDSCH based on the first antenna operation method, the signal received by the UE on the non-SBFD symbol may be transmitted from two antenna panels of the base station, and the signal received by the UE on the SBFD symbol may be transmitted from one antenna panel of the base station. That is, the number of panels transmitting the PDSCH at the base station may vary, so a power difference and a phase difference may occur between the signal received on the non-SBFD symbol and the signal received on the SBFD symbol. Therefore, in this case, the UE may not be able to receive (i.e., decode) the PDSCH scheduled across the SBFD symbol and the non-SBFD symbol.

For example, when the base station transmits the PDSCH based on the second antenna operation method, both the signal received by the UE on the non-SBFD symbol and the signal received on the SBFD symbol are transmitted from the same antenna panel of the base station. Therefore, no power or phase difference may occur between the signal received on the non-SBFD symbol and the signal received on the SBFD symbol. Therefore, the UE may receive the PDSCH scheduled across the SBFD symbol and the non-SBFD symbol.

According to an embodiment of the present disclosure, when the PDSCH scheduled for the UE is scheduled across the non-SBFD symbol and the SBFD symbol, the base station may configure, for the UE, whether the scheduled PDSCH is receivable. The UE that has received, from the base station, a configuration that the PDSCH is receivable may assume that the signal received on the non-SBFD symbol on which the PDSCH is scheduled and the signal received on the SBFD symbol have the same power or the same phase.

According to an embodiment of the present disclosure, the base station may configure whether the UE may receive the scheduled PDSCH in one reception occasion. Here, the one reception occasion may be positioned within one slot.

The base station may configure one of the following for the UE.

Configuration 1-1: The UE may receive the PDSCH only when the symbol types are the same in the reception occasion. According to configuration 1-1, when the symbol types included in one reception occasion are the same, i.e., when one reception occasion includes only the non-SBFD symbol or only the SBFD symbol, the UE may receive the PDSCH in one reception occasion. However, when one reception occasion includes both the non-SBFD symbol and SBFD symbols, the UE may not receive the PDSCH in the one reception occasion.

Configuration 1-2: The UE may receive the PDSCH even if the symbol types are different in the reception occasion. According to configuration 1-2, when the symbol types included in one reception occasion includes only the non-SBFD symbol, only the SBFD symbol, or both the non-SBFD and SBFD symbols, the UE may receive the PDSCH in the one reception occasion.

According to an embodiment of the present disclosure, the base station may configure whether the UE may receive the scheduled PDSCH(s) in multiple reception occasions. Here, the reception occasions may be as follows.

When repeated PDSCH transmission is configured in K slots, the reception occasion is a set of symbols in which the PDSCH is scheduled within each of the K slots. For example, when a start symbol of the PDSCH in a slot is 0, the length of the PDSCH (the number of symbols included in the PDSCH) is 14, and K=4, the number of reception occasions is four, four reception occasions are located in each of the four slots, and each reception occasion may include 14 symbols starting from start symbol 0.

When reception of K PDSCHs is scheduled by one DCI format, each reception occasion is a set of symbols included in each of the K PDSCHs. For example, a DCI format may schedule a first PDSCH and a second PDSCH. The first PDSCH may have a start symbol of 0 and a length of 7 in the first slot, and the second PDSCH may have a start symbol of 4 and a length of 10 in the second slot. In this case, the number of reception occasions may be 2 which corresponds to the number of PDSCHs. The first reception occasion may correspond to the symbols (with a start symbol of 0 and a length of 7 in the first slot) in which the first PDSCH is scheduled, and the second reception occasion may correspond to the symbols (with a start symbol of 4 and a length of 10 in the second slot) in which the second PDSCH is scheduled.

The base station may configure at least one of the following for the UE.
Configuration 2-1: The UE may receive the PDSCH only when the symbol types of all reception occasions are the same. That is, when the PDSCH is scheduled in multiple reception occasions, the UE may receive the PDSCH if the symbols included in all reception occasions are the non-SBFD symbols. Alternatively, when the PDSCH is scheduled in multiple reception occasions, the UE may receive the PDSCH if the symbols included in all reception occasions are the SBFD symbols. However, when the symbols included in all reception occasions include at least one non-SBFD symbol and at least one SBFD symbol, the UE may not receive the PDSCH in all reception occasions.
Configuration 2-2: The UE may receive the PDSCH in multiple reception occasions when each reception occasion includes one symbol type. That is, when the PDSCH is scheduled in multiple reception occasions, even if the symbol types of all symbols included in the multiple reception occasions are not the same, if each reception occasion includes one symbol type (e.g., the reception occasion including only the non-SBFD symbols or the reception occasion including only the SBFD symbols), the UE may receive the PDSCH in all reception occasions. Conversely, when at least one of the multiple reception occasions includes both the SBFD symbols and non-SBFD symbols, the PDSCH may not be received in all of the multiple reception occasions.
Configuration 2-3: The UE may receive the PDSCH in the reception occasion that includes only a specific symbol type. When one reception occasion includes only the specific symbol type, the reception occasion may be called a valid reception occasion. When one reception occasion includes a symbol other than the specific symbol type, the reception occasion may be called an invalid reception occasion. The UE may receive the PDSCH in a valid reception occasion. However, the UE may not receive the PDSCH in an invalid reception occasion.

For reference, the specific symbol type may be one symbol type (SBFD symbol or non-SBFD symbol) or multiple symbol types (including both SBFD symbol and non-SBFD symbol). When the specific symbol type is one symbol type (SBFD symbol) and one reception occasion includes only the SBFD symbol, the corresponding one reception occasion is a valid reception occasion, and when one reception occasion includes at least one non-SBFD symbol, the corresponding one reception occasion may be the invalid reception occasion. As another example, when the specific symbol type is one symbol type (non-SBFD symbol) and one reception occasion includes only the non-SBFD symbol, the corresponding one reception occasion is a valid reception occasion, and when one reception occasion includes at least one SBFD symbol, the corresponding one reception occasion may be the invalid reception occasion. When the specific symbol type is multiple symbol types (SBFD symbol and non-SBFD symbol), one reception occasion that includes only one of the multiple symbol types (SBFD symbol and only non-SBFD symbol) may be called a valid reception occasion, and one reception occasion that includes the multiple symbol types (including both the SBFD symbol and non-SBFD symbol) may be called an invalid reception occasion.
The specific symbol type may be determined by at least one of the following methods.
In the first method, the specific symbol type may be configured using the higher layer signal. For example, in the case of the SPS PDSCH configuration, the SBFD symbol or the non-SBFD symbol may be configured as the specific symbol type in which the SPS PDSCH is to be received. Additionally, multiple symbol types (SBFD symbol and non-SBFD symbol) may be configured as the specific symbol type in which the SPS PDSCH is to be received. Information on the specific symbol type to be received may be configured separately for each SPS PDSCH configuration.

For example, for the first SPS PDSCH, the non-SBFD symbol may be configured as the specific symbol type. In this case, when the reception occasion for the SPS PDSCH determined according to the first SPS PDSCH includes only the non-SBFD symbols, the UE may receive the SPS PDSCH at the reception occasion. Conversely, when the reception occasion includes symbols other than the non-SBFD symbol, the UE may not receive the SPS PDSCH at the reception occasion. For the second SPS PDSCH, the SBFD symbol may be configured as the specific symbol type. In this case, when the reception occasion for the SPS PDSCH determined according to the second SPS PDSCH includes only the SBFD symbols, the UE may receive the SPS PDSCH at the reception occasion. Conversely, when the reception occasion includes symbols other than the SBFD symbol, the UE may not receive the SPS PDSCH at the reception occasion. For a third SPS PDSCH, multiple symbol types (SBFD symbol and non-SBFD symbol) may be configured as the specific symbol type. In this case, when the reception occasion for the SPS PDSCH determined according to the third SPS PDSCH includes only the SBFD symbols or only the non-SBFD symbols, the UE may receive the SPS PDSCH at the reception occasion. Conversely, when the reception occasion includes both the SBFD symbol and non-SBFD symbol, the UE may not receive the SPS PDSCH at the reception occasion.
As a second method, the specific symbol type may be indicated by the DCI format. The DCI format may include a 1-bit or 2-bit symbol type indication field. For 1 bit, a first value (e.g., ‘0’) may indicate the non-SBFD symbol as the specific symbol type, and a second value (e.g., ‘1’) may indicate the SBFD symbol as the specific symbol type. For 2 bits, the first value (e.g., ‘00’) may indicate the non-SBFD symbol as the specific symbol type, the second value (e.g., ‘01’) may indicate the SBFD symbol as the specific symbol type, and a third value (e.g., ‘10’) may indicate multiple symbol types (including both the SBFD symbol and non-SBFD symbol) as the specific symbol type. When receiving the PDSCH scheduled by the DCI format, the UE may receive the PDSCH at the reception occasion corresponding to the symbol type indicated by the symbol type indication field. For example, the DCI format may schedule the first PDSCH and indicate the non-SBFD symbol as the specific symbol type via the 1-bit or 2-bit symbol type indication field. In this case, when the reception occasion of the first PDSCH includes only the non-SBFD symbols, the UE may receive the first PDSCH at the reception occasion. Conversely, when the reception occasion includes symbols other than the non-SBFD symbol, the UE may not receive the first PDSCH at the reception occasion. The DCI format may schedule a second PDSCH and indicate the SBFD symbol as the specific symbol type via the 1-bit or 2-bit symbol type indication field. In this case, when the reception occasion of the second PDSCH includes only the SBFD symbols, the UE may receive the second PDSCH at the reception occasion. Conversely, when the reception occasion includes symbols other than the SBFD symbol, the UE may not receive the second PDSCH at the reception occasion. The DCI format may schedule a third PDSCH and indicate multiple symbol types (SBFD symbol and non-SBFD symbol) as the specific symbol type via a 2-bit symbol type indication field. In this case, when the reception occasion of the third PDSCH includes only the SBFD symbols or only the non-SBFD symbols, the UE may receive the third PDSCH at the reception occasion. Conversely, when the reception occasion includes both the SBFD symbol and non-SBFD symbol, the UE may not receive the third PDSCH at the reception occasion.
As a third method, the specific symbol type may be determined based on the PDSCH that is temporally received first among the repeatedly received PDSCHs. When the PDSCH that is temporally received first among the repeatedly received PDSCHs is received at the reception occasion that includes only the SBFD symbol, the UE may determine that the specific symbol type is the SBFD symbol. When the PDSCH that is temporally received first among the repeatedly received PDSCHs is received at the reception occasion that includes only the non-SBFD symbol, the UE may determine that the specific symbol type is the non-SBFD symbol.

### [Type-1 HARQ-ACK Codebook Association]

A method for configuring a Type-1 HARQ-ACK codebook in an NR system will be described. For reference, a Type-1 HARQ-ACK codebook is also called a semi-static HARQ-ACK codebook.

The following description assumes a situation in which the PUCCH via which the UE may transmit HARQ-ACK information is limited to one within one time unit (e.g., slot, sub-slot, mini-slot). Unless otherwise mentioned, the time unit is described as a slot, but this may be extended to the sub-slot, the mini-slot, etc.

The UE may be configured with a semi-static HARQ-ACK codebook configuration from the base station. Here, the configuration may be configured via a higher layer signal (e.g., an RRC signal). The UE may receive the DCI format from the base station. The UE may transmit HARQ-ACK information, including PDSCHs scheduled by the DCI format, SPS PDSCH release, or Scell dormancy indication, in a slot indicated by a value of a PDSCH-to-HARQ_feedback timing indicator field within the DCI format. When the UE is instructed to transmit multiple pieces of HARQ-ACK information in one slot, the UE may generate the HARQ-ACK information into the HARQ-ACK codebook according to defined rules and transmit the generated HARQ-ACK information on one PUCCH in the slot.

More specifically, rules for generating a semi-static HARQ-ACK codebook are as follows.

The UE reports a HARQ-ACK information bit value as NACK within the HARQ-ACK codebook in a slot not indicated by a PDSCH-to-HARQ_feedback_timing_indicator field in the DCI format.

When the UE reports only the HARQ-ACK information for one SPS PDSCH release or one PDSCH reception in all M_{A,C} cases for candidate PDSCH reception, and the report is scheduled by DCI format 1_0, which includes information indicating that a counter DACI field in the Pcell indicates 1, the UE determines one HARQ-ACK codebook for the corresponding SPS PDSCH release or the corresponding PDSCH reception.

Otherwise, a method for determining a HARQ-ACK codebook is based on a method described below.

For convenience of the present disclosure, a PDSCH-to-HARQ_feedback timing indicator value is referred to as a K1 value. The UE may be configured with multiple K1 values, and these multiple K1 values are collectively referred to as a K1 set.

A set of PDSCH reception candidate occasions in a serving cell c is referred to as M_{A,c} and a method for obtaining M_{A,c} will be described below.

### <Type-1 HARQ-ACK Codebook>

First, it is assumed that the PDSCH scheduled by the DCI format is received in one slot. This may include a case where pdsch-AggregationFactor is not configured from the higher layer.

A pseudo-code for transmitting a PUCCH or PUSCH delivering a Type-1 HARQ-ACK codebook in slot n is as follows.

### [Pseudo-Code 1: (No Repeated Reception of PDSCH)]

Preparation step: Set R is a set of scheduling information (slot information (hereinafter, K0 value) to which the PDSCH is mapped, a start symbol and length information (hereinafter, starting and length value (SLIV)) configured in a time domain resource assignment (TDRA) table. When the UE monitors one or more DCI formats and the DCI formats use different TDRA tables, the set R is generated based on all TDRA tables.
Step 0: Initialize M_{A,c} to an empty set. Initialize k to 0. Initialize j to 0. Initialize j to 0.
Step 1: Select a kth largest K1 value from the configured K1 set. (For example, when k=0, select the largest K1 value from the K1 set, and when k=1, select a second largest K1 value from the K1 set.) The K1 value is referred to as K_{1,k}.
Step 2: When, in the slot (slot n−K_{1,k}) corresponding to the K_{1,k} value, the symbol corresponding to the starting and length value (SLIV) belonging to each row of the set R overlaps with a symbol configured for the uplink by the higher layer, the row may be excluded from the set R.
Step 3-1 (When the UE has only the UE capability to receive up to one unicast PDSCH per slot): When the determined set R is not an empty set, j is added as a new PDSCH reception candidate occasion to the set M_{A,c}. When receiving one of the PDSCH candidates in the set R, the UE may position the HARQ-ACK of the one PDSCH in the new PDSCH candidate occasion j. j is incremented by 1.
Step 3-2: (When the UE has the UE capability to receive more than one unicast PDSCH per slot): For the SLIV ending earliest in the determined set R and the SLIVs that temporally overlap with the SLIV, j is added as a new PDSCH reception candidate occasion to the set M_{A,c}. When receiving one of the PDSCH candidates having the SLIV, the UE may position the HARQ-ACK of the one PDSCH in the new PDSCH candidate occasion j. j is incremented by 1. The SLIVs is excluded from the set R. Step 3-2 is repeated until the set R is an empty set.
Step 4: k is incremented by 1. When k is less than cardinality of the K1 set, it restarts from Step 2, and when k is equal to or greater than the cardinality of the K1 set, pseudo-code 1 is terminated.

### [End of Pseudo-Code 1]

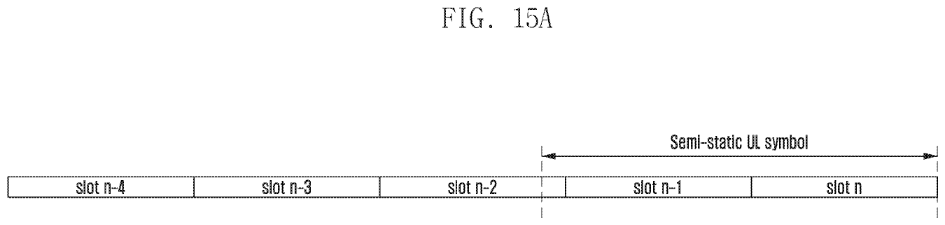

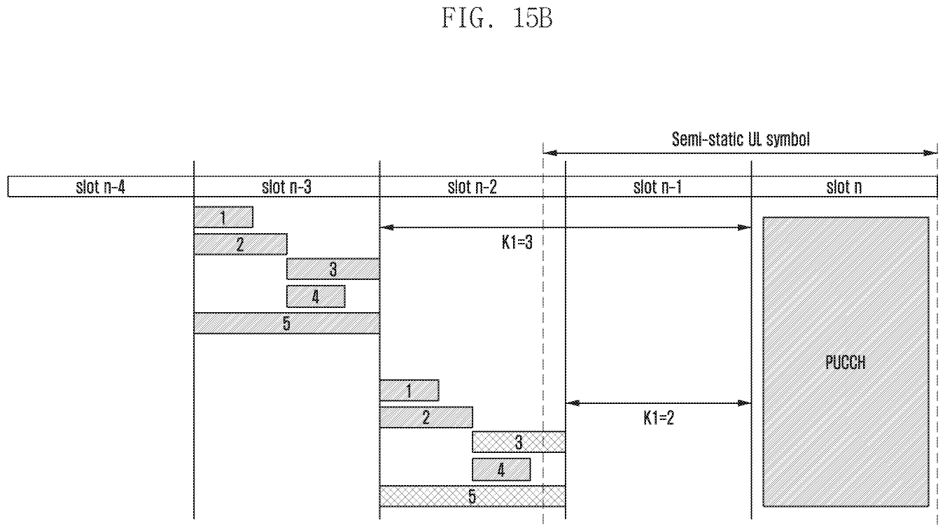

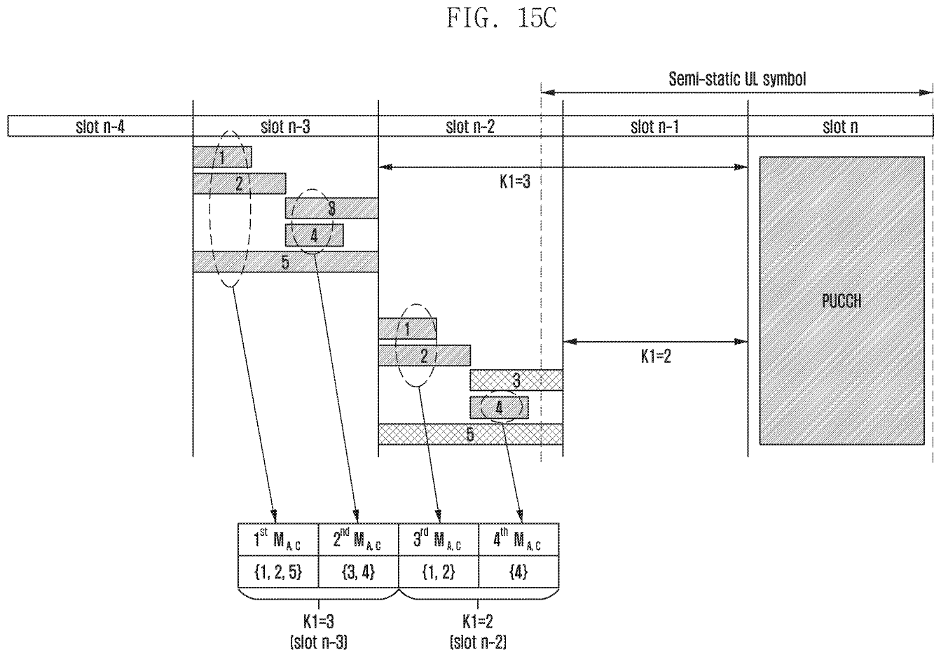

FIGS. 15A to 15C are diagrams illustrating the Type-1 HARQ-ACK codebook for HARQ-ACK transmission on the PDSCH according to an embodiment of the present disclosure.

Referring to FIGS. 15A to 15C, the UE performs the PUCCH transmission including the HARQ-ACK information in slot n. The HARQ-ACK information may be generated in the form of the Type-1 HARQ-ACK codebook.

The UE may receive uplink/downlink configuration information from the base station. According to the uplink/downlink configuration information, the UE may determine whether the symbol is the uplink symbol, the downlink symbol, or the flexible symbol. For convenience, only the uplink symbol is described herein, and symbols other the uplink symbol may be the downlink symbols or the flexible symbols. Referring to FIG. 15A, all symbols in slot n and slot n−1 may be configured for the uplink symbols. The last two symbols in slot n−2 may be configured for the uplink symbols.

It is assumed that K1=2 and K1=3 as the K1 value are configured for the UE. That is, the K1 set is {2,3}. In addition, the TDRA table in the DCI format monitored by the UE may include five rows, as shown in Table 24. For reference, a K0 value, a SLIV value, or a PDSCH mapping type value may be configured in each row, but for convenience of description, the PDSCH mapping type is omitted.

TABLE 24

| Index | K0 | SLIV (S, L) |
|---|---|---|
| 1 | 0 | SLIV 1 (0, 4) |
| 2 | 0 | SLIV 2 (0, 7) |
| 3 | 0 | SLIV 3 (7, 7) |
| 4 | 0 | SLIV 4 (7, 4) |
| 5 | 0 | SLIV 5 (0, 14) |

Depending on the preparation step, the UE may include each SLIV row of the TDRA table in Table 24 in the set R. FIG. 15A illustrates the SLIVs for each row. The UE may determine the PDSCH reception candidate occasion M_{A,c} based on the K1 value and the set R. Referring to FIGS. 15A to 15C, the pseudo code 1 may be interpreted as follows. In the following description, it is assumed that the UE has the UE capability to receive more than one unicast PDSCH in one slot.
Step 0: Initialize M_{A,c} to an empty set. Initialize k to 0. Initialize j to 0.
Step 1: Select a k=0th largest K1 value from the configured K1 set. The K1 value is K_{1,0}=3.

Step 2: When, in the slot n−K_{1,0}=n−3, the symbol corresponding to the start and length indicator value (SLIV) belonging to each SLIV row of the set R overlaps with the symbol configured for the uplink by the higher layer, the SLIV row may be excluded from the set R. Referring to FIG. 15B, when some symbols in slot n−3 are semi-static uplink symbols configured by the higher layer, the SLIV row including the SLIVs overlapping with the symbols may be excluded from the set R. Referring to FIG. 15B, since no semi-static uplink symbol is configured in slot n−3, all SLIV rows may not be excluded from the set R. The set R may include {1, 2, 3, 4, 5}.
Step 3-2 (When the UE has the UE capability to receive more than one unicast PDSCH per slot)
Add j=0 as a new PDSCH reception candidate occasion to the set M_{A,c} for SLIV ending earliest in the determined set R and SLIVs that temporally overlap with the SLIV. Here, the SLIV ending earliest is SLIV1 (0,4) in row 1, and the SLIVs overlapping with the SLIV are SLIV2 (0,7) in row 2 and SLIV5 (0,14) in row 5. Therefore, when j=0 is added to M_{A,c}, and the UE receives a PDSCH scheduled with SLIV1(0,4) in row 1, SLIV2(0,7) in row 2, or SLIV5(0,14) in row 5 in slot n−3, the HARQ-ACK of the PDSCH may be included in a position corresponding to the first (j=0) M_{A,c} in the type-1 HARQ-ACK codebook. j is incremented by 1 so that j=1. The SLIV rows of rows 1, 2, and 5 are excluded from the set R so that R={3, 4}. Since the set R is not an empty set, step 3-2 is repeated.
Add j=1 as a new PDSCH reception candidate occasion to the set M_{A,c} for SLIV ending earliest in the determined set R and SLIVs that temporally overlap with the SLIV. Here, the SLIV ending earliest is SLIV4 (7,4) in row 4, and the SLIV overlapping with the SLIV is SLIV3 (7,7) in row 3. Therefore, when j=1 is added to M_{A,c}, and the UE receives a PDSCH scheduled as SLIV4(7,4) in row 4 or SLIV3(7,7) in row 3 in slot n−3, the HARQ-ACK of the PDSCH may be included in a position corresponding to the second (j=1) M_{A,c} in the type-1 HARQ-ACK codebook. j is incremented by 1 so that j=2. The SLIVs in rows 3 and 4 are excluded from the set R so that R becomes an empty set. Therefore, step 3-2 may be terminated.
Step 4: k is incremented by 1 so that k=1. Since the cardinality of the K1 set is 2, step 2 restarts using the next K1 value. Now, K_{1,1}=2.
Step 2: When, in the slot n−K_{1,1}=n−2, the symbol corresponding to the start and length indicator value (SLIV) belonging to each row of the set R overlaps with the symbol configured for the uplink by the higher layer, the row may be excluded from the set R. Referring to FIG. 15B, when some symbols in slot n−2 are semi-static uplink symbols configured by the higher layer, the row including the SLIVs overlapping with the symbols may be excluded from the set R. Referring to FIG. 15B, the semi-static uplink symbol is configured in slot n−2, and the rows overlapping with the semi-static uplink symbols are rows 3 and 5. Therefore, SLIV row 3 and SLIV row 5 may be excluded from the set R. The set R may include {1, 2, 4}.
Step 3-2 (When the UE has the UE capability to receive more than one unicast PDSCH per slot):
Add j=2 as a new PDSCH reception candidate occasion to the set M_{A,c} for SLIV ending earliest in the determined set R and SLIVs that temporally overlap with the SLIV. Here, the SLIV ending earliest is SLIV1 (0,4) in row 1, and the SLIV overlapping with the SLIV is SLIV2 (0,7) in row 2. Therefore, when j=2 is added to M_{A,c}, and the UE receives a PDSCH scheduled as SLIV1(0,4) in row 1 or SLIV2(0,7) in row 2 in slot n−3, the HARQ-ACK of the PDSCH may be included in a position corresponding to a third (j=2) M_{A,c} in the type-1 HARQ-ACK codebook. j is incremented by 1 so that j=3. The SLIVs of rows 1 and 2 are excluded from the set R, so R={4}. Since the set R is not an empty set, step 3-2 is repeated.
Add j=3 as a new PDSCH reception candidate occasion to the set M_{A,c} for SLIV ending earliest in the determined set R and SLIVs that temporally overlap with the SLIV. Here, the SLIV ending earliest is SLIV 4(7,4) in row 4, and there are no SLIVs overlapping with the SLIV. Therefore, when j=3 is added to M_{A,c}, and the UE receives a PDSCH scheduled as SLIV4(7,4) in row 4 in slot n−3, the HARQ-ACK of the PDSCH may be included in a position corresponding to a fourth (j=3) M_{A,c} in the type-1 HARQ-ACK codebook. j is incremented by 1 so that j=4. The SLIV in row 4 is excluded from the set R, so R becomes an empty set. Therefore, step 3-2 may be terminated.
Step 4: k is incremented by 1 so that k=2. Since the cardinality of the K1 set is 2, the pseudo-code is terminated.

Referring to FIG. 15C, the UE may determine M_{A,c} corresponding to four PDSCH reception candidate occasions j=0, j=1, j=2, and j=3. Here, M_{A,C} corresponding to j=0 and j=1 denotes PDSCH reception candidate occasions in slot n−3, and M_{A,C} corresponding to j=2 and j=3 denotes PDSCH reception candidate occasions in slot n−2. The size of the Type-1 HARQ-ACK codebook may be determined based on the number of PDSCH reception candidate occasions. The actual number of bits per PDSCH reception candidate occasion may be determined depending on configurations such as the number of transport blocks (TBs) included in each PDSCH, the number of code block groups (CBGs) included in each PDSCH, or spatial bundling.

### <Type-1 HARQ-ACK Codebook Considering Symbol Type>

The present disclosure proposes a method for restricting UE scheduling and designing a corresponding HARQ codebook.

In the SBFD operation, the UE may support the following two modes.

In the first mode, the UE may be scheduled with a PDSCH on the same symbol type. In this mode, the PDSCH scheduled to the UE may not be scheduled across the DL symbol and the SBFD symbol.

In the second mode, the UE may be scheduled with the PDSCH on different symbol types. In this mode, the PDSCH scheduled to the UE may be scheduled across the DL symbol and the SBFD symbol.

The present disclosure includes a method for designing a Type-1 HARQ codebook when a UE is configured in a first mode by a base station.

The UE may exclude the SLIV from the HARQ codebook when the SLIV overlaps with the DL symbol and the SBFD symbol.

When the UE has the SLIV overlapping with the DL symbol and the flexible symbol, the SLIV may be excluded depending on whether the flexible symbols are used for the SBFD. For example, when the flexible symbol may only be used for the SBFD operation (i.e., when the flexible symbol may not be used for DL only), the UE may exclude the SLIV. However, when the flexible symbol may be used for the SBFD operation and DL only operations, the UE may not exclude the SLIV.

According to the example described above, when the SLIV in the TDRA row overlaps with the semi-static uplink symbol, the UE excludes the corresponding overlapping SLIV row from the set R. This is because the UE expects not to be scheduled the PDSCH based on the SLIV in the row. Even if the base station schedules the PDSCH based on the SLIV in the row, the UE may not receive the PDSCH since the SLIV in the row overlaps with the semi-static uplink symbol. Therefore, the Type-1 HARQ-ACK codebook may reduce the codebook size by excluding the TDRA rows that do not require HARQ-ACK transmission.

When the SBFD operation is configured, the UE may be configured not only with the semi-static uplink symbol, the semi-static downlink symbol, and the semi-static flexible symbol as the uplink/downlink symbol configurations, but may also have symbols configured with the UL subband or the DL subband depending on the SBFD configuration. Here, the symbol configured with the UL subband or the DL subband is referred to as the SBFD symbol, whereas the symbols without the UL subband or the DL subband are referred to as the non-SBFD symbols. Depending on the scheduling constraints, the UE may not receive the PDSCH in the symbol (the semi-static downlink symbol or the semi-static flexible symbol) other than the semi-static uplink depending on the SBFD configuration. Therefore, the base station may exclude the TDRA row from the Type-1 HARQ-ACK codebook depending on the SBFD configuration.

In an embodiment of the present disclosure, the UE may be configured with configuration 1-1 due to the scheduling constraints. According to configuration 1-1, the UE may receive the PDSCH only when the symbol types are the same in the PDSCH reception occasion. Accordingly, the UE may exclude the PDSCH reception occasions satisfying the following cases from the Type-1 HARQ-ACK codebook.
Condition 1: When the symbol corresponding to the PDSCH reception occasion overlaps with the semi-static uplink symbol, or
Condition 2: When at least one of the symbols corresponding to the PDSCH reception occasion overlaps with the SBFD symbol and at least one other symbol overlaps with the non-SBFD symbol.

Condition 1 is a condition for PDSCH reception occasion that are not receivable depending on the uplink/downlink symbol configuration, regardless of the SBFD configuration. Condition 2 is a condition for PDSCH reception occasion that may not be received depending on the SBFD configuration and the scheduling constraint configuration.

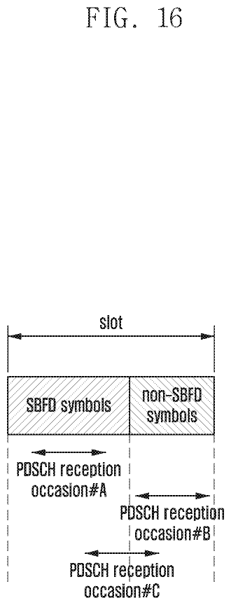

FIG. 16 is a diagram illustrating the PDSCH reception occasion to be included in and excluded from the Type-1 HARQ-ACK codebook depending on the SBFD symbol or the non-SBFD symbol according to an embodiment of the present disclosure.

FIG. 16 illustrates the PDSCH reception occasions according to Condition 2. Referring to FIG. 16, some symbols in a slot may be configured as the SBFD symbol, and the remaining symbols may be configured as the non-SBFD symbol. In the example of FIG. 16, it is assumed that the UE is configured with PDSCH reception occasion #A, PDSCH reception occasion #B, and PDSCH reception occasion #C. All PDSCH reception occasions #A overlap with the SBFD symbols. All PDSCH reception occasions #B overlap with the non-SBFD symbols. Some of the PDSCH reception occasions #C overlap with the SBFD symbol, and the remaining overlap with the non-SBFD symbols. In this case, according to Condition 2, the UE may exclude the PDSCH reception occasion #C overlapping with two symbol types (i.e., at least one symbol is the SBFD symbol, and at the same time, at least one symbol is the non-SBFD symbol) from the Type-1 HARQ-ACK codebook generation.

For reference, here, the SBFD symbol and the non-SBFD symbol may follow at least one of the following definitions.

### First Definition:

The SBFD symbol is a symbol which the base station may use for the SBFD operation as a symbol in which the DL subband or the UL subband is configured.
The non-SBFD symbol is a symbol other than the SBFD symbol, and a symbol which may not be used for the SBFD operation.

According to the first definition, the flexible symbol in which the DL subband or the UL subband is not configured may be included in the non-SBFD symbol. That is, the base station may not perform the SBFD operation in the flexible symbol in which the DL subband or the UL subband is not configured, and the UE does not expect the SBFD operation to be performed in the flexible symbol where the DL subband or the UL subband is not configured. This means that the base station may only use the flexible symbol where the DL subband or the UL subband is not configured for one direction, i.e., for the downlink or uplink transmission.

### Second Definition:

The SBFD symbol is the symbol in which the DL subband or the UL subband is configured, and the flexible symbol that the base station may use for the SBFD operation.
The non-SBFD symbol is a symbol other than the SBFD symbol, and a symbol which may not be used for the SBFD operation.

According to the second definition, the flexible symbol in which the DL subband or the UL subband is not configured may be included in the SBFD symbol. That is, the base station may perform the SBFD operation in the flexible symbol in which the DL subband or the UL subband is not configured, and the UE may not expect the SBFD operation to be performed in the flexible symbol in which the DL subband or the UL subband is not configured.

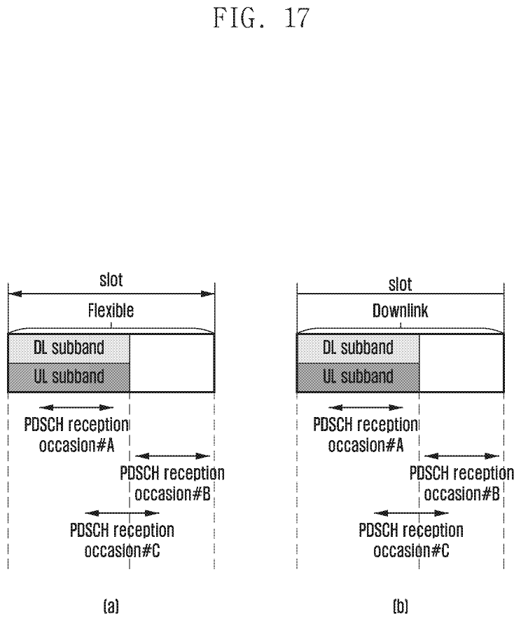

FIG. 17 is a diagram illustrating the PDSCH reception occasion to be included in and excluded from the Type-1 HARQ-ACK codebook according to uplink/downlink slot configuration information and SBFD configuration information according to an embodiment of the present disclosure. Condition 2 according to the first and second definitions is interpreted as follows with reference to FIG. 17.

According to the first definition, Condition 2 may be interpreted as follows.
When some symbols of the PDSCH reception occasion overlap with symbols in which the UL subband or the DL subband is configured, and the remaining some symbols overlap with symbols in which the UL subband or the DL subband is not configured, the UE may exclude the PDSCH reception occasion from the Type-1 HARQ-ACK codebook.
FIG. 17(a) illustrates that the UL subband or the DL subband is configured in the flexible symbol. Here, all symbols in one slot are configured as the flexible symbols, the DL subband or the UL subband is configured in some of the flexible symbols, and the DL subband or the UL subband is not configured in the remaining symbols. It is assumed that three PDSCH reception occasions are configured for the UE.

The PDSCH reception occasion #A overlaps with the flexible symbol in which the DL subband or the UL subband is configured. According to the first definition, the symbols in which the DL subband or the UL subband is configured may be considered as the SBFD symbols. Since the PDSCH reception occasion #A overlaps only with the SBFD symbols, it may be included in the Type-1 HARQ-ACK codebook.

The PDSCH reception occasion #B overlaps with the flexible symbols in which the DL subband or the UL subband is not configured. According to the first definition, the symbols in which the DL subband or the UL subband is not configured may be considered as the non-SBFD symbols. Since the PDSCH reception occasion #B overlaps only with the non-SBFD symbols, it may be included in the Type-1 HARQ-ACK codebook.

Some symbols of the PDSCH reception occasion #C overlap with the flexible symbols in which the DL subband or the UL subband is configured, and the remaining symbols overlap with flexible symbols in which the DL subband or the UL subband is not configured. According to the first definition, the symbols in which the DL subband or the UL subband is configured are the SBFD symbols, and the symbols in which the DL subband or the UL subband is not configured are the non-SBFD symbols. Since the PDSCH reception occasion #C overlaps with both the SBFD symbols and the non-SBFD symbols, it may be excluded from the Type-1 HARQ-ACK codebook.
FIG. 17(b) illustrates that the UL subband or the DL subband is configured in the semi-static downlink symbol. Here, all symbols in one slot are configured as the semi-static downlink symbols, the DL subband or the UL subband is configured in some of the semi-static downlink symbols, and the DL subband or the UL subband is not configured in the remaining symbols. It is assumed that three PDSCH reception occasions are configured for the UE.

The PDSCH reception occasion #A overlaps with the semi-static downlink symbols in which the DL subband or the UL subband is configured. According to the first definition, the symbols in which the DL subband or the UL subband is configured may be considered as the SBFD symbols. Since the PDSCH reception occasion #A overlaps only with the SBFD symbol, it may be included in the Type-1 HARQ-ACK codebook.

The PDSCH reception occasion #B overlaps with the semi-static downlink symbols in which the DL subband or the UL subband is not configured. According to the first definition, the symbols in which the DL subband or the UL subband is not configured may be considered as the non-SBFD symbols. Since the PDSCH reception occasion #B overlaps only with the non-SBFD symbols, it may be included in the Type-1 HARQ-ACK codebook.

Some symbols of the PDSCH reception occasion #C overlap with the semi-static downlink symbols in which the DL subband or the UL subband is configured, and the remaining symbols overlap with the semi-static downlink symbols in which the DL subband or the UL subband is not configured. According to the first definition, the symbols in which the DL subband or the UL subband is configured are the SBFD symbols, and the symbols in which the DL subband or the UL subband is not configured are the non-SBFD symbols. Since the PDSCH reception occasion #C overlaps with both the SBFD symbols and the non-SBFD symbols, it may be excluded from the Type-1 HARQ-ACK codebook.

According to the second definition, Condition 2 may be interpreted as follows.

When some symbols of the PDSCH reception occasion overlap with the symbols in which the UL subband or the DL subband is configured, and the remaining some symbols overlap with the semi-static downlink symbols in which the UL subband or the DL subband is not configured, the UE may exclude the PDSCH reception occasion from the Type-1 HARQ-ACK codebook.

FIG. 17(a) illustrates that the UL subband or the DL subband is configured in the flexible symbol. Here, all symbols in one slot are configured as the flexible symbols, the DL subband or the UL subband is configured in some of the flexible symbols, and the DL subband or the UL subband is not configured in the remaining symbols. It is assumed that three PDSCH reception occasions are configured for the UE.

The PDSCH reception occasion #A overlaps with the flexible symbol in which the DL subband or the UL subband is configured. According to the second definition, the flexible symbols in which the DL subband or the UL subband is configured may be considered as the SBFD symbols. Since the PDSCH reception occasion #A overlaps only with the SBFD symbol, it may be included in the Type-1 HARQ-ACK codebook.

The PDSCH reception occasion #B overlaps with the flexible symbols in which the DL subband or the UL subband is not configured. According to the second definition, even if the DL subband or the UL subband is not configured, the flexible symbols may be considered as the SBFD symbols. Since the PDSCH reception occasion #B overlaps only with the SBFD symbol, it may be included in the Type-1 HARQ-ACK codebook.

Some symbols of the PDSCH reception occasion #C overlap with the flexible symbols in which the DL subband or the UL subband is configured, and the remaining symbols overlap with the flexible symbols in which the DL subband or the UL subband is not configured. According to the second definition, the symbols in which the DL subband or the UL subband is configured are the SBFD symbols, and even if the DL subband or the UL subband is not configured, the flexible symbols are the SBFD symbols. Since the PDSCH reception occasion #C overlaps only with the SBFD symbols, it may be included in the Type-1 HARQ-ACK codebook.

FIG. 17(b) illustrates that the UL subband or the DL subband is configured in the semi-static downlink symbol. Here, all symbols in one slot are configured as the semi-static downlink symbols, the DL subband or the UL subband is configured in some of the semi-static downlink symbols, and the DL subband or the UL subband is not configured in the remaining symbols. It is assumed that three PDSCH reception occasions are configured for the UE.

The PDSCH reception occasion #A overlaps with the semi-static downlink symbols in which the DL subband or the UL subband is configured. According to the second definition, the symbols in which the DL subband or the UL subband is configured may be considered as the SBFD symbols. Since the PDSCH reception occasion #A overlaps only with the SBFD symbol, it may be included in the Type-1 HARQ-ACK codebook.

The PDSCH reception occasion #B overlaps with the semi-static downlink symbols in which the DL subband or the UL subband is not configured. According to the second definition, the semi-static downlink symbols in which the DL subband or the UL subband is not configured may be considered as the non-SBFD symbols. Since the PDSCH reception occasion #B overlaps only with the non-SBFD symbols, it may be included in the Type-1 HARQ-ACK codebook.

Some symbols of the PDSCH reception occasion #C overlap with semi-static downlink symbols in which the DL subband or the UL subband is configured, and the remaining symbols overlap with the semi-static downlink symbols in which the DL subband or the UL subband is not configured. According to the second definition, the symbols in which the DL subband or the UL subband is configured are the SBFD symbols, and the semi-static symbols in which the DL subband or the UL subband is not configured are the non-SBFD symbols. Since the PDSCH reception occasion #C overlaps with both the SBFD symbols and the non-SBFD symbols, it may be excluded from the Type-1 HARQ-ACK codebook.

According to an embodiment of the present disclosure, the Type-1 HARQ-ACK codebook of the UE in which the SBFD operation is configured may be generated as follows.

### [Pseudo-Code 2: (No Repeated Reception of PDSCH)]

Preparation step: Set R is a set of scheduling information (slot information (hereinafter, K0 value) to which the PDSCH is mapped, starting symbol and length information (hereinafter, starting and length value (SLIV)) configured in a time domain resource assignment (TDRA) table. When the UE monitors one or more DCI formats and the DCI formats use different TDRA tables, the set R is generated based on all TDRA tables.
Step 0: Initialize M_{A,c} to an empty set. Initialize k to 0. Initialize j to 0.
Step 1: Select a kth largest K1 value from the configured K1 set. (For example, when k=0, select the largest K1 value from the K1 set, and when k=1, select a second largest K1 value from the K1 set.) The K1 value is referred to as K_{1,k}.
Step 2: When, in the slot (slot n−K_{1,k}) corresponding to the K_{1,k} value, the symbol corresponding to the starting and length value (SLIV) belonging to each SLIV row of the set R overlaps with the symbol configured for the uplink by the higher layer, or some of the symbols corresponding to the starting and length value (SLIV) overlap with the non-SBFD symbols and the remaining symbols overlap with the SBFD symbols, the row may be excluded from the set R.
Step 3-1 (When the UE has only the UE capability to receive up to one unicast PDSCH in one slot): When the determined set R is not an empty set, j is added as a new PDSCH reception candidate occasion to the set M_{A,c}. When receiving one of the PDSCH candidates in the set R, the UE may position the HARQ-ACK of the one PDSCH in the new PDSCH candidate occasion j. j is incremented by 1.
Step 3-2 (When the UE has the UE capability to receive more than one unicast PDSCH per slot): For the SLIV ending earliest in the determined set R and the SLIVs that temporally overlap with the SLIV, j is added as a new PDSCH reception candidate occasion to the set M_{A,c}. When receiving one of the PDSCH candidates having the SLIV, the UE may position the HARQ-ACK of the one PDSCH in the new PDSCH candidate occasion j. j is incremented by 1. The SLIVs is excluded from the set R. Step 3-2 is repeated until the set R is an empty set.
Step 4: k is incremented by 1. When k is less than cardinality of the K1 set, it restarts from Step 2, and when k is equal to or greater than the cardinality of the K1 set, pseudo-code 2 is terminated.

### [End of Pseudo-Code 2]

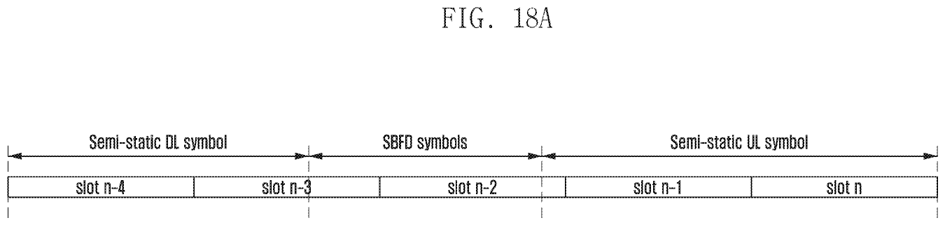

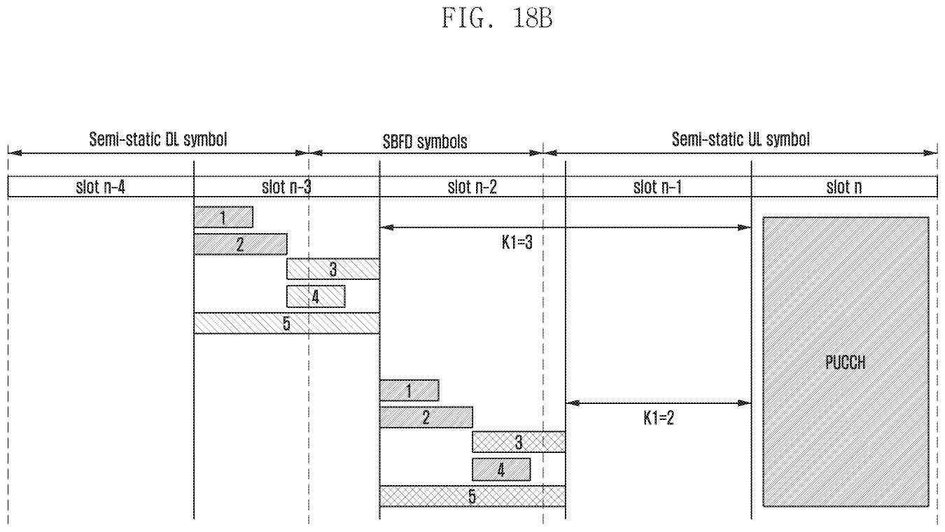

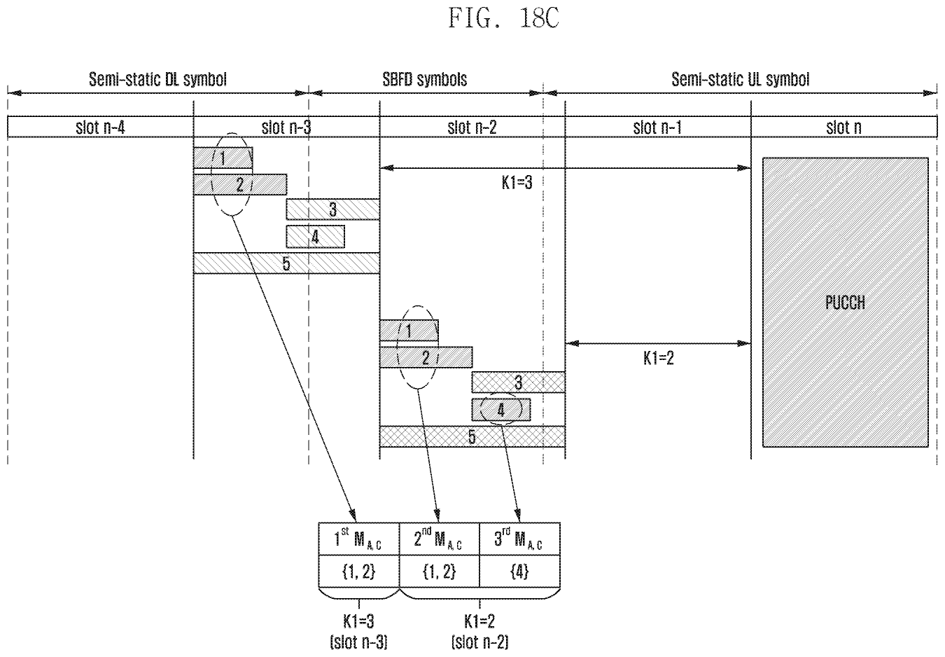

FIGS. 18A to 18C are diagrams illustrating the Type-1 HARQ-ACK codebook for HARQ-ACK transmission by the UE configured with the SBFD operation according to an embodiment of the present disclosure.

Referring to FIGS. 18A to 18C, the pseudo code 2 may be interpreted as follows. In the following description, it is assumed that the UE has the UE capability to receive more than one unicast PDSCH in one slot.

Referring to FIG. 18A, it is assumed that all symbols in slot n−4 are composed of the semi-static downlink symbols, some symbols in slot n−3 are composed of the semi-static downlink symbols, some symbols are composed of the SBFD symbols, some symbols in slot n−2 are composed o the SBFD symbols, some symbols are composed of the semi-static UL symbols, and all symbols in slots n−1 and n are composed of the semi-static uplink symbols.
Step 0: Initialize M_{A,c} to an empty set. Initialize k to 0. Initialize j to 0.
Step 1: Select a k=0th largest K1 value from the configured K1 set. The K1 value is K_{1,0}=3.
Step 2: When, in slot n−K_{1,0}=n−3, the symbols corresponding to the starting and length value (SLIV) belonging to each row of the set R overlap with the symbols configured for the uplink by the higher layer, or some symbols corresponding to the start and length value (SLIV) overlap with the SBFD symbols and some symbols overlap with the semi-static downlink symbols, the row may be excluded from the set R. Referring to FIG. 15B, when some symbols in slot n−3 are semi-static uplink symbols configured by the higher layer, the row including the SLIVs overlapping with the symbols may be excluded from the set R. Referring to FIG. 18B, some symbols in slot n−3 are the semi-static downlink symbols, and some symbols are the SBFD symbols. Since the SLIV1 and SLIV2 overlap only with the semi-static downlink symbols, SLIV 1 and SLIV 2 may be included in the set R. However, some symbols of the SLIV 3, SLIV 4, and SLIV 5 overlap with the semi-static downlink symbols, and some symbols overlap with the SBFD symbol. Therefore, the SLIV3, SLIV4, and SLIV5 may be excluded from the set R. Therefore, the set R may include {1, 2}.
Step 3-2 (When the UE has the UE capability to receive more than one unicast PDSCH per slot):
Add j=0 as a new PDSCH reception candidate occasion to the set M_{A,c} for SLIV ending earliest in the determined set R and SLIVs that temporally overlap with the SLIV. Here, the SLIV ending earliest is SLIV (0,4) in row 1, and the SLIV overlapping with the SLIV is SLIV (0,7) in row 2. Therefore, when j=0 is added to M_{A,c}, and the UE receives a PDSCH scheduled with SLIV(0,4) in row 1 or SLIV(0,7) in row 2 in slot n−3, the HARQ-ACK of the PDSCH may be included in the position corresponding to the first (j=0) M_{A,c} in the type-1 HARQ-ACK codebook. j is incremented by 1 so that j=1. The SLIVs of rows 1 and 2 are excluded from the set R so that the set R becomes an empty set. Step 3-2 may be terminated.
Step 4: k is incremented by 1 so that k=1. Since the cardinality of the K1 set is 2, step 2 restarts using the next K1 value. Now, K_{1,1}=2.
Step 2: When, in the slot n−K_{1,1}=n−2, the symbol corresponding to the starting and length value (SLIV) belonging to each row of the set R overlaps with the symbol configured for the uplink by the higher layer, the row may be excluded from the set R. Referring to FIG. 18B, when some symbols in slot n−2 are semi-static uplink symbols configured by the higher layer, the row including the SLIVs overlapping with the symbols may be excluded from the set R. Referring to FIG. 18B, the semi-static uplink symbol is configured in slot n−2, and the SLIV overlapping with the semi-static uplink symbols are SLIV3 and SLIV5. Therefore, the SLIV 3 and SLIV 5 may be excluded from the set R. In addition, when some symbols corresponding to the starting and length value (SLIV) overlap with the SBFD symbol and some symbols overlap with the semi-static downlink symbols, the SLIV row may be excluded from the set R. Referring to FIG. 18B, the SLIV 1, SLIV2, and SLIV 4 of the UE overlap only with the SBFD symbols. Therefore, the SLIV rows may be included in the set R. The set R={1, 2, 4}.
Step 3-2 (When the UE has the UE capability to receive more than one unicast PDSCH per slot):
Add j=1 as a new PDSCH reception candidate occasion to the set M_{A,c} for SLIV ending earliest in the determined set R and SLIVs that temporally overlap with the SLIV. Here, the SLIV ending earliest is SLIV (0,4) in row 1, and the SLIV overlapping with the SLIV is SLIV (0,7) in row 2. Therefore, when j=1 is added to M_{A,c}, and the UE receives a PDSCH scheduled as SLIV(0,4) in row 1 or SLIV(0,7) in row 2 in slot n−2, the HARQ-ACK of the PDSCH may be included in the position corresponding to the second (j=1) M_{A,c} in the type-1 HARQ-ACK codebook. j is incremented by 1 so that j=2. The SLIVs of rows 1 and 2 are excluded from the set R, so R={4}. Since the set R is not an empty set, step 3-2 is repeated.
Add j=2 as a new PDSCH reception candidate occasion to the set M_{A,c} for SLIV ending earliest in the determined set R and SLIVs that temporally overlap with the SLIV. Here, the SLIV ending earliest is SLIV(7,4) in row 4, and there are no SLIVs overlapping with the SLIV. Therefore, when j=2 is added to M_{A,c} and the UE receives a PDSCH scheduled as SLIV(7,4) in row 4 in slot n−2, the HARQ-ACK of the PDSCH may be included in the position corresponding to the third (j=2) M_{A,c} in the type-1 HARQ-ACK codebook. j is incremented by 1 so that j=3. The SLIV in row 4 is excluded from the set R, so R becomes an empty set. Therefore, step 3-2 may be terminated.
Step 4: k is incremented by 1 so that k=2. Since the cardinality of the K1 set is 2, the pseudo-code is terminated.

Referring to FIG. 18C, the UE may determine M_{A,c} corresponding to three PDSCH reception candidate occasions j=0, j=1, and j=2. Here, M_{A,C} corresponding to j=0 denotes the PDSCH reception candidate occasions in slot n−3, and M_{A,C} corresponding to j=1 and j=2 denotes the PDSCH reception candidate occasions in slot n−2. Compared to FIG. 15C, it may be confirmed that the number of PDSCH reception candidate occasions included in the Type-1 HARQ-ACK codebook to be transmitted by the UE is reduced according to the embodiment of the present disclosure.

As described above, when describing the embodiment of the present disclosure, the repeated transmission of the PDSCH is not considered. The UE may be configured with the repeated transmission of the PDSCH by the base station. For example, when being configured with pdsch-AggregationFactor, the UE may receive the PDSCH in K consecutive slots. Here, K may be a value configured in pdsch-AggregationFactor.

The UE supporting the SBFD operation may be configured with the scheduling constraints. The UE may be configured with at least one of the configurations 2-1, 2-2, and 2-3 described above. Depending on the configured scheduling constraints, the UE may determine the PDSCH reception candidates included in the Type-1 HARQ-ACK codebook and the PDSCH reception candidates to be excluded from the Type-1 HARQ-ACK codebook.

When the UE receives configuration 2-1, the UE may determine whether to include the PDSCH reception candidate in the Type-1 HARQ-ACK codebook as follows.
When all symbols corresponding to the SLIV in the K slots are the same symbol type, the UE may include the SLIV in the Type-1 HARQ-ACK codebook. For example, when all symbols corresponding to the SLIV in K slots are the SBFD symbols or all are the non-SBFD symbols, the SLIV may be included in the Type-1 HARQ-ACK codebook. However, when some of the symbols corresponding to the SLIV in K slots overlap with the SBFD symbols and some overlap with the non-SBFD symbols, the UE may exclude the SLIV from the Type-1 HARQ-ACK codebook. Here, when the SLIV overlaps with the UL symbol in any one of the K slots, the symbol corresponding to the SLIV may be excluded from the above determination.

When the UE receives configuration 2-2, the UE may determine whether to include the PDSCH reception candidate in the Type-1 HARQ-ACK codebook as follows.
When all symbols corresponding to the SLIV in at least one of the K slots are the same symbol type, the UE may include the SLIV in the Type-1 HARQ-ACK codebook. For example, when all symbols corresponding to the SLIV in at least one of the K slots are the SBFD symbols or all are the non-SBFD symbols, the SLIV may be included in the Type-1 HARQ-ACK codebook. However, in each of the K slots, when some of the symbols corresponding to the SLIV overlap with the SBFD symbols and some overlap with the non-SBFD symbols, the UE may exclude the SLIV from the Type-1 HARQ-ACK codebook. Here, when there is an SLIV that overlaps with the UL symbol in any slot among the K slots, the symbol corresponding to the SLIV may be excluded from the above determination.

When the UE receives configuration 2-3, the UE may determine whether to include the PDSCH reception candidate in the Type-1 HARQ-ACK codebook as follows.
When the symbols corresponding to the SLIV in at least one slot among the K slots are the specific symbol type, the UE may include the SLIV in the Type-1 HARQ-ACK codebook. For example, when the symbols corresponding to the SLIV in at least one of the K slots are the specific symbol type (e.g., all symbols are the SBFD symbols or all symbols are the non-SBFD symbols), the SLIV may be included in the Type-1 HARQ-ACK codebook. However, in each of the K slots, when some of the symbols corresponding to the SLIV overlap with the SBFD symbols and some overlap with the non-SBFD symbols, the UE may exclude the SLIV from the Type-1 HARQ-ACK codebook. Here, when there is an SLIV that overlaps with the UL symbol in any slot among the K slots, the symbol corresponding to the SLIV may be excluded from the above determination. Here, the method for determining a specific symbol type may be determined in the same manner as in the above configuration 2-3.

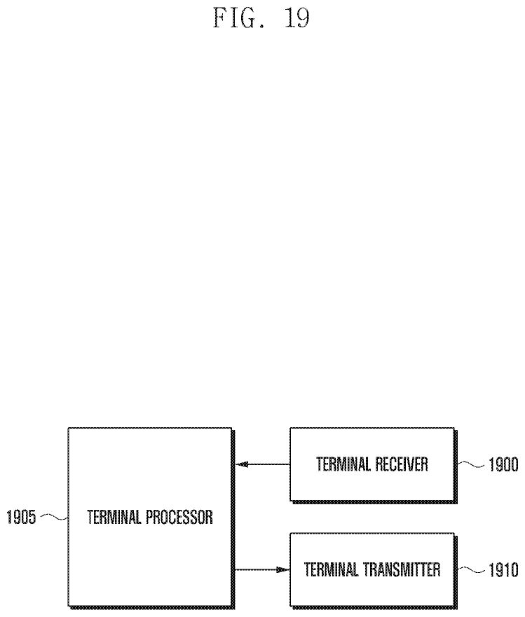

FIG. 19 is a diagram illustrating a structure of a terminal in a wireless communication system according to an embodiment of the present disclosure.

Referring to FIG. 19, the terminal may include a transceiver, which refers to a terminal receiver 1900 and a terminal transmitter 1910, a memory (not illustrated), and a terminal processor 1905 (or terminal controller or processor). According to the communication method of the terminal described above, the transceivers 1900 and 1910, the memory, and the terminal processor 1905 of the terminal may operate. However, the components of the terminal are not limited to the examples described above. For example, the terminal may include more or fewer components than the components described above. In addition, the transceiver, the memory, and the processor may also be implemented in the form of one chip.

The transceiver may transmit and receive a signal to and from a base station. Here, the signal may include control information and data. To this end, the transceiver may include an RF transmitter that up-converts the frequency of the transmitted signal and amplifies the transmitted signal, an RF receiver that performs low-noise amplification on the received signal and down-converts the frequency of the received signal, etc. However, this is only one example of the transceiver, and the components of the transceiver are not limited to the RF transmitter and the RF receiver.

In addition, the transceiver may receive a signal via a wireless channel, output the signal to the processor, and transmit the signal output from the processor via the wireless channel.

The memory may store programs and data necessary for the operation of the terminal. In addition, the memory may store the control information or data included in the signal transmitted and received by the terminal. The memory may be configured as storage media, such as a ROM, a RAM, a hard disk, a CD-ROM, or a DVD, or a combination of such storage media. Furthermore, the number of memories may be plural.

In addition, the processor may control a series of processes so that the terminal may operate according to the embodiments described above. For example, the processor may receive a DCI composed of two layers and control the components of the terminal to simultaneously receive a plurality of PDSCHs. There may be a plurality of processors, and the processors may perform component control operations of the terminal by executing programs stored in the memory.

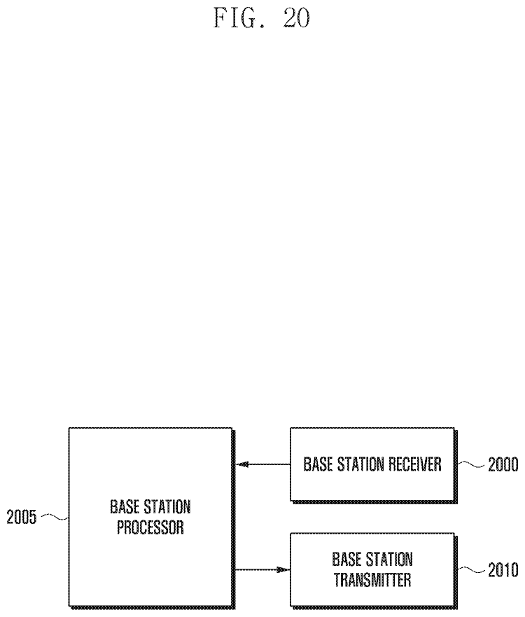

FIG. 20 is a diagram illustrating a structure of a base station in a wireless communication system according to an embodiment of the present disclosure.

Referring to FIG. 20, the base station may include a transceiver, which refers to a base station receiver 2000 and a base station transmitter 2010, a memory (not illustrated), and a base station processor 2005 (or a base station controller or processor). According to the communication method of the base station described above, the transceivers 2000 and 2010, the memory, and the base station processor 2005 of the base station may operate. However, the components of the base station are not limited to the examples described above. For example, the base station may include more or fewer components than the components described above. In addition, the transceiver, the memory, and the processor may also be implemented in the form of one chip.

The transceiver may transmit and receive a signal to and from a terminal. Here, the signal may include control information and data. To this end, the transceiver may include an RF transmitter that up-converts the frequency of the transmitted signal and amplifies the transmitted signal, an RF receiver that performs low-noise amplification on the received signal and down-converts the frequency of the received signal, etc. However, this is only one example of the transceiver, and the components of the transceiver are not limited to the RF transmitter and the RF receiver.

In addition, the transceiver may receive a signal via a wireless channel, output the signal to the processor, and transmit the signal output from the processor via the wireless channel.

The memory may store programs and data necessary for the operation of the base station. In addition, the memory may store the control information or data included in the signal transmitted and received by the base station. The memory may be configured as storage media, such as a ROM, a RAM, a hard disk, a CD-ROM, or a DVD, or a combination of such storage media. Furthermore, the number of memories may be plural.

The processor may control a series of processes so that the base station may operate according to the embodiments of the present disclosure described above. For example, the processor may control each component of the base station to configure and transmit two layers of DCIs including allocation information for a plurality of PDSCHs. The number of processors may be plural, and the processor may execute the programs stored in the memory to perform component control operations of the base station.

Methods according to the embodiments described in the claims or specifications of the present disclosure may be implemented in the form of hardware, software, or a combination of hardware and software.

When implemented in software, a computer-readable storage medium storing one or more programs (software modules) may be provided. One or more programs stored in the computer-readable storage medium are configured to be executable by one or more processors in an electronic device. One or more programs include instructions for causing an electronic device to execute methods according to embodiments described in a claim or specification of the present disclosure.

Such programs (software modules, software) may be stored in a random access memory, a non-volatile memory including flash memory, a read only memory (ROM), an electrically erasable programmable read only memory (EEPROM), a magnetic disc storage device, a compact disc-ROM (CD-ROM), digital versatile Discs (DVDs), any other form of optical storage device, and a magnetic cassette. Alternatively, it may be stored in a memory composed of a combination of some or all thereof. In addition, each memory component may be included in plural.

In addition, the program may be stored in an attachable storage device that may accessed via a communication network such as the Internet, the Intranet, a local area network (LAN), wide LAN (WLAN), or a storage area network (SAN), or a combination thereof. Such a storage device may be connected to a device implementing an embodiment of the present disclosure via an external port. In addition, a separate storage device on the communication network may be connected to the device implementing the embodiment of the present disclosure.

In the specific embodiments of the present disclosure described above, components included in the disclosure are expressed in the singular or plural according to the specific embodiments presented. However, the singular or plural expression is appropriately selected for the context presented for convenience of description, and the present disclosure is not limited to the singular or plural components, and even if the component is expressed in plural, the component is configured in singular or even if the component is expressed in singular, the components may be configured in plural.

Meanwhile, the embodiments of the present disclosure disclosed in this specification and drawings are merely specific examples presented to easily describe the technical contents of the present disclosure and to help understanding of the present disclosure, and are not intended to limit the scope of the present disclosure. That is, it is obvious to a person having ordinary skill in the art to which the present disclosure pertains that other modifications based on the technical idea of the present disclosure are possible. In addition, each embodiment may be combined with each other and operated as needed. For example, portions of an embodiment and another embodiment of the present disclosure may be combined with each other to operate a base station and a terminal. For example, portions of the first and second embodiments of the present disclosure may be combined with each other to operate the base station and the terminal. In addition, while the embodiments have been presented based on an FDD LTE system, other modifications based on the technical ideas of the embodiments may also be practiced in other systems, such as a TDD LTE system, 5G, or NR system.

Meanwhile, the order of description in the drawings describing the method of the present disclosure does not necessarily correspond to the order of execution, and the order of precedence may be changed or executed in parallel.

Alternatively, the drawings describing the method of the present disclosure may omit some components and include only some components, without departing from the essence of the present disclosure.

In addition, the method of the present disclosure may be executed by combining some or all of the contents included in each embodiment, without departing from the essence of the present disclosure.

Various embodiments of the present disclosure have been described above. The foregoing description of the present disclosure is for illustrative purposes, and the embodiments of the present disclosure are not limited to the disclosed embodiments. It will be understood by those of ordinary skill in the art to which the present disclosure pertains that various modifications can be made in other specific forms without departing from the technical ideas or essential features of the present disclosure. It should be interpreted that the scope of the present disclosure is defined by the following claims rather than the detailed description and all modifications or alterations deduced from the meaning, the scope, and equivalences of the claims are included in the scope of the present disclosure.

1. A method performed by a terminal of a communication system, the method comprising:
receiving configuration information related to subband non-overlapping full duplex (SBFD);
identifying at least one occasion for receiving a physical downlink shared channel (PDSCH); and
receiving the PDSCH at a valid occasion among the at least one occasion,
wherein, in case that the configuration information corresponds to a first configuration, the valid occasion is defined as either an occasion including only a first type symbol or an occasion including only a second type symbol, and
wherein, in case that the configuration information corresponds to a second configuration, the valid occasion is defined as the occasion including only the first type symbol and the occasion including only the second type symbol.

2. The method of claim 1, wherein each of the at least one occasion includes only the first type symbol or only the second type symbol.

3. The method of claim 1, wherein, in case that the configuration information corresponds to the first configuration, an occasion including at least one first type symbol and at least one second type symbol among the at least one occasion is excluded from the Type-1 hybrid automatic repeat request-acknowledgement (HARQ-ACK) codebook.

4. The method of claim 1,
wherein the first type symbol is an SBFD symbol defined according to a first definition or second definition,
the second type symbol is a non-SBFD symbol,
the SBFD symbol according to the first definition is a symbol configured with a downlink subband or an uplink subband, and
the SBFD symbol according to the second definition is a symbol configured with a downlink subband or an uplink subband and a flexible symbol.

5. A method performed by a base station of a communication system, the method comprising:
transmitting configuration information related to subband non-overlapping full duplex (SBFD);
identifying at least one occasion for transmitting a physical downlink shared channel (PDSCH); and
transmitting the PDSCH at a valid occasion among the at least one occasion,
wherein, in case that the configuration information corresponds to a first configuration, the valid occasion is defined as either an occasion including only a first type symbol or an occasion including only a second type symbol, and
wherein, in case that the configuration information corresponds to a second configuration, the valid occasion is defined as the occasion including only the first type symbol and the occasion including only the second type symbol.

6. The method of claim 5, wherein each of the at least one occasion includes only the first type symbol or only the second type symbol.

7. The method of claim 5, wherein, in case that the configuration information corresponds to the first configuration, the occasion including at least one first type symbol and at least one second type symbol among the at least one occasion is excluded from the Type-1 hybrid automatic repeat request-acknowledgement (HARQ-ACK) codebook.

8. The method of claim 5,
wherein the first type symbol is an SBFD symbol defined according to a first definition or second definition,
the second type symbol is a non-SBFD symbol,
the SBFD symbol according to the first definition is a symbol configured with a downlink subband or an uplink subband, and
the SBFD symbol according to the second definition is a symbol configured with a downlink subband or an uplink subband and a flexible symbol.

9. A terminal of a communication system, comprising:
a transceiver; and
a controller configured to:
receive configuration information related to subband non-overlapping full duplex (SBFD),
identify at least one occasion for receiving a physical downlink shared channel (PDSCH), and
receive the PDSCH at a valid occasion among the at least one occasion,
wherein, in case that the configuration information corresponds to a first configuration, the valid occasion is defined as either an occasion including only a first type symbol or an occasion including only a second type symbol, and
wherein, in case that the configuration information corresponds to a second configuration, the valid occasion is defined as the occasion including only the first type symbol and the occasion including only the second type symbol.

10. The terminal of claim 9, wherein each of the at least one occasion includes only the first type symbol or only the second type symbol.

11. The terminal of claim 9, wherein, in case that the configuration information corresponds to the first configuration, the occasion including at least one first type symbol and at least one second type symbol among the at least one occasion is excluded from the Type-1 hybrid automatic repeat request-acknowledgement (HARQ-ACK) codebook.

12. The terminal of claim 9,
wherein the first type symbol is an SBFD symbol defined according to a first definition or second definition,
the second type symbol is a non-SBFD symbol,
the SBFD symbol according to the first definition is a symbol configured with a downlink subband or an uplink subband, and
the SBFD symbol according to the second definition is a symbol configured with a downlink subband or an uplink subband and a flexible symbol.

13. A base station of a communication system, comprising:
a transceiver; and
a controller configured to:
transmit configuration information related to subband non-overlapping full duplex (SBFD),
identify at least one occasion for transmitting a physical downlink shared channel (PDSCH), and
transmit the PDSCH at a valid occasion among the at least one occasion,
wherein, in case that the configuration information corresponds to a first configuration, the valid occasion is defined as either an occasion including only a first type symbol or an occasion including only a second type symbol, and
wherein, in case that the configuration information corresponds to a second configuration, the valid occasion is defined as the occasion including only the first type symbol and the occasion including only the second type symbol.

14. The base station of claim 13, wherein each of the at least one occasion includes only the first type symbol or only the second type symbol.

15. The base station of claim 13, wherein, in case that the configuration information corresponds to the first configuration, the occasion including at least one first type symbol and at least one second type symbol among the at least one occasion is excluded from the Type-1 hybrid automatic repeat request-acknowledgement (HARQ-ACK) codebook.
